(19) United States
(12) Patent Application Publication
(10) Pub. No.: US 2015/0127141 A1
(43) Pub. Date: May 7, 2015

(54) ROBOT, CONTROL DEVICE, ROBOT SYSTEM AND ROBOT CONTROL METHOD

(71) Applicant: Seiko Epson Corporation, Tokyo (JP)

(72) Inventors: Hiroyuki KAWADA, Suwa (JP); Yuki KIYOSAWA, Matsumoto (JP); Makoto KUDO, Fujimi (JP)

(21) Appl. No.: 14/528,278

(22) Filed: Oct. 30, 2014

(30) Foreign Application Priority Data
Nov. 1, 2013 (JP) 2013-227969
Nov. 1, 2013 (JP) 2013-227970
Nov. 15, 2013 (JP) 2013-237316
Mar. 26, 2014 (JP) 2014-063235

(51) Int. Cl. B25J 9/00; G05D 15/01

(52) U.S. Cl. CPC B25J 9/0084; G05D 15/01; Y10S 901/30; Y10S 901/02
USPC 700/206; 901/30; 901/2

(57) ABSTRACT

A robot includes a force detection unit and an arm including an end effector. The arm applies a force acting in a predetermined direction to a first workpiece so that the first workpiece is pressed against at least a first surface and a second surface of a second workpiece.

### BACKGROUND

1. Technical Field

The present invention relates to a robot, a control device, a robot system, and a robot control method.

2. Related Art

JP-A-2012-35391 discloses a robot which carries out assembly work for a product by combining a plurality of components. The robot disclosed in JP-A-2012-35391 overlaps a component of one type at a predetermined position on a base component, and further overlaps a component of the other type at the predetermined position on the previously overlapped component. In this manner, the robot presses the component with a hand so that the component is unmovable.

Incidentally, when the robot is controlled to carry out the above-described assembly work, a dedicated jig is frequently used so that the component is fixed and unmovable. However, if types of components increase, it is necessary to prepare a dedicated jig each time, depending on the types of components. For example, a jobsite in producing multiple products needs to prepare many jigs.

In this regard, as disclosed in JP-A-2012-35391, a method is considered in which the component is overlapped with the other component and is pressed by the hand so that the component is unmovable. However, JP-A-2012-35391 does not disclose how to press the component (for example, in which direction). For example, when screw fastening work is carried out, if the overlapped components cannot be appropriately pressed against each other, respective holes of the overlapped components are misaligned with each other. Consequently, there is a possibility that not only the screw fastening work cannot be carried out but also the components may be destroyed.

### SUMMARY

An advantage of some aspects of the invention is to cause a workpiece such as a component to be more reliably unmovable during work carried out by a robot.

A first aspect of the invention is directed to a robot including a force detection unit and an arm including an end effector. The arm applies a force acting in a predetermined direction to a first workpiece so that the first workpiece is pressed against at least a first surface and a second surface of a second workpiece. According to the first aspect of the invention, the first workpiece is pressed against two surfaces of the second workpiece. Accordingly, it is possible to more reliably cause a workpiece to be unmovable.

In the robot, the second surface may be perpendicular to the first surface. The arm may press the first workpiece against the first surface in a first direction, and may press the first workpiece against the second surface in a second direction perpendicular to the first direction. In this manner, the first workpiece is pressed against the two surfaces of the second workpiece by two forces applied to the respective surfaces. Accordingly, it is possible to more reliably cause the workpiece to be unmovable.

In the robot, the arm may further press the first workpiece against a third surface of the second workpiece. Since the first workpiece is pressed against three surfaces of the second workpiece, it is possible to more reliably cause the workpiece to be unmovable.

In the robot, the second surface may be perpendicular to the first surface. The third surface may be perpendicular to both the first surface and the second surface. The arm may press the first workpiece against the first surface in the first direction, may press the first workpiece against the second surface in the second direction, and may press the first workpiece against the third surface in a third direction. In this manner, the first workpiece is pressed against three surfaces of the second workpiece by three forces applied to the respective surfaces. Accordingly, it is possible to more reliably cause the workpiece to be unmovable.

In the robot, two arms may be provided. One of the arms may press the first workpiece against the second workpiece, and the other arm may carry out predetermined work for the first workpiece. In this manner, one of the arms causes the workpiece to be more reliably fixed and unmovable. Accordingly, it is possible to accurately carry out work by using the other arm.

In the robot, the predetermined work may be work for inserting a member into the first workpiece. The first direction may be a direction where the member is inserted into the first workpiece. The workpiece is pressed not only in the first direction, but also in the second direction. Accordingly, even when there is an error in the insertion direction, it is possible to bring the workpiece into a state where the workpiece is less likely to move.

In the robot, the second workpiece may be a jig for positioning the first workpiece. In this manner, when work is carried out for the first workpiece on the jig, it is possible to more reliably cause the first workpiece to be unmovable.

In the robot, the second workpiece may be a workpiece to which the first workpiece is fastened at a predetermined position. When work is carried out for the first workpiece on the second workpiece, it is possible to more reliably cause the first workpiece to be unmovable.

A second aspect of the invention is directed to a robot including a force detection unit and an arm including an end effector. The arm applies a force acting in a predetermined direction and a moment acting in a predetermined direction to a first workpiece so that the first workpiece is pressed against at least a first surface and a second surface of a second workpiece. According to the second aspect of the invention, the first workpiece is pressed against two surfaces of the second workpiece by the force and the moment. Accordingly, it is possible to more reliably cause the workpiece to be unmovable.

A third aspect of the invention is directed to a control device that controls a robot having a force detection unit and an arm including an end effector. The arm applies a force acting in a predetermined direction to a first workpiece so that the robot performs an operation in which the first workpiece is pressed against at least a first surface and a second surface of a second workpiece. According to the third aspect of the invention, the first workpiece is pressed against two surfaces of the second workpiece. Accordingly, it is possible to more reliably cause the workpiece to be unmovable.

A fourth aspect of the invention is directed to a robot system including a robot that has a force detection unit and an arm including an end effector and a controller that controls the robot. The controller causes the robot to perform an operation in which the arm applies a force acting in a predetermined direction to a first workpiece so that the first workpiece is pressed against at least a first surface and a second surface of a second workpiece. According to the fourth aspect of the invention, the first workpiece is pressed against two surfaces of the second workpiece. Accordingly, it is possible to more reliably cause the workpiece to be unmovable.

A fifth aspect of the invention is directed to a control method for controlling a robot that has a force detection unit and an arm including an end effector. The arm applies a force acting in a predetermined direction to a first workpiece so that the first workpiece is pressed against at least a first surface and a second surface of a second workpiece. According to the fifth aspect of the invention, the first workpiece is pressed against two surfaces of the second workpiece. Accordingly, it is possible to more reliably cause the workpiece to be unmovable.

Another aspect of the invention is directed to a robot including a force detection unit, a first arm including a first end effector, and a second arm including a second end effector. The first arm carries out predetermined work for applying a force to a first workpiece in a first direction, and the second arm performs an operation for pressing the first workpiece in a second direction opposite to the first direction. According to this aspect, the workpiece is pressed in the second direction opposite to the first direction where the force is applied during the work. Accordingly, it is possible to more reliably cause the workpiece to be unmovable.

The first direction and the second direction may be a direction parallel to a first surface on which the first workpiece is placed. In this manner, it is possible to more reliably cause the workpiece to be unmovable in the first direction along the first surface.

The robot may cause the second arm to perform an operation for pressing the first workpiece in a third direction orthogonal to the first surface. In this manner, the workpiece is also pressed against the surface on which the workpiece is to be placed. Accordingly, it is possible to more reliably cause the workpiece to be unmovable.

The robot may cause the second arm to perform an operation for pressing the first workpiece by using a second moment opposite to the first moment which is generated in the first workpiece during the predetermined work. In this manner, the pressing can be operated so as to remove or reduce the moment generated by the work. Accordingly, it is possible to more reliably cause the workpiece to be unmovable.

The first moment may be parallel to an axis orthogonal to the first direction, and may be a moment around an axis parallel to the first surface. The second moment may be parallel to an axis orthogonal to the second direction, and may be a moment around an axis parallel to the first surface. In this manner, even if the moment attempting to float the workpiece from the first surface is generated, it is possible to more reliably cause the workpiece to be unmovable.

The first moment may be parallel to an axis orthogonal to the first direction, and may be a moment around an axis perpendicular to the first surface. The second moment may be parallel to an axis orthogonal to the second direction, and may be a moment around an axis perpendicular to the first surface. In this manner, even if the moment attempting to cause the workpiece to slide along the first surface is generated, it is possible to more reliably cause the workpiece to be unmovable.

The predetermined work may be work for assembling a member with respect to the first workpiece, and the first direction may be a direction where the member is assembled with respect to the first workpiece. In this manner, it is possible to accurately carry out the work for assembling the member with respect to the workpiece.

Still another aspect of the invention is directed to a control device for controlling a robot having a force detection unit, a first arm including a first end effector, and a second arm including a second end effector. The control device causes the robot to perform an operation in which the first arm carries out predetermined work for applying a force to a first workpiece in a first direction, and the second arm carries out work for pressing the first workpiece in a second direction opposite to the first direction. According to this aspect, the workpiece is pressed in the second direction opposite to the first direction where the force is applied during the work. Accordingly, it is possible to more reliably cause the workpiece to be unmovable.

Yet another aspect of the invention is directed to a robot system that has a robot having a force detection unit, a first arm including a first end effector, and a second arm including a second end effector, and a controller for controlling the robot. The controller causes the robot to perform an operation in which the first arm carries out predetermined work for applying a force to a first workpiece in a first direction, and the second arm presses the first workpiece in a second direction opposite to the first direction. According to this aspect, the workpiece is pressed in the second direction opposite to the first direction where the force is applied during the work. Accordingly, it is possible to more reliably cause the workpiece to be unmovable.

Still yet another aspect of the invention is directed to a control method for controlling a robot having a force detection unit, a first arm including a first end effector, and a second arm including a second end effector. The control method causes the robot to perform an operation in which the first arm carries out predetermined work for applying a force to a first workpiece in a first direction, and the second arm presses the first workpiece in a second direction opposite to the first direction. According to this aspect, the workpiece is pressed in the second direction opposite to the first direction where the force is applied during the work. Accordingly, it is possible to more reliably cause the workpiece to be unmovable.

Further another aspect of the invention is directed to a program that causes a computer to function as a controller for controlling a robot having a force detection unit, a first arm including a first end effector, and a second arm including a second end effector. The program causes the computer to execute a process for the robot to perform an operation in which the first arm carries out predetermined work for applying a force to a first workpiece in a first direction, and the second arm presses the first workpiece in a second direction opposite to the first direction. According to this aspect, the workpiece is pressed in the second direction opposite to the first direction where the force is applied during the work. Accordingly, it is possible to more reliably cause the workpiece to be unmovable.

Still further another aspect of the invention is directed to a robot including an arm having an end effector including at least two finger portions and a receiving portion between at least the two finger portions. A first end of a tool is brought into contact with the receiving portion, the tool is gripped by at least one of the finger portions, and a retaining ring held by a second end different from the first end is fitted into a fitting portion.

According to this aspect, the robot can fit the retaining ring by using the tool for fitting the retaining ring. In this manner, even if there is no mechanism for expanding and contracting the retaining ring, the retaining ring can be fitted.

Here, the retaining ring may include any one of a C-type retaining ring and an E-type retaining ring. In this manner, even if there is no retaining ring for exclusive use, the retaining ring can be fitted without using a mechanism for expanding and contracting the retaining ring.

Here, at least the two finger portions may include four finger portions, and the tool may be gripped by the four finger portions. In this manner, the tool can be stably gripped. Accordingly, it is possible to hold the retaining ring or to prevent the retaining ring from being misaligned in fitting.

Here, a force required for the fitting may be smaller than a sum of a force obtained by the tool coming into contact with the receiving portion and a force obtained by gripping of the tool. In this manner, the tool can be stably gripped. Accordingly, when the retaining ring is fitted, it is possible to prevent the retaining ring from being misaligned.

Here, the tool may be gripped by at least the two finger portions so that an operation direction of the fitting is perpendicular to a surface of the receiving portion with which the tool comes into contact. In this manner, the receiving portion can perpendicularly receive a reaction force generated when the retaining ring is fitted. Accordingly, it is possible to prevent the retaining ring from being misaligned during the fitting.

Here, the operation direction of the fitting may be a direction from the first end to the second end. In this manner, it is possible to prevent the retaining ring from being bent or misaligned during the fitting.

Here, the robot may detect a fitting portion by moving the retaining ring held by the second end while bringing the retaining ring into contact with a surface including at least any one of the fitting portion and an indication portion indicating the fitting portion. In this manner, it is possible to detect the fitting portion.

Here, in the robot, the retaining ring may come into contact with the gripped tool, and the retaining ring may be held by the tool. In this manner, the tool can easily hold the retaining ring. Accordingly, it is possible to improve workability.

Here, the robot may further include a control device for controlling the robot so as to perform at least one of the operations. In this manner, it is possible to freely control the operation of the robot.

Yet further another aspect of the invention is directed to a robot system that has a robot including an arm having an end effector including at least two finger portions and a receiving portion between at least the two finger portions, and a control device. The control device causes the robot to bring a first end of a tool into contact with the receiving portion, causes the tool to be gripped by at least one of the finger portions, and causes a retaining ring held by a second end different from the first end to be fitted into a fitting portion.

Still yet further another aspect of the invention is directed to a robot control device that controls the robot.

A further aspect of the invention is directed to a method in which a robot including an arm having an end effector including at least two finger portions and a receiving portion between at least the two finger portions brings a first end of a tool into contact with the receiving portion, causes the tool to be gripped by at least one of the finger portions, and causes a retaining ring held by a second end different from the first end to be fitted into a fitting portion.

A still further aspect of the invention is directed to a robot including a force sensor, a hand for gripping a tool used during a work, and a controller for controlling the operation of the hand. The controller causes the hand to carry out the work after determining a position or a posture of the hand by bringing the tool gripped by the hand into contact with a workpiece.

According to this configuration, the controller determines the position or the posture of the robot, based on contact between a workpiece having a very precise shape, such as an assembly member, and a tool. Accordingly, the controller can accurately derive a relative position or posture between the tool and the workpiece. Therefore, the robot can improve accuracy of the work. In addition, it is not necessary to provide a tool dedicated for the robot, such as an end effector. Therefore, it is possible to reduce the cost and time for preparing the tool dedicated for the robot.

A yet further aspect of the invention is directed to the robot described above, wherein the controller changes a position or posture of the hand and causes the hand to carry out the work, based on a predetermined change amount, after determining the position or the posture of the hand.

According to this configuration, based on a change amount changed from the determined position or posture which is caused by coming into contact with a workpiece, the controller can accurately move the robot to a position for carrying out the work, or can cause the robot to adopt a posture suitable for the work. Therefore, the robot can improve the accuracy of the work.

A still yet further aspect of the invention is directed to the robot described above, wherein the controller causes the hand to grip the tool using a weak force before coming into contact with the workpiece, and causes the hand to carry out the work by strengthening the gripping force of the hand when the position or the posture of the hand is determined.

According to this configuration, the controller flexibly adjusts the position or the posture of the tool with respect to the robot which is caused by the contact so as to determine the position or the posture. Then, the controller fixes a relative position or posture of the tool with respect to the robot by causing the tool to be firmly gripped. Therefore, the robot can improve the accuracy of the work.

A furthermore aspect of the invention is directed to the robot described above, wherein the controller brings a predetermined portion of the tool which is gripped by the hand into contact with the workpiece.

According to this configuration, the controller controls the robot so as to bring the predetermined portion of the tool into contact with the workpiece. Accordingly, it is possible to more accurately determine a position of an operating point of the tool or a posture of the tool. Therefore, the robot can improve the accuracy of the work.

A still furthermore aspect of the invention is directed to a robot system including a robot having a force sensor and a hand for gripping a tool used during a work, and a controller for operating the robot. The controller causes the robot to carry out the work after determining a position or a posture of the hand by bringing the tool gripped by the hand into contact with a workpiece.

According to this configuration, the controller determines the position or the posture of the robot, based on contact between a workpiece having a very precise shape, such as an assembly member, and a tool. Accordingly, the controller can accurately derive a relative position or position between the tool and the workpiece. Therefore, the robot system can improve accuracy of the work.

A yet furthermore aspect of the invention is directed to a control device that operates a robot including a force sensor and a hand for gripping a tool used during a work. The control device causes the robot to carry out the work after determining a position or a posture of the hand by bringing the tool gripped by the hand into contact with a workpiece.

According to this configuration, the control device determines the position or the posture of the robot, based on contact between a workpiece having a very precise shape, such as an assembly member, and a tool. Accordingly, the control device can accurately derive a relative position or posture between the tool and the workpiece. Therefore, the control device can improve accuracy of the work carried out by the robot.

A still yet furthermore aspect of the invention is directed to a control method for operating a robot including a force sensor and a hand for gripping a tool used during a work. The control method including bringing the tool gripped by the hand into contact with a workpiece, determining a position or a posture of the hand, and causing the robot to carry out the work.

According to this method, the position or the posture of the robot is determined, based on the contact between the workpiece having a very precise shape, such as an assembly member, and the tool. Accordingly, the relative position or posture between the tool and the workpiece is accurately derived. Therefore, the above-described control method can improve accuracy of the work.

### BRIEF DESCRIPTION OF THE DRAWINGS

The invention will be described with reference to the accompanying drawings, wherein like numbers reference like elements.

FIG. 1 is a front perspective view illustrating an example of a robot according to an embodiment of the invention.

FIG. 2 is a rear perspective view illustrating an example of the robot.

FIG. 3 is a view illustrating details of an arm and a hand.

FIG. 4 is a view illustrating a relationship between the robot and a working table.

FIG. 5 is a view illustrating an example of a functional configuration of the robot.

FIG. 6 is a view for describing a first work example carried out by the robot.

FIGS. 7A and 7B are views illustrating a configuration example of a jig.

FIGS. 8A to 8C are views for describing a pressing operation of the robot in the first work example.

FIGS. 9A to 9C are views for describing the pressing operation of the robot in the first work example.

FIG. 10 is a view for describing a second work example carried out by the robot.

FIGS. 11A to 11C are views for describing a pressing operation of the robot in the second work example.

FIGS. 12A to 12C are views for describing a pressing operation of a robot in a third work example.

FIG. 13 is a view for describing the first work example carried out by the robot.

FIGS. 14A to 14C are views for describing a first example of the pressing operation of the robot in the first work example.

FIGS. 15A to 15C are views for describing a second example of the pressing operation of the robot in the first work example.

FIGS. 16A to 16C are views for describing a third example of the pressing operation of the robot in the first work example.

FIGS. 17A to 17C are views for describing a fourth example of the pressing operation of the robot in the first work example.

FIGS. 18A to 18C are views for describing a fifth example of the pressing operation of the robot in the first work example.

FIG. 19 is a view illustrating a configuration example of a jig.

FIGS. 20A to 20C are views for describing a sixth example of the pressing operation of the robot in the first work example.

FIGS. 21A to 21C are views for describing a seventh example of the pressing operation of the robot in the first work example.

FIG. 22 is a view illustrating a configuration example of a jig.

FIGS. 23A and 23B are perspective views illustrating details of a hand.

FIG. 24A is a perspective view of a retaining ring, FIG. 24B is a perspective view of a tool, and FIG. 24C is a perspective view of a retaining ring stand.

FIG. 25 is a view illustrating details of an arm.

FIG. 26 is a functional block diagram of a controller.

FIG. 27 is a block diagram illustrating an example of a schematic configuration of a controller.

FIG. 28 is a processing flowchart from when a robot pinches a tool until the tool draws out a retaining ring from a retaining ring stand and the retaining ring is fitted into a fitting portion.

FIG. 29A is a view for describing an operation of an arm and a hand in an operation in which a tool is gripped by the hand, FIG. 29B is a view illustrating a positional relationship on a gripping surface when a surface P1 and a surface P2 of the tool are substantially parallel to each other, and FIG. 29C is a view illustrating a positional relationship on the gripping surface when the surface P1 and the surface P2 of the tool are parallel to each other and a surface P3 and a surface P4 are parallel to each other.

FIG. 30 is a processing flowchart of the operation described with reference to FIGS. 29A to 29C.

FIG. 31 is a view for describing an operation of an arm and a hand in an operation in which a tool removes a retaining ring from a retaining ring stand.

FIG. 32 is a processing flowchart of the operation described with reference to FIG. 31.

FIGS. 33A and 33B are views for describing an operation of an arm and a hand in an operation in which a retaining ring is fitted into a fitting portion.

FIG. 34 is a processing flowchart of the operation described with reference to FIGS. 33A and 33B.

FIGS. 35A to 35C are views for describing detection of a fitting portion.

FIG. 36 is a processing flowchart in Step S83a.

FIG. 37 is a view illustrating an example of a schematic configuration of a robot system according to an embodiment of the invention.

FIG. 38 is a block diagram illustrating an example of a schematic functional configuration of a control device according to an embodiment of the invention.

FIG. 39 is a view for describing a first example of work carried out by a robot system according to an embodiment of the invention.

FIG. 40 is a flowchart illustrating a flow example of processing performed by a control device according to an embodiment of the invention.

FIGS. 41A to 41F are views for describing an example of an operation in a robot system according to an embodiment of the invention.

FIG. 42 is a view for describing a second example of work carried out by a robot system according to an embodiment of the invention.

FIG. 43 is a flowchart illustrating a flow example of a process performed by a control device according to an embodiment of the invention.

FIGS. 44A to 44F are views for describing an example of an operation in a robot system according to an embodiment of the invention.

FIG. 45 is a view illustrating an example of a schematic configuration of a robot system according to another configuration example.

### DESCRIPTION OF EXEMPLARY EMBODIMENTS

### First Embodiment

An embodiment of the invention will be described with reference to the drawings.

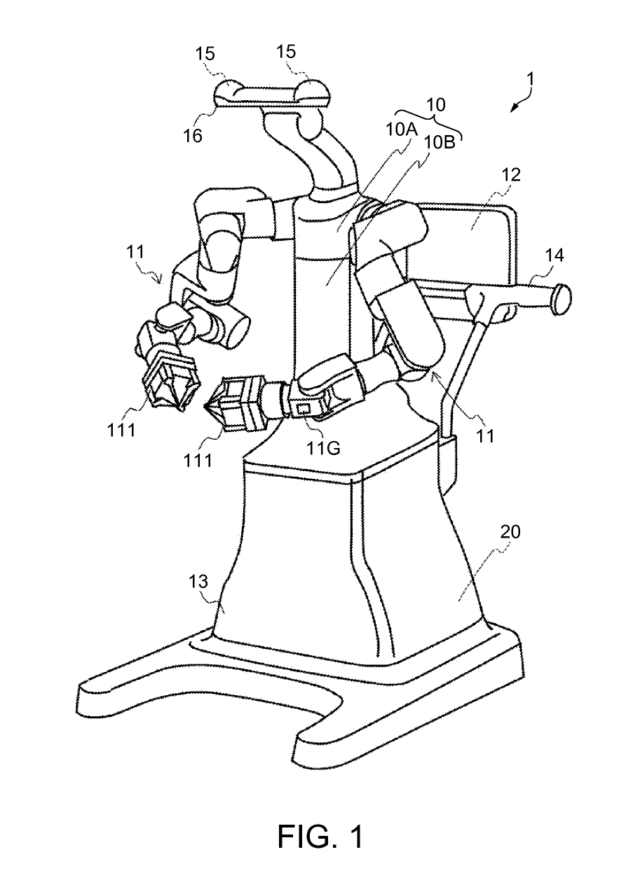

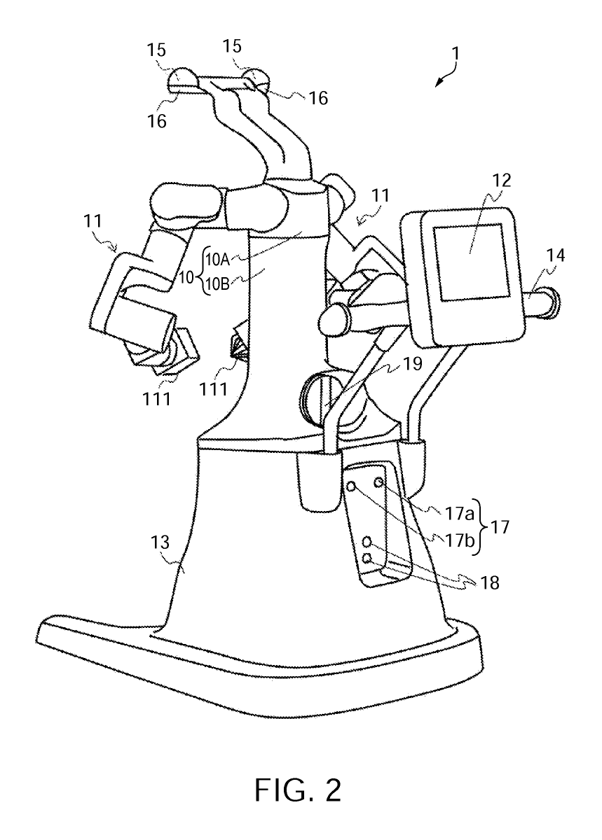

FIG. 1 is a front perspective view illustrating an example of a robot according to the embodiment of the invention. FIG. 2 is a rear perspective view illustrating an example of the robot.

For convenience of description, an upper side in FIGS. 1 and 2 is referred to as “up” or “upward”, and a lower side is referred to as “down” or “downward”. In addition, a forward side in FIG. 1 is referred to as a “front surface side”, a “front surface”, or “forward”. A forward side in FIG. 2 is referred to as a “rear surface side”, a “rear surface”, or “rearward”.

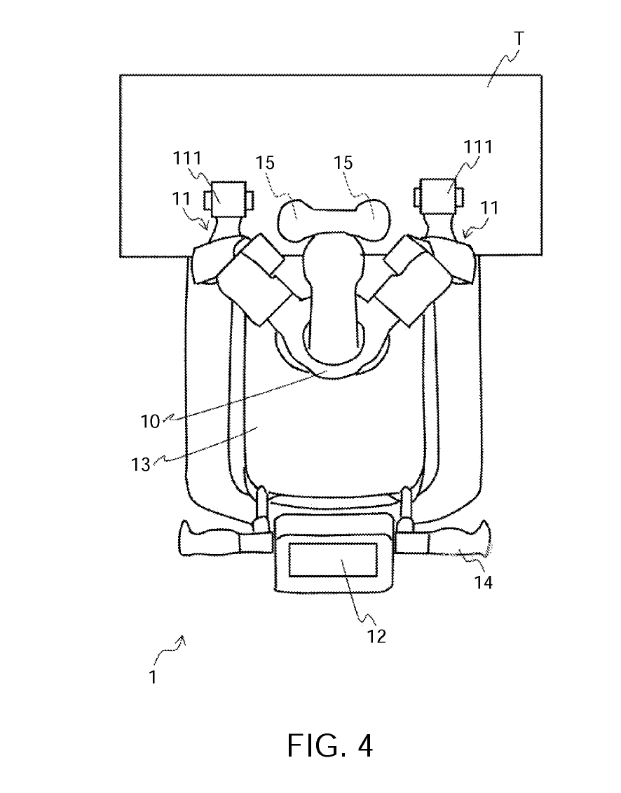

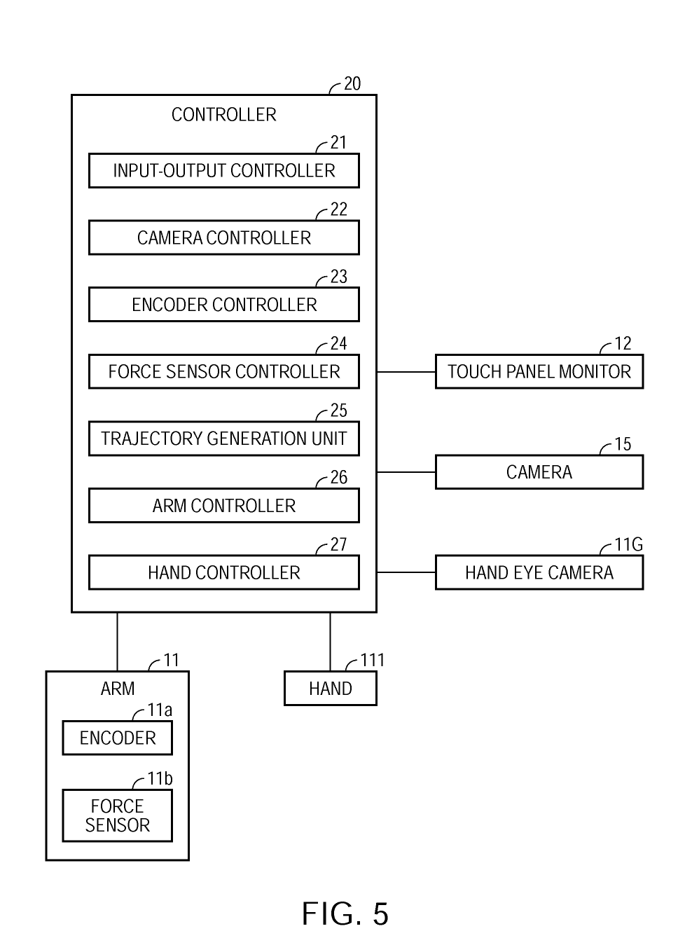

A robot 1 includes a body portion 10, arms 11, a touch panel monitor 12, a leg portion 13, a transporting handle 14, cameras (referred to as “imaging units”) 15, a signal lamp 16, a power switch 17, an external interface (I/F) unit 18, and a lifting handle 19. The robot 1 is a humanoid dual arm robot, and is operated according to a control of a controller 20 (refer to FIG. 5). For example, the robot 1 can be used in a manufacturing process for assembling a precision instrument such as a printer. The manufacturing work is usually carried out on a working table T (refer to FIG. 4).

The body portion 10 is disposed on a frame of the leg portion 13. The leg portion 13 is a base of the robot 1. The body portion 10 is a body of the robot 1. The body portion 10 can also be called a robot main body. Not only the body portion 10 but also the leg portion 13 may be called the robot main body.

The body portion 10 has an upper side shoulder region 10A and a lower side main body 10B. In the upper side shoulder region 10A, the arms 11 (referred to as a “manipulator”) respectively protruding toward a front surface side are disposed on both side surfaces thereof.

Hands 111 (referred to as “end effectors”) for gripping a work object (referred to as a “workpiece”) or a tool are disposed in respective distal ends of the arms 11. In addition, the arm 11 has a hand eye camera 11G for imaging the workpiece or the like placed on the working table. Details of the arm 11 and the hand 111 will be described in detail later.

Two cameras 15 and the signal lamp 16 which protrude obliquely in an upward direction from the shoulder region 10A of the body portion 10 toward the front surface side are disposed in a portion corresponding to a head portion of the robot 1.

For example, the camera 15 has a charge coupled device (CCD) and a complementary metal oxide semiconductor (CMOS) and the like, and can image the working table. For example, the signal lamp 16 has each LED for emitting red light, yellow light, and blue light, and the LED appropriately selected depending on current conditions of the robot 1 is caused to emit the light.

The controller 20 for controlling the robot 1 itself and the like disposed inside the leg portion 13. A rotary shaft vertically extending with respect to the robot 1 is disposed inside the leg portion 13 and the main body 10B, and the shoulder region 10A of the body portion 10 is disposed in the rotary shaft. The shoulder region 10A can be moved and rotated around the rotary shaft. That is, a further upper side member from the main body 10B can integrally turn around the rotary shaft in any desired direction.

The power switch 17 and the external I/F unit 18 serving as an external connection terminal for connecting the controller 20 and an external PC or the like are disposed on a rear surface of the leg portion 13. The power switch 17 has a power-on switch 17a for switching on the power of the robot 1 and a power-off switch 17b for switching off the power of the robot 1.

Multiple casters (not illustrated) are installed in the lowermost portion of the leg portion 13 at intervals in a horizontal direction. This enables a worker to move and transport the robot 1 by pushing the transporting handle 14.

The lifting handle 19 is disposed on a rear surface of the body portion 10. The lifting handle 19 moves the shoulder region 10A located above the body portion 10 with respect to the main body 10B in a vertical direction. In this manner, it is possible to correspond to working tables having various heights.

The touch panel monitor 12 which is visible from the rear surface side of the robot 1 is arranged on the rear surface side of the body portion 10. For example, the monitor is a liquid crystal display, and can display a current condition of the robot 1. In addition, for example, the touch panel is an electrostatic or piezoelectric touch panel, and is used as a user interface unit to set operations for the robot 1.

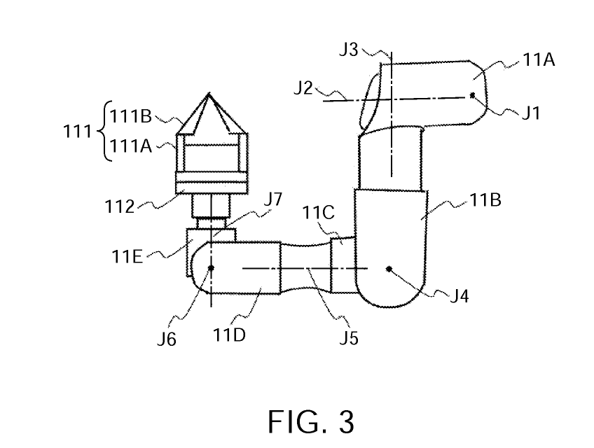

FIG. 3 is a view illustrating details of an arm and a hand.

The arm 11 is configured so that arm members (also referred to as “manipulator members”) 11A, 11B, 11C, 11D, and 11E are connected to one another by joints (not illustrated) sequentially from the body portion 10 side. The joints respectively have actuators (not illustrated) for operating the joints.

The arm 11 is a seven-axis arm having seven pivot shafts. The seven pivot shafts J1, J2, J3, J4, J5, J6, and J7 are respectively the rotary shafts of the actuators disposed in the joints. The arm members 11A, 11B, 11C, 11D, 11E, and the hand 111 can be pivotally and independently moved around the pivot shafts J1, J2, J3, J4, J5, J6, and J7.

For example, the actuator includes a servo motor and an encoder (refer to FIG. 5). An encoder value output from the encoder is used in a feedback control performed by the controller 20 for the robot 1. In addition, an electromagnetic brake for fixing the rotary shaft is disposed in the actuator.

An attention position (also referred to as an “end point”) set in a distal end portion of the arm 11 can be freely moved within a predetermined movable range, or can be oriented in any free direction by linking the respective rotary shafts with each other. The position of the end point is not limited to the distal end portion of the arm. For example, the position may be set in the distal end portion of the end effector.

A force sensor (not illustrated in FIGS. 1 to 3, refer to FIG. 5, also referred to as a “force detection unit”) is disposed in a distal end (corresponding to a wrist portion of the arm 11) of the arm member 11E. The force sensor is a sensor for detecting a force or a moment which is received as a reaction force with respect to a force output from the robot 1. For example, as the force sensor, it is possible to use a six-axis force sensor which can simultaneously detect six components of force components in three translational axes and moment components around three rotational axes. The force sensor is not limited to the six axes, and may have three axes, for example. The force sensor can detect the force or the moment which is applied to the hand or the like.

A method of detecting the force or the moment which is applied to the hand or the like is not limited to a method of using the force sensor. For example, it is possible to estimate an external force acting on the hand, based on respective shaft torque values of the arm 11. Accordingly, any detecting method may be employed as long as the arm 11 has means for directly or indirectly detecting the force or the moment which is applied to the hand.

The hand 111 is disposed in the distal end of the arm member 11E via an attachment/detachment member 112 for disposing the hand 111 to be attachable and detachable.

The hand 111 has a main body portion 111A and multiple (for example, any desired number such as two to four) fingers 111B arranged on a distal end side of the main body portion 111A. The main body portion 111A has a substantially rectangular parallelepiped outer shape. A drive mechanism (not illustrated) for driving the respective fingers 111B is disposed inside the main body portion 111A. The drive mechanism causes the fingers 111B to be close to each other. In this manner, an object such as a component can be interposed therebetween. In addition, the drive mechanism causes the fingers 111B to be away from each other. In this manner, the object can be released from the interposed state.

The arm 11 can be regarded as a type of the manipulator. The manipulator is a mechanism for moving the position of the end point, and can employ various forms without being limited to the arm. For example, any form may be employed as long as the manipulator is configured to have one or more joints and links and operation of the joints allows the manipulator to be completely operated. In addition, the number of the manipulators disposed in the robot 1 is not limited to two, and may be one, three, or more.

The hand 111 can be regarded as a type of the end effector. The end effector is a member for gripping, pressing, lifting, hanging, or suctioning an object, or processing a workpiece. The end effector can employ various forms such as a hand, a hook, and a suction cup. In addition, the end effector may be disposed at multiple locations for a single arm.

According to the above-described configuration, for example, the robot 1 can cause the hand 111 to grip a workpiece, or can cause the hand 111 to come into contact with the workpiece, under the control of the controller 20. In addition, for example, the robot 1 can cause the hand 111 to press the workpiece by applying forces in various directions, or can cause the hand 111 to apply various moments to the workpiece.

The above-described configuration of the robot 1 is intended to describe a main configuration in describing characteristics according to the embodiment, and thus, is not limited to the illustrated configuration example. In addition, a configuration included in a general robot is not excluded. For example, the number of joints (also referred to as the “number of shafts”) or the number of links may be increased or decreased. In addition, a shape, a size, arrangement, and a structure of various members such as the joint, the link, and the hand may be appropriately modified.

For example, the controller 20 may be disposed outside the robot 1 as a robot control device for fulfilling a function of the controller 20. In this case, the robot control device is connected to the robot 1 via a communication I/F. A system including the robot control device and the robot can also be referred to as a robot system.

FIG. 4 is a plan view illustrating an example of a relationship between the robot and the working table. The hand 111 is illustrated in a simplified manner.

For convenience of description, an upper side in FIG. 4 is referred to as a “front surface side”, a “front surface”, or “forward”, and a lower side is referred to as a “rear surface side”, a “rear surface”, or “rearward”. In addition, a forward side in FIG. 4 is referred to as “up” or “upward”. A rearward side in FIG. 4 is referred to as a “down” or “downward”.

The working table T is arranged on the front surface side of the robot 1. The robot 1 can carry out predetermined work within a predetermined working area (not illustrated) on the working table T by operating the arm 11 and using the hand 111. For example, within the predetermined working area, the robot 1 carries out the work for assembling a product by combining multiple components with one another.

For example, the working area can be a rectangular parallelepiped space of three dimensions (having respective lengths in XYZ directions). For example, a range of the working area can be defined within a movable range of the end point. In addition, the range of the working area can be defined in view of work details of the robot 1 or operation accuracy required for the work details.

FIG. 5 is a view illustrating an example of a functional configuration of the robot.

The controller 20 includes an input-output controller 21, a camera controller 22, an encoder controller 23, a force sensor controller 24, a trajectory generation unit 25, an arm controller 26, and a hand controller 27. The arm 11 includes an encoder 11a and a force sensor 11b.

The input-output controller 21 controls an output to the touch panel monitor 12 and an input from the touch panel monitor 12. For example, the input-output controller 21 displays conditions of the robot 1 or an image captured by the camera 15 on the touch panel monitor 12. In addition, for example, the input-output controller 21 receives a user's operation with respect to the touch panel monitor 12.

The camera controller 22 controls the camera 15 or the hand eye camera 11G so as to capture the image, and acquires the captured image. In addition, the camera controller 22 performs image processing for extracting a workpiece from the acquired image.

The encoder controller 23 acquires information relating to an encoder angle and the like from the encoder 11a, and outputs the information to the arm controller 26.

The force sensor controller 24 acquires a value measured by the force sensor 11b, for example, information relating to a direction of a force, a magnitude of the force, a direction of a moment, a magnitude of the moment and the like.

The trajectory generation unit 25 generates a trajectory of the end point. For example, the trajectory generation unit 25 generates the trajectory of the end point, based on the captured image acquired by the camera controller 22. Specifically, the trajectory generation unit 25 recognizes a position of a workpiece by using the image acquired by the camera controller 22, and replaces the position of the work with robot coordinates. Then, the trajectory generation unit 25 generates the trajectory which moves the current robot coordinates of the end point to the robot coordinates of the workpiece. As a matter of course, a trajectory set by a user maybe used. A process for generating the trajectory can employ a general technology, and thus, detailed description thereof will be omitted.

The arm controller 26 controls the arm 11, based on the trajectory generated by the trajectory generation unit 25, and the information of the encoder 11a which is acquired by the encoder controller 23 (position control). For example, the arm controller 26 outputs a movement instruction indicating a rotation angle of the joint to the actuator so as to drive the actuator.

The arm controller 26 controls the arm 11, based on the information of the force sensor 11b which is acquired by the force sensor controller 24 (force control such as an impedance control). For example, the arm controller 26 adjusts a position or a posture of the end point so that the magnitude of the force acting in a specific direction which is detected by the force sensor 11b becomes a targeted magnitude. In addition, for example, the arm controller 26 adjusts the position or the posture of the end point so that the magnitude of a specific moment which is detected by the force sensor 11b becomes a targeted magnitude. This can realize an operation of the robot 1 for pressing the hand 111 against the workpiece. A process for the position control or the force control can employ a general technology, and thus, detailed description thereof will be omitted. The arm controller 26 may move the position of the end point by using a visual servo or the like instead of the position control.

Although description will be made in detail later with reference to a specific example, in the embodiment, for example, when the robot 1 carries out a screw fastening work for a certain component, the robot 1 places the component on a jig (or the other component) having a positioning portion. Then, the robot 1 presses the component against the jig (or the other component) in a planar direction perpendicular to a direction where the force is applied during the screw fastening work (screw inserting direction), and presses the component against the jig in the direction where the force is applied during the screw fastening work. This enables the component to be more reliably unmovable.

The hand controller 27 controls the hand 111. For example, when the end point reaches a targeted position where the end point can grip the workpiece, the hand controller 27 generates an instruction value for causing the respective fingers to be close to each other, and outputs the instruction value to a drive mechanism of the hand 111.

For example, the above-described controller 20 can be realized by a computer that includes an arithmetic unit such as a central processing unit (CPU), a main memory device such as a random access memory (RAM), an auxiliary storage device such as a hard disk drive (HDD), a communication interface (I/F) connected to a communication network over wires or wirelessly, an input I/F connected to an input device such as a touch panel, an output I/F connected to a display device, and a reading-writing device for reading and writing information on a portable storage medium. The controller 20 may be realized by an application specific integrated circuit (ASIC) dedicated for a robot. In addition, for example, the controller 20 may be realized by a controller board or the like including an arithmetic unit, a storage device, a processing circuit, and a drive circuit.

For example, a predetermined program loaded from the auxiliary storage device to the main storage device is executed by the arithmetic unit so that each function of the controller is realized. For example, the above-described predetermined program may be installed from a storage medium read by the reading-writing device, or may be installed from the network via the communication I/F.

The above-described functional configuration of the robot 1 is classified depending on main processing contents so as to facilitate understanding of the configuration in the robot 1. The invention is not limited thereto by a classification method or a name of the configuration elements. The configuration of the robot 1 can be classified into many more configuration elements depending on the processing contents. In addition, the configuration may be classified so that one configuration element executes many more processing tasks. In addition, the processing of each configuration element may be executed by one piece of hardware, or by multiple pieces of hardware.

Sharing of the function and the processing between the controller 20 and other configurations (arm or hand) is not limited to the illustrated example. For example, at least a partial function of the controller 20 may be realized by other configurations. In addition, for example, at least a partial function of other configurations may be realized by the controller 20.

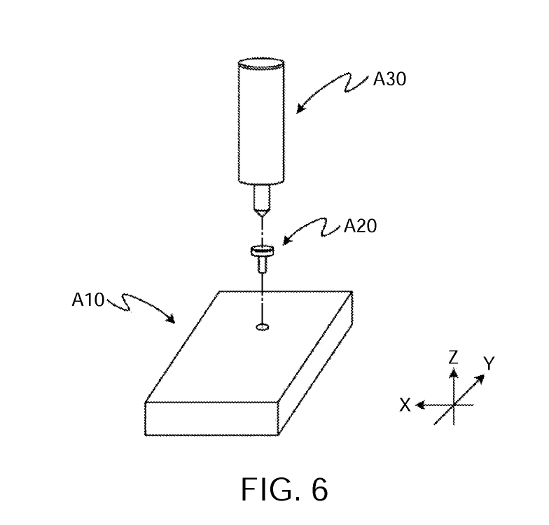

Next, a characteristic operation realized by the above-described robot 1 will be described with reference to FIGS. 6 to 12C. Hereinafter, terms of “substantially” and “shaped” may be used. However, unless a length, an angle, a direction, and a shape of an object are strictly identical to each other, the terms mean a concept which includes a case where all of these are substantially identical to each other (that is, a case where an advantageous effect according to the embodiment can be obtained). As a matter of course, even when the terms of “substantially” and “shaped” are not used, the concept includes the case where all of these are substantially identical to each other.

FIG. 6 is a view for describing a first work example carried out by the robot. The first work example represents that a screw A20 is inserted into a screw hole formed in a workpiece A10 so as to perform screw fastening. The workpiece A10 has a rectangular parallelepiped shape. In order to perform the screw fastening of the screw A20, an electric screwdriver A30 which can also be used by humans is used, for example. The screw A20 is configured to contain a metal such as iron, and a screwdriver bit of the electric screwdriver A30 is magnetized. Therefore, in a state where the screw A20 is set in the screwdriver bit of the electric screwdriver A30, the screw A20 can be moved.

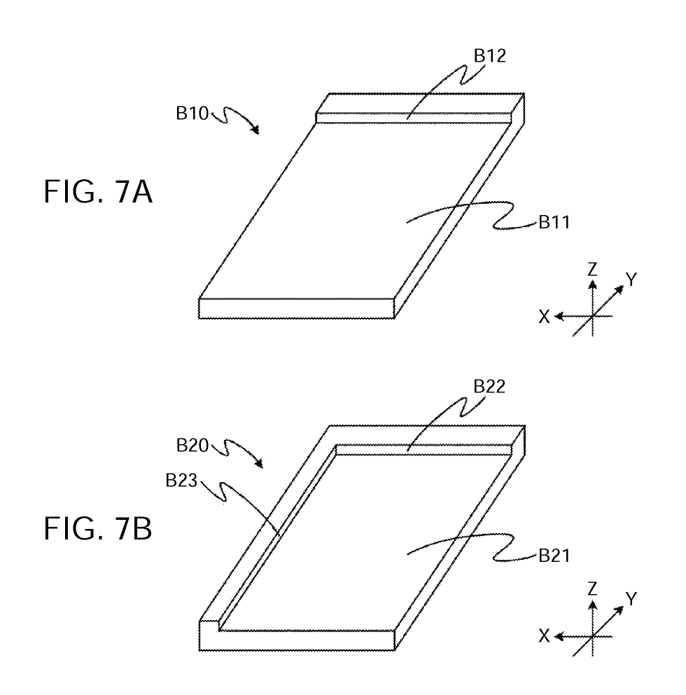

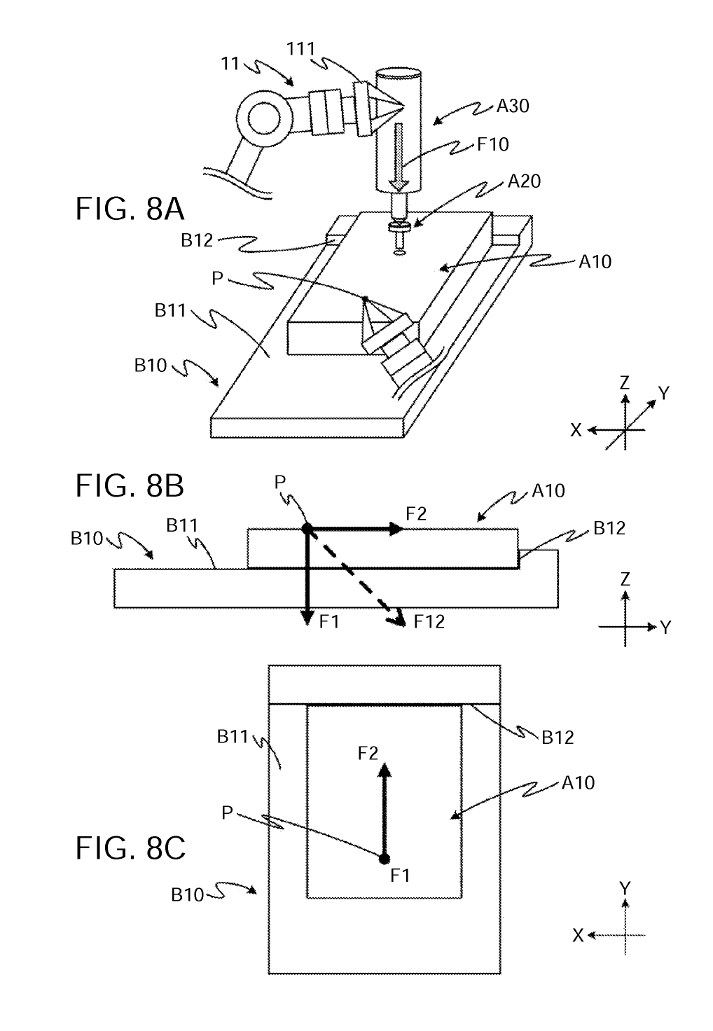

FIGS. 7A and 7B are views illustrating a configuration example of a jig. Since the workpiece A10 is fixed so as to be unmovable, the first work example employs a jig B10 illustrated in FIG. 7A or a jig B20 illustrated in FIG. 8B.

The jig B10 illustrated in FIG. 7A has a rectangular parallelepiped shape, and includes a planar surface B11 on which the workpiece is placed and a surface B12 substantially perpendicular to the surface B11. The surface B11 and the surface B12 function as a positioning portion for positioning the workpiece A10. As will be described in detail later, the robot 1 presses the workpiece A10 in a direction of the surface B11, and presses the workpiece A10 in a direction of the surface B12.

The jig B20 illustrated in FIG. 7B has a rectangular parallelepiped shape, and includes a planar surface B21 on which the workpiece is placed, a surface B22 substantially perpendicular to the surface B21, and a surface B23 substantially perpendicular to the surface B21 and the surface B22. The surface B21, the surface B22, and the surface B23 function as a positioning portion for positioning the workpiece A10. As will be described in detail later, the robot 1 presses the workpiece A10 in a direction of the surface B21, and presses the workpiece A10 in directions of the surface B22 and the surface B23.

The jig B10 and the jig B20 have a simple structure including a function as a workpiece placement place and a function of positioning the workpiece. Therefore, as compared to a dedicated jig corresponding to an individual type of the components, the jig B10 and the jig B20 can be generally used for many more types of the components. This can reduce the costs such as work costs for setting the robot operation which matches an individual dedicated jig.

FIGS. 8A to 8C are views for describing a pressing operation of the robot in the first work example. FIG. 8 illustrates a case of using the jig B10 (refer to FIG. 7A). In FIGS. 7A, 7B, and 7C, the arm 11 and the hand 111 are simplified or omitted. In FIGS. 7B and 7C, the screw A20, the screwdriver A30 and the like are omitted.

For example, in a preparation stage, the controller 20 controls one arm 11 and the hand 111 of the arm, thereby placing the workpiece A10 on the surface B11. The controller 20 controls one arm 11 and the hand 111 of the arm, thereby causing the hand 111 to grip the electric screwdriver A30. Then, the hand 111 is moved, and the screw is set in the screwdriver bit of the electric screwdriver A30 (refer to FIG. 8A).

In a work stage, the controller 20 controls one arm 11 and the hand 111 of the arm, thereby pressing the workpiece A10 against the jig B10. In addition, the controller 20 controls the other arm 11 and the hand 111 of the arm, thereby rotating the electric screwdriver A30 while inserting the screw into the screw hole and pressing the screw against the workpiece A10 (refer to FIG. 8A).

Here, the controller 20 performs a pressing operation in a state where the hand 111 is brought into contact with a predetermined position on the workpiece A10 (refer to FIGS. 8A, 8B, and 8C). For example, any contacting method may be employed as long as the hand 111 comes into contact with the workpiece on one or more surfaces. For convenience of description, a representative position to which a force is applied by the pressing operation for the workpiece A10 will be described as an operating point P. For example, a position of the operating point P can be located farther than a distance from the surface B12 to the screw hole.

Specifically, the controller 20 controls one arm 11, thereby pressing the hand 111 in a direction F1 which is substantially the same as a direction F10 in which the force is applied during a screw fastening work. The direction F1 is substantially perpendicular to the surface B11. In addition, the controller 20 controls one arm 11, thereby pressing the hand 111 in a direction F2 of the surface B12 which is a direction substantially parallel to the surface B11. The direction F2 is substantially perpendicular to an XZ plane including the surface B12. This causes the hand 111 to be pressed in a direction F12 obtained by combining the direction F1 and the direction F2 by setting the operating point P to be an original point (that is, the workpiece A10 is pressed against the jig B10 in the direction F12).

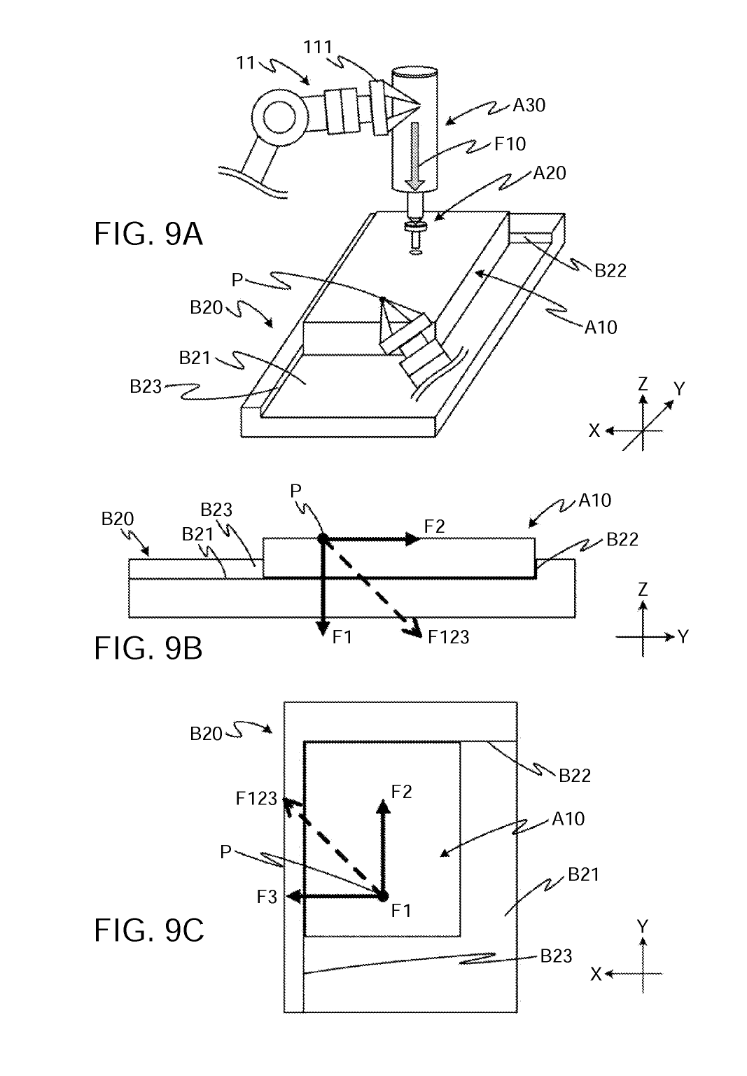

FIGS. 9A to 9C are views for describing a pressing operation of the robot in the first work example. FIGS. 9A to 9C illustrate a case of using the jig B20 (refer to FIG. 7B). Description will be made by focusing on points different from those in a case of FIGS. 8A to 8C.

In the preparation stage, for example, the controller 20 places the workpiece A10 on the surface B21. In addition, the screw is set in the screwdriver bit of the electric screwdriver A30 (refer to FIG. 9A). Thereafter, in the work stage, the controller 20 causes one arm 11 and the hand 111 to press the workpiece A10 against the jig B20. In addition, the controller 20 causes the other arm 11 and the hand 111 to rotate the electric screwdriver A30 while inserting the screw into the screw hole and pressing the screw against the workpiece A10 (refer to FIG. 9A).

Here, the controller 20 performs a pressing operation in a state where the hand 111 is brought into contact with a predetermined position on the workpiece A10 (refer to FIGS. 9A, 9B, and 9C). For example, a position of the operating point P can be located farther than a distance from the surface B22 and the surface B23 to the screw hole.

Specifically, the controller 20 controls one arm 11, thereby pressing the hand 111 in the direction F1 which is substantially the same as a direction F10 in which the force is applied during the screw fastening work. The direction F1 is substantially perpendicular to the surface B21. In addition, the controller 20 controls one arm 11, thereby pressing the hand 111 in the direction F2 of the surface B22 which is a direction substantially parallel to the surface B21. The direction F2 is substantially perpendicular to the XZ plane including the surface B22. Furthermore, the controller 20 controls one arm 11, thereby pressing the hand 111 in a direction F3 of the surface B23 which is a direction substantially parallel to the surface B21. The direction F3 is substantially perpendicular to a YZ plane including the surface B23. This causes the hand 111 to be pressed in a direction F123 obtained by combining the direction F1, the direction F2, and the direction F3 by setting the operating point P to be the original point (that is, the workpiece A10 is pressed against the jig B20 in the direction F123).

The hand 111 presses the workpiece against a general jig in the above-described directions. In this manner, it is possible to more reliably fix the workpiece so as to be unmovable during the screw fastening work.

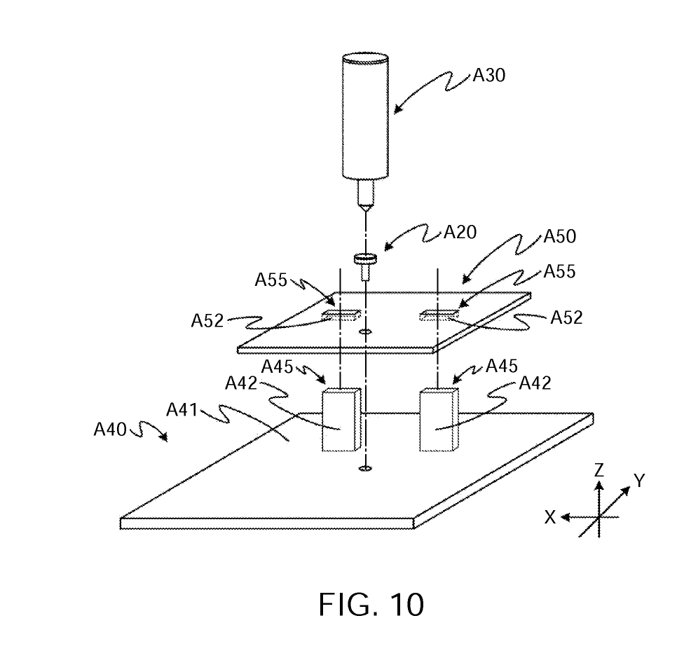

FIG. 10 is a view for describing a second work example carried out by the robot. In the second work example, a workpiece A50 is arranged at a predetermined position on a workpiece A40 serving as a base, a screw hole formed in the workpiece A50 and a screw hole formed in the workpiece A40 are overlapped with each other, and the screw A20 is inserted into the overlapped screw holes, thereby performing screw fastening (the workpiece A50 is fastened to the workpiece A40). Similar to the first work example, the electric screwdriver A30 is used in order to perform the screw fastening of the screw A20.

The workpiece A40 has a flat plate shape, and includes a planar surface A41 on which the workpiece A50 is placed. Two flat plate-shaped locking portions A45 substantially perpendicular to the surface A41 are disposed at respectively independent positions on the surface A41. The respective locking portions A45 includes planar surfaces A42 (forward side in the drawing) substantially perpendicular to the surface A41.

The workpiece A50 has a flat plate shape, and has two holes A55 which the respective locking portions A45 penetrate. The respective holes A55 include surfaces A52 (forward side in the drawing) which face the surfaces A42 of the locking portions A45 in a state the locking portions A45 penetrate the holes A55. Here, the workpiece A50 is moved in a direction of the surface A42, and the surface A52 comes into contact with the surface A42, thereby positioning the workpiece A50. In this manner, the screw hole of the workpiece A40 and the screw hole of the workpiece A50 are overlapped with each other. The surface A41 and the surface A42 function as a positioning portion for positioning the workpiece A50.

As will be described later, in a state where the locking portion A45 penetrates the hole A55, the robot 1 presses the workpiece A50 in a direction of the surface A41, and presses the workpiece A50 in a direction of the surface A42.

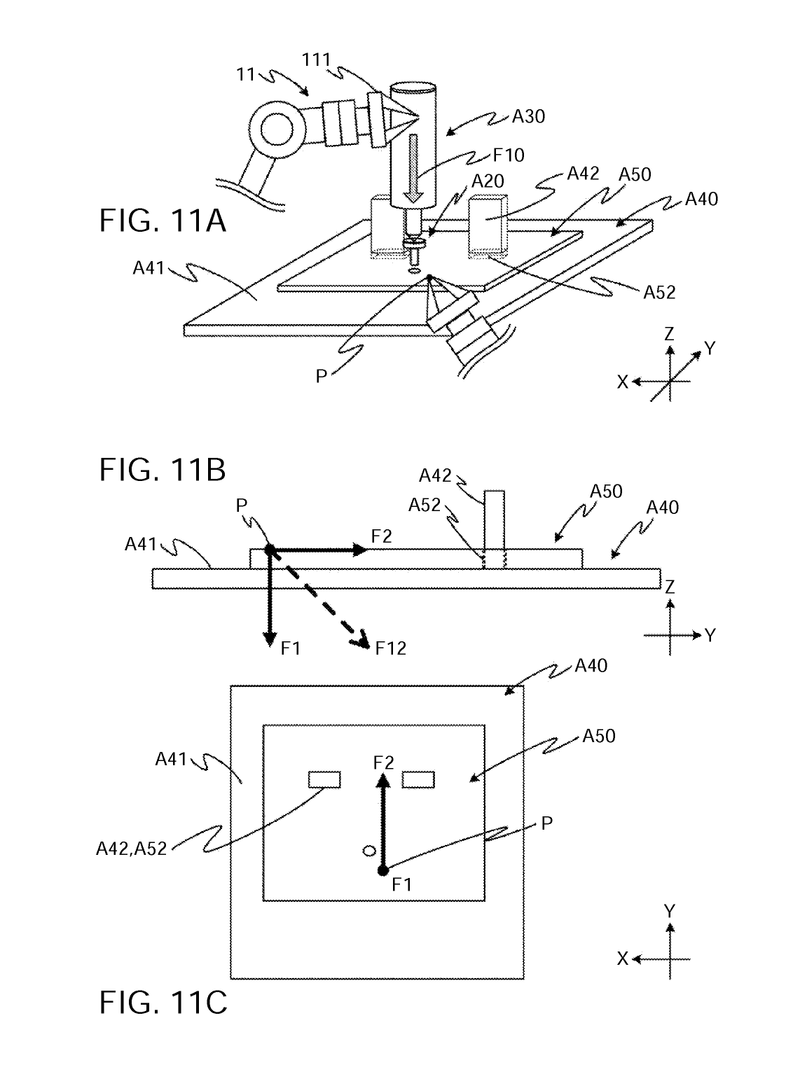

FIGS. 11A to 11C are views for describing a pressing operation of the robot in the second work example. In FIGS. 11A, 11B, and 11C, the arm 11 and the hand 111 are simplified or omitted. In addition, in FIGS. 11B and 11C, the screw A20, the screw driver 30 and the like are omitted.

In the preparation stage, for example, the controller 20 controls one arm 11 and the hand 111 of the arm 11, thereby placing the workpiece A40 on the surface B11 of the jig B10 (the jig B10 is not illustrated). In addition, the controller 20 controls one arm 11 and the hand 111 of the arm, thereby causing the hand 111 to grip the workpiece A50. Then, the locking portions A45 are caused to penetrate the respective holes A55, and the workpiece A50 is placed on the surface A41 of the workpiece A40. In addition, the controller 20 controls one arm 11 and the hand 111 of the arm, thereby causing the hand 111 to grip the electric screwdriver A30. Then, the hand 111 is moved, and a screw is set in the screwdriver bit of the electric screwdriver A30 (refer to FIG. 11A).

In the work stage, the controller 20 controls one arm 11 and the hand 111 of the arm, thereby pressing the workpiece A50 against the workpiece A40. In addition, the controller 20 controls the other arm 11 and the hand 111 of the arm, thereby rotating the electric screwdriver A30 while inserting the screw into the screw hole of the workpiece A50 and the screw hole of the workpiece A40 and pressing the screw against the workpiece A50 (refer to FIG. 11A).

Here, the controller 20 performs the pressing operation in a state where the hand 111 is brought into contact with a predetermined position on the workpiece A50 (refer to FIGS. 11A, 11B, and 11C). For example, the position of the operating point P can be located farther than a distance from the surface A52 to the screw hole.

Specifically, the controller 20 controls one arm 11, thereby pressing the hand 111 in the direction F1 which is substantially the same as the direction F10 in which the force is applied during the screw fastening work. The direction F1 is substantially perpendicular to the surface A41. In addition, the controller 20 controls one arm 11, thereby pressing the hand 111 in the direction F2 of the surface A42 which is a direction substantially parallel to the surface A41. The direction F2 is substantially perpendicular to the XZ plane including the surface A42 and the surface A52. This causes the hand 111 to be pressed in the direction F12 obtained by combining the direction F1 and the direction F2 by setting the operating point P to be the original point (that is, the workpiece A50 is pressed against the workpiece A40 in the direction F12).

If necessary, the controller 20 may further press the hand 111 in the direction F3 (not illustrated) which is substantially perpendicular to the direction F1 and the direction F2. This causes the hand 111 to be pressed in the direction F123 obtained by combining the direction F1, the direction F2, and the direction F3 by setting the operating point P to be the original point (that is, the workpiece A50 is pressed against the workpiece A40 in the direction F123).

The hand 111 presses the workpiece against the workpiece serving as a base in the above-described directions. In this manner, it is possible to more reliably fix the workpiece so as to be unmovable during the screw fastening work.

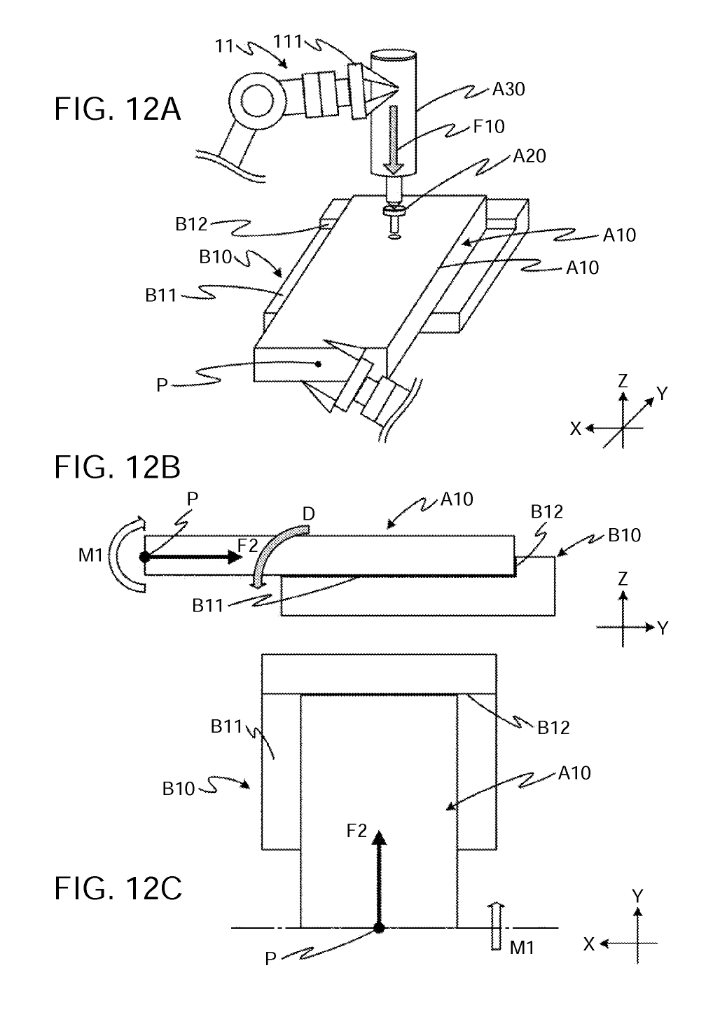

Next, FIGS. 12A to 12C are views for describing a pressing operation of the robot in a third work example. The third work example is basically the same as the first work example. However, in the third work example, a length in a longitudinal direction (direction Y in the drawing) of the workpiece A10 is longer than a length in a longitudinal direction (direction Y in the drawing) of the jig B10. Therefore, when the workpiece A10 is placed on the surface B11 of the jig B10, a portion of the workpiece A10 protrudes outward from the surface B11. In this case, the workpiece A10 loses balance due to the weight of the protruding portion, thereby causing a possibility that the workpiece A10 is tilted in a direction D about an edge of the jig B10 as a fulcrum (refer to FIG. 12B). Therefore, the controller 20 causes the hand 111 to press and support the workpiece A10 so as to maintain a posture of the workpiece A10.

Here, the controller 20 performs the pressing operation in a state where the hand 111 grips one end protruding outward from the surface B11 (refer to FIGS. 12A, 12B, and 12C). For example, any gripping method may be employed as long as two or more fingers come into contact with the workpiece on multiple surfaces. For convenience of description, a representative position to which the force is applied by the pressing operation for the workpiece A10 will be described as the operating point P.

Specifically, the controller 20 controls one arm 11, thereby pressing the hand 111 in the direction F2 which is a direction substantially parallel to the surface B11 and which is the direction of the surface B12. In addition, the controller 20 controls one arm 11, thereby setting an axis which is substantially orthogonal to the direction F2, which is substantially parallel to the surface B11, and which passes through the operating point P. In this manner, the hand 111 is pressed so as to generate a moment M1 around the axis (rotation direction in which the force is applied to the jig 10B, clockwise direction when the workpiece A10 is viewed in a direction X in the drawing). The controller 20 may set an axis which is substantially orthogonal to the direction F2 and which is orthogonal to the direction F1 substantially the same as the direction F10 in which the force is applied during the screw fastening work. The controller 20 may set an axis which is substantially parallel to the axis substantially orthogonal to the direction F2 and which is substantially parallel to the surface B11. In this manner, the workpiece A10 is pressed against the jig B10 in the direction F2, and is pressed in the rotation direction of the moment M1. The moment M1 applies the force acting in the direction of the surface B11 to the workpiece A10. Accordingly, a surface in contact with the surface B11 of the workpiece A10 is pressed against the surface B11. For example, in a case of using the jig B20, if necessary, the hand 111 may be pressed in the direction F3 (not illustrated) which is orthogonal to both the direction F1 and the direction F2.

The above-described directions and moment cause the hand 111 to press the workpiece against a general jig. Accordingly, even when the workpiece protrudes from the jig, it is possible to more reliably fix the workpiece so that the workpiece is unmovable during the screw fastening work. In addition, it is possible to support the workpiece so as not to lose the balance. The pressing direction and the moment can also be applied to a case where the workpiece placed on the workpiece serving as a base protrudes from the workpiece serving as the base.

Hitherto, the embodiment of the invention has been described. According to the embodiment, in the work carried out by the robot, it is possible to cause the workpiece such as the component to be more reliably unmovable. In addition, even in a case of using a versatile jig, it is possible to cause the workpiece such as the component to be more reliably unmovable. In addition, since the versatile jig can be used, it is possible to reduce the costs.

The configuration of the jig or the component is not limited to the illustrated configuration. That is, any configuration may be adopted as long as the jig and the workpiece serving as the base include the first surface on which the workpiece is placed, and the second surface which is substantially perpendicular to the first surface. Then, the robot 1 may press the workpiece placed on the first surface in the planar direction which is substantially perpendicular to the direction in which the force is applied during the screw fastening work (screw inserting direction), and may press the workpiece in the direction in which the force is applied during the screw fastening work. Alternatively, the robot 1 may press the workpiece placed on the first surface in the planar direction which is substantially perpendicular to the direction in which the force is applied during the screw fastening work (screw inserting direction), and may press the workpiece by using the moment corresponding to the direction in which the force is applied during the screw fastening work. In addition, if necessary, the robot 1 may press the workpiece placed on the first surface in a direction which is substantially perpendicular to both the planar direction which is substantially perpendicular to the direction in which the force is applied during the screw fastening work (screw inserting direction) and the direction in which the force is applied during the screw fastening work.

In the above-described embodiment, the screw fastening work has been described as an example, but the contents of the work are not limited thereto. For example, the contents of the work may include work for inserting a member such as a pin into a workpiece, or work for driving a member such as staple (needle) into a workpiece. Even in these cases, the direction in which the force is applied during the work is the same as the screw inserting direction.

In the above-described embodiment, the position for pressing the hand 111 against the workpiece or the position for bringing the finger into contact with the workpiece has been described as a surface of the workpiece, but may be an edge or a vertex of the workpiece. In addition, in the above-described embodiment, a form of the hand 111 when the hand 111 is pressed against the workpiece is not particularly limited. For example, the hand 111 may be pressed by bringing one or more fingers into contact with the workpiece in a state where the hand 111 is closed (state where the fingers 111B are caused to be close to each other). In addition, for example, the hand 111 may be pressed by bringing one or more fingers into contact with the workpiece in a state where the hand 111 is opened (state where the fingers 111B are caused to be away from each other).

In the above-described embodiment, description is made so that the workpiece and the jig, the workpiece and the workpiece, or the robot and the workpiece are in contact with each other on the surface. However, even in a case of point contact or linear contact, there is provided a physically constant area. Accordingly, the point contact or the linear contact can be considered to be the same as the surface contact.

Hitherto, the invention has been described using the embodiment. However, the technical scope of the invention is not limited to the scope described in the above-described embodiment. It is apparent to those skilled in the art that various modifications or improvements can be added to the above-described embodiment. In addition, it is apparent from the scope according to an aspect of the invention that the modified or improved embodiment is also included in the technical scope of the invention. The invention may be provided as a robot system which separately has a robot and a control device (controller), or may be provided as a robot and a control device for a robot system. In addition, the invention may be provided as a method of controlling a robot, a program for controlling the robot, or a storage medium for storing the program.

### Second Embodiment

Hereinafter, a second embodiment will be described. The same reference numerals are given to elements which are the same as those in the first embodiment, and description thereof will be omitted.

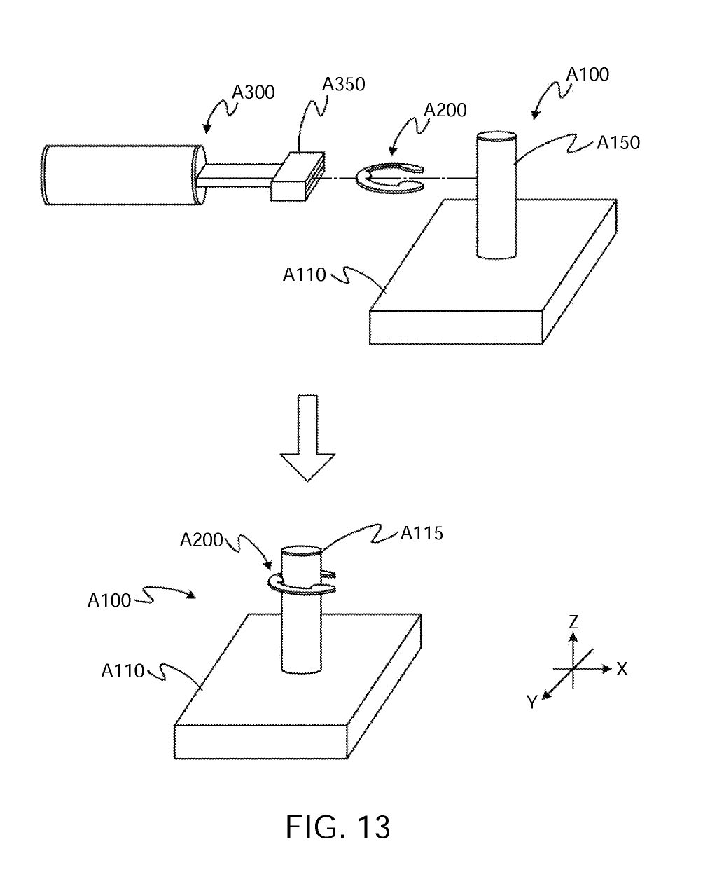

FIG. 13 is a view for describing the first work example carried out by the robot. In the first work example, a retaining ring A200 is fitted (assembled) to a rod-shaped shaft portion A150 of a workpiece A100.

The workpiece A100 has a rectangular parallelepiped main body portion A110 and the rod-shaped shaft portion A150 disposed to be substantially perpendicular to one surface of the main body portion A110. A groove (not illustrated) into which the retaining ring A200 is fitted is formed on an outer periphery (side surface) of the shaft portion A150.

The retaining ring A200 has an annular shape when viewed in a direction Z, and has a shape whose ring is partially open. The retaining ring A200 is fitted into the groove (not illustrated) formed on the outer periphery of the shaft portion A150 in a direction substantially perpendicular to the longitudinal direction of the shaft portion A150. For example, the retaining ring A200 is also called a snap ring or a stop ring. More specifically, for example, the retaining ring A200 includes an E-ring and a C-ring.

For example, assembling of the retaining ring A200 is performed by the robot 1 using a tool A300 used by humans. The tool A300 has a receiving portion A350 for receiving the retaining ring A200. The receiving portion A350 has a groove into which a portion of the retaining ring A200 is inserted. Therefore, the retaining ring A200 can be moved in a state where the retaining ring A200 is set in the groove of the receiving portion A350.

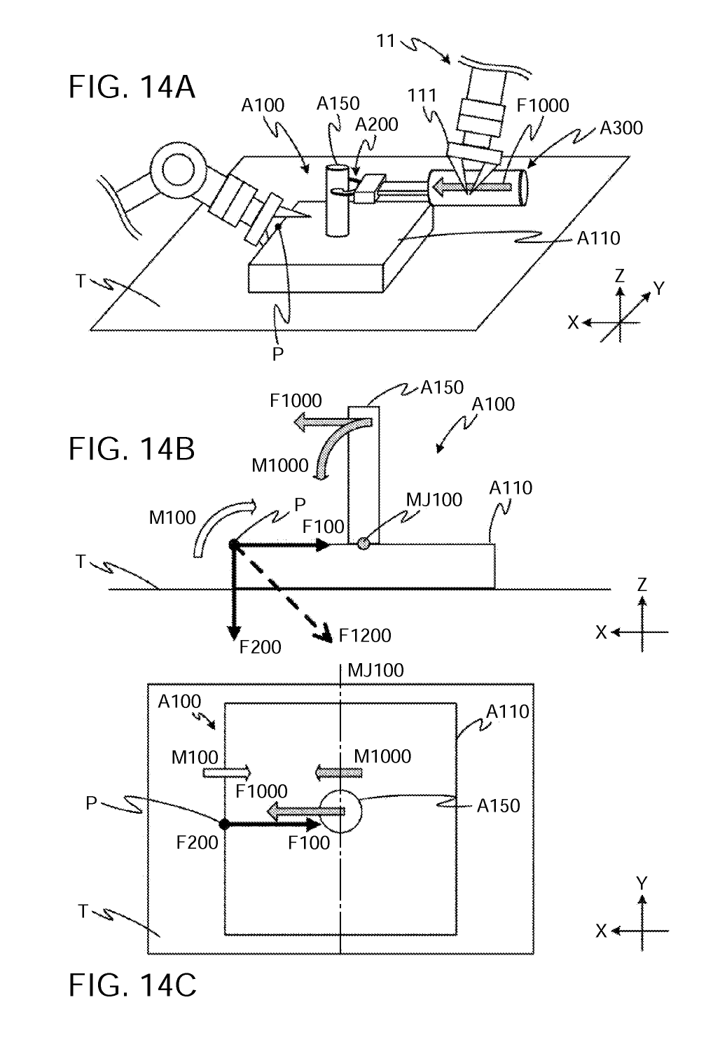

FIGS. 14A to 14C are views for describing a first example of a pressing operation of the robot in the first work example. FIGS. 14A to 14C illustrate a case where an assembling work of the retaining ring A200 is carried out by placing the workpiece A100 on the working table T so that a distal end of the shaft portion A150 faces upward (in the direction Z). In FIGS. 14A, 14B, and 14C, the arm 11 and the hand 111 are simplified or omitted. In addition, in FIGS. 14B and 14C, the retaining ring A200, the tool A300 and the like are omitted.

In the preparation stage, for example, the controller 20 controls one arm 11 and the hand 111 of the arm, thereby placing the workpiece A100 on the working table T so that a bottom surface of the main body portion A110 of the workpiece A100 comes into contact with the working table T. In addition, the controller 20 controls one arm 11 and the hand 111 of the arm, thereby causing the hand 111 to grip the tool A300. In this manner, the hand 111 is moved, and the retaining ring A200 is set in the receiving portion A350 (refer to FIG. 14A).

In the work stage, the controller 20 controls one arm 11 and the hand 111 of the arm (which grips the tool A300), thereby pressing the retaining ring A200 against the shaft portion A150 in a direction F1000. The direction F1000 is the direction in which the force is applied during the assembling work, is substantially parallel to the working table T, and is substantially orthogonal to the longitudinal direction of the shaft portion A150.

Here, if the shaft portion A150 is pressed in the direction F1000, a moment M1000 is generated in the overall workpiece A100. The moment M1000 is substantially parallel to an axis substantially orthogonal to the direction F1000, and is a counterclockwise moment when the workpiece A100 is viewed in the direction Y, with regard to an axis MJ100 substantially parallel to the working table T. The moment M1000 acts so that the main body portion A110 floats from the working table T about one side edge in the direction F1000 as a fulcrum, within the bottom surface in which the main body portion A110 comes into contact with the working table T. Therefore, the controller 20 causes one hand 111 to press the retaining ring A200, and simultaneously causes the other hand 111 to support the workpiece A100 so as to maintain a position and a posture of the workpiece A100.

Specifically, the controller 20 controls the other arm 11 and the hand 111 of the arm, thereby causing the hand 111 to grip at a predetermined position on the main body portion A110 of the workpiece A100. For example, any gripping method may be employed as long as the hand 111 comes into contact with the workpiece on one or more surfaces. For convenience of description, a representative position to which the force is applied by an operation for supporting the workpiece A100 will be described as the operating point P. If the workpiece A100 has the above-described shape, for example, it is preferable that the position of the operating point P be located to be substantially perpendicular to the longitudinal direction of the shaft portion A150 and on a line segment on the main body portion A110 in the direction F1000, or near the line segment. As the gripping position is farther away from the axis MJ100 in the direction F1000, a magnitude of the moment M100 (to be described later) can be decreased.

Then, the controller 20 controls the other arm 11, thereby pressing the hand 111 in a direction F100 opposite to the direction F1000 during the assembling work. In addition, the controller 20 controls the other arm 11, thereby pressing the hand 111 in a direction F200 which is substantially orthogonal to the working table T. The direction F200 is substantially perpendicular to the direction F100. In addition, the controller 20 operates the hand 111 so as to generate the moment M100 opposite (in the opposite rotation direction) to the moment M1000. For example, the controller 20 sets an axis MJ10 (not illustrated) which is substantially parallel to the axis substantially orthogonal to the direction F100 and is substantially parallel to the working table T, and presses the hand 111 by changing a posture of the arm 11 so as to generate the moment M100 around the axis (in the drawing, clockwise direction when the workpiece A100 is viewed in the direction Y). The axis MJ10 and the axis MJ100 may be located at the same position, or may be located at respectively different positions. This enables the workpiece A100 to be pressed against the working table T in a direction F1200 obtained by combining the direction F100 and the direction F200 about the operating point P as a point of origin, and to be pressed in the rotation direction of the moment M100.

In a case of FIGS. 14A to 14C, the pressing operation in the direction F200 is not essential. The reason is that applying the moment M100 to the workpiece A100 generates an effect in which the bottom surface of the workpiece A100 is pressed against the working table T in the direction F200.

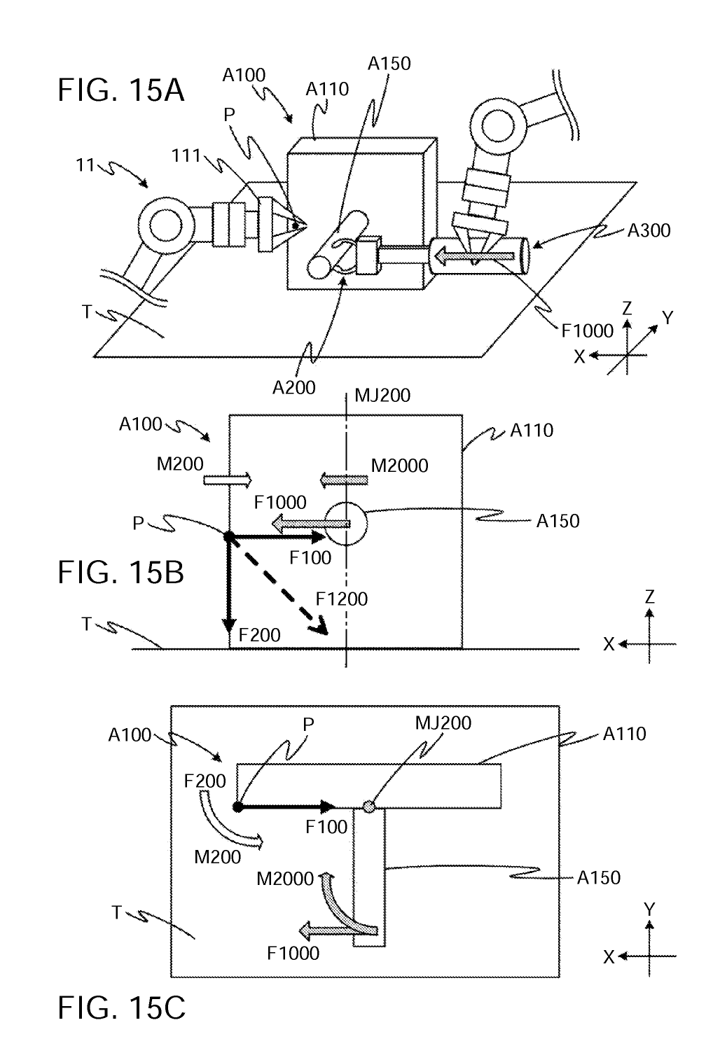

FIGS. 15A to 15C are views for describing a second example of the pressing operation of the robot in the first work example. FIGS. 15A to 15C illustrate a case where the assembling work of the retaining ring A200 is carried out by placing the workpiece A100 on the working table T so that the distal end of the shaft portion A150 faces sideways (direction opposite to the direction Y). In FIGS. 15A, 15B, and 15C, the arm 11 and the hand 111 are simplified or omitted. In FIGS. 15B and 15C, the retaining ring A200, the tool A300 and the like are omitted.

In the preparation stage, for example, the controller 20 controls one arm 11 and the hand 111 of the arm, thereby placing the workpiece A100 on the working table T so that a side surface of the main body portion A110 of the workpiece A100 comes into contact with the working table T. In addition, the controller 20 controls one arm. 11 and the hand 111 of the arm, thereby causing the hand 111 to grip the tool A300. In this manner, the hand 111 is moved, and the retaining ring A200 is set in the receiving portion A350 (refer to FIG. 15A).

In the work stage, the controller 20 controls one arm 11 and the hand 111 of the arm (which grips the tool A300), thereby pressing the retaining ring A200 against the shaft portion A150 in a direction F1000. The direction F1000 is the direction in which the force is applied during the assembling work, is substantially parallel to the working table T, and is substantially orthogonal to the longitudinal direction of the shaft portion A150.

Here, if the shaft portion A150 is pressed in the direction F1000, a moment M2000 is generated in the overall workpiece A100. The moment M2000 is substantially parallel to an axis substantially orthogonal to the direction F1000, and is a clockwise moment when the workpiece A100 is viewed in the direction Z side, with regard to an axis MJ200 substantially perpendicular to the working table T. The moment M2000 acts so that a side surface where the main body portion A110 comes into contact with the working table T slides on the working table T. Therefore, the controller 20 causes one hand 111 to press the retaining ring A200, and simultaneously causes the other hand 111 to support the workpiece A100 so as to maintain a position and a posture of the workpiece A100.

Specifically, the controller 20 controls the other arm 11 and the hand 111 of the arm, thereby causing the hand 111 to grip at a predetermined position on the main body portion A110 of the workpiece A100. For example, any gripping method may be employed as long as the hand 111 comes into contact with the workpiece on one or more surfaces. For convenience of description, a representative position to which the force is applied by an operation for supporting the workpiece A100 will be described as the operating point P. If the workpiece A100 has the above-described shape, for example, it is preferable that the position of the operating point P be located to be substantially perpendicular to the longitudinal direction of the shaft portion A150 and on a line segment on the main body portion A110 in the direction F1000, or near the line segment. As the gripping position is farther away from the axis MJ200 in the direction F1000, a magnitude of the moment M200 (to be described later) can be decreased.

Then, the controller 20 controls the other arm 11, thereby pressing the hand 111 in the direction F100 opposite to the direction F1000 during the assembling work. In addition, the controller 20 controls the other arm 11, thereby pressing the hand 111 in the direction F200 which is substantially orthogonal to the working table T. The direction F200 is substantially perpendicular to the direction F100. In addition, the controller 20 operates the hand 111 so as to generate the moment M200 opposite (in the opposite rotation direction) to the moment M2000. For example, the controller 20 sets an axis MJ20 (not illustrated) which is substantially parallel to the axis substantially orthogonal to the direction F100 and is substantially orthogonal to the working table T, and presses the hand 111 by changing a posture of the arm 11 so as to generate the moment M200 around the axis (in the drawing, counterclockwise direction when the workpiece A100 is viewed in the direction Z side). The axis MJ20 and the axis MJ200 may be located at the same position, or may be located at respectively different positions. This enables the workpiece A100 to be pressed against the working table T in the direction F1200 obtained by combining the direction F100 and the direction F200 about the operating point Pas a point of origin, and to be pressed in the rotation direction of the moment M200.

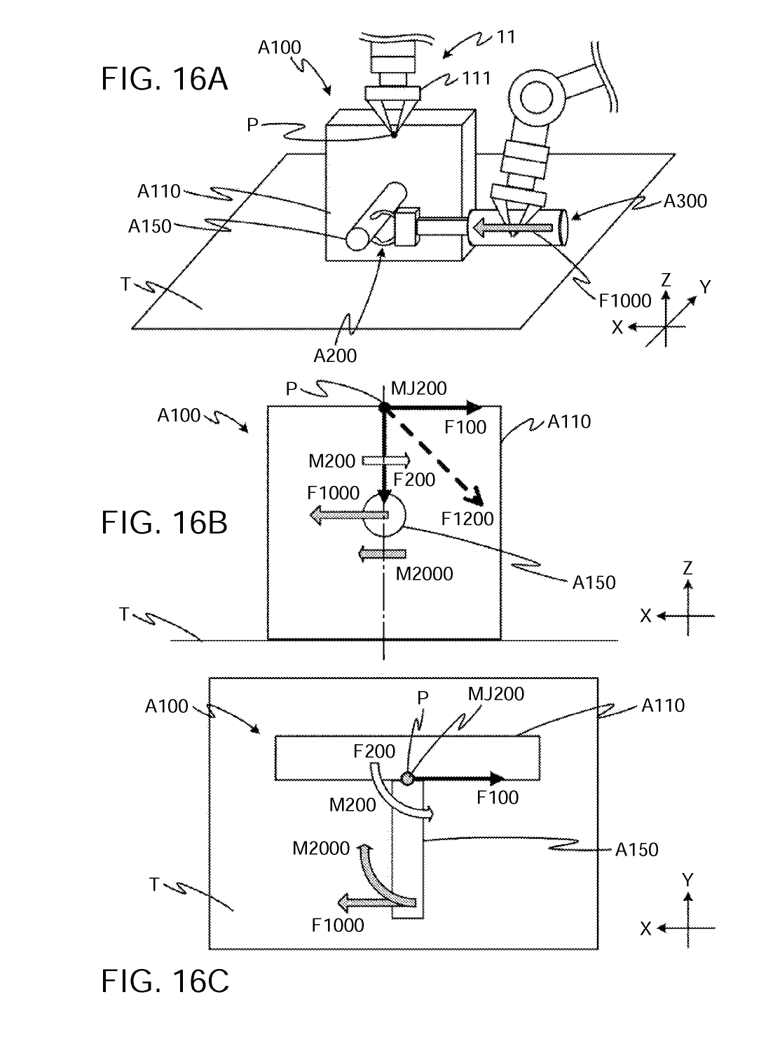

FIGS. 16A to 16C are views for describing a third example of the pressing operation of the robot in the first work example. Hereinafter, description will be made by focusing on points different from those in FIGS. 15A to 15C.

A placing method for the workpiece A100 is the same as that in FIGS. 15A to 15C. In addition, the direction F1000 in which the retaining ring A200 is pressed against the shaft portion A150 is the same as that in FIGS. 15A to 15C. In contrast, the position of the operating point P is different from that in FIGS. 15A to 15C. In FIGS. 16A to 16C, for example, it is preferable that the position of the operating point P be located to be substantially perpendicular to the longitudinal direction of the shaft portion A150 and on a line segment on the main body portion A110 in the direction (direction Z) substantially perpendicular to the working table T, or near the line segment.

In a case of the operating point P as illustrated in FIGS. 16A to 16C, the controller 20 also controls the other arm 11, similar to the case in FIGS. 15A to 15C. That is, the controller 20 controls the other arm 11, thereby pressing the hand 111 in the direction F100 and the direction F200. In addition, the controller 20 sets the axis MJ20 (not illustrated), and presses the hand 111 by changing a posture of the arm 11 so as to generate the moment M200 around the axis (in the drawing, counterclockwise direction when the workpiece A100 is viewed in the direction Z side). The axis MJ20 and the axis MJ200 may be located at the same position, or may be located at respectively different positions. This enables the workpiece A100 to be pressed against the working table T in the direction F1200 obtained by combining the direction F100 and the direction F200 about the operating point P as a point of origin, and to be pressed in the rotation direction of the moment M200.

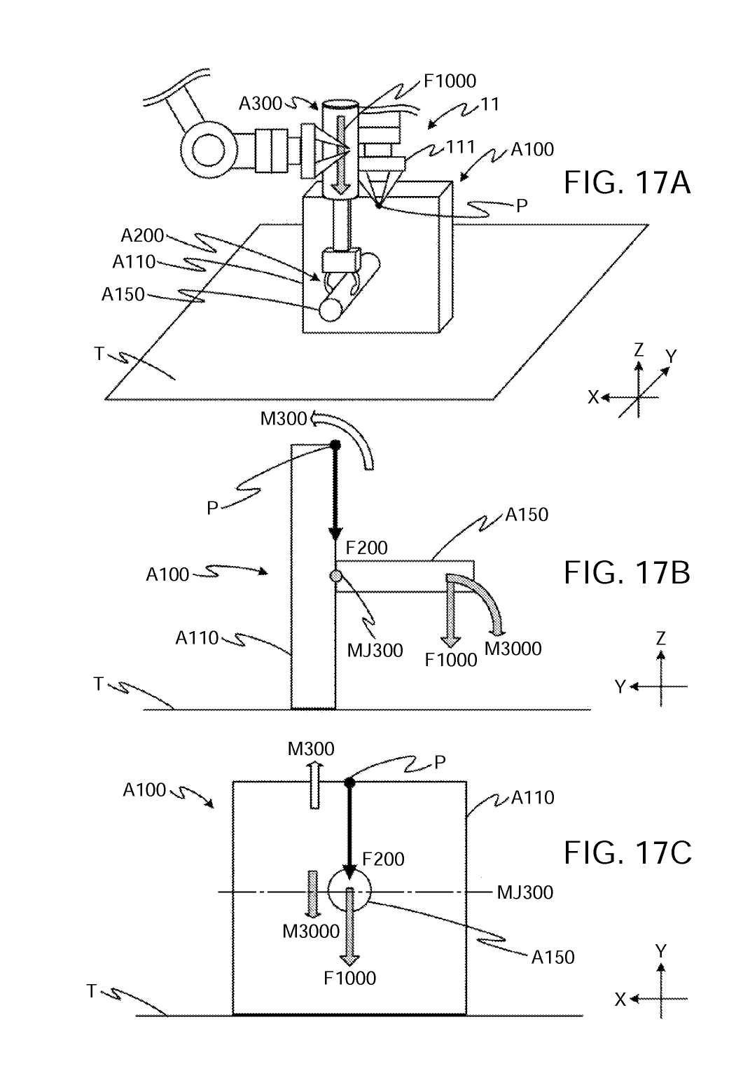

FIGS. 17A to 17C are views for describing a fourth example of the pressing operation of the robot in the first work example. Hereinafter, description will be made by focusing on points different from those in FIGS. 15A to 15C and FIGS. 16A to 16C.

A placing method for the workpiece A100 is the same as that in FIGS. 15A to 15C. In addition, the position of the operating point P is the same as that in FIGS. 16A to 16C. In contrast, the direction F1000 is different from that in FIGS. 15A to 15C and FIGS. 16A to 16C. In FIGS. 17A to 17C, the direction F1000 is a direction in which the force is applied during the assembling work, is substantially perpendicular to the working table T, and is substantially orthogonal to the longitudinal direction of the shaft portion A150.

Here, if the shaft portion A150 is pressed in the direction F1000, a moment M3000 is generated in the overall workpiece A100. The moment M3000 is a clockwise moment when the workpiece A100 is viewed in the direction X side, with regard to an axis MJ300 substantially parallel to the axis which is substantially orthogonal to both the direction F1000 and the longitudinal direction of the shaft portion A150. The moment M3000 acts so that the main body portion A110 floats from the working table T about one side edge close to the shaft portion A150 (direction opposite to the direction Y) as a fulcrum, within the side surface in which the main body portion A110 comes into contact with the working table T. Therefore, the controller 20 causes one hand 111 to press the retaining ring A200, and simultaneously causes the other hand 111 to support the workpiece A100 so as to maintain a position and a posture of the workpiece A100.

That is, the controller 20 controls the other arm 11, thereby pressing the hand 111 in the direction F200 which is substantially orthogonal to the working table T. The direction F200 is substantially parallel to the direction F1000. In addition, the controller 20 operates the hand 111 so as to generate the moment M300 opposite (in the opposite rotation direction) to the moment M3000. For example, the controller 20 sets an axis MJ30 (not illustrated) which is substantially parallel to the axis substantially orthogonal to the direction F200 and is substantially parallel to the bottom surface of the main body portion A110, and presses the hand 111 by changing a posture of the arm 11 so as to generate the moment M300 around the axis (in the drawing, counterclockwise direction when the workpiece A100 is viewed in the direction X side). The axis MJ30 and the axis MJ300 may be located at the same position, or may be located at respectively different positions. This enables the workpiece A100 to be pressed against the working table T in the direction F200 about the operating point P as a point of origin, and to be pressed in the rotation direction of the moment M300.

In a case of FIGS. 17A to 17C, the pressing operation in the direction F200 is not essential. The reason is that applying the force in the direction F1000 to the workpiece A100 generates an effect in which the side surface of the workpiece A100 is pressed against the working table T in the direction F200.

The above-described direction and moment cause the hand 111 to press and support the workpiece. In this manner, it is possible to more reliably fix the workpiece so that the workpiece is unmovable or does not float during the assembling work. The pressing direction and the moment can also be applied to a case where the assembling work is carried out for the workpiece A100 placed on the workpiece serving as a base.

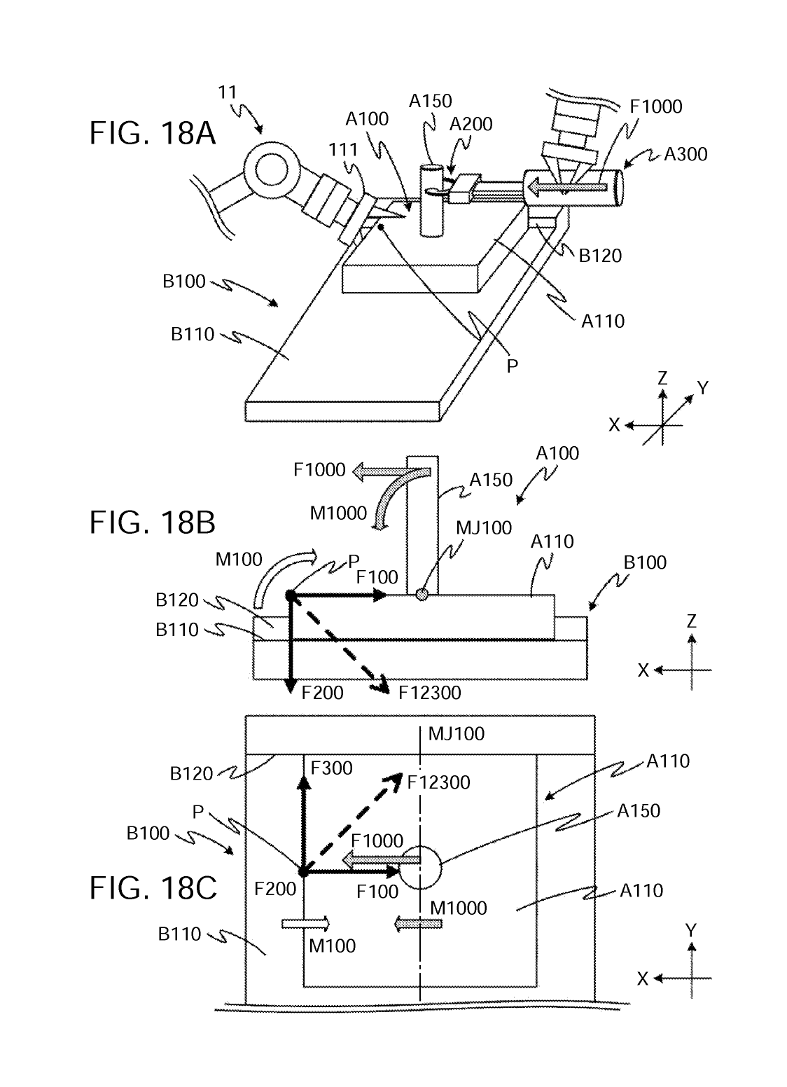

FIGS. 18A to 18C are views for describing a fifth example of the pressing operation of the robot in the first work example. FIGS. 18A to 18C illustrate a case where the first work example is carried out by using a jig B100. In addition, FIGS. 18A to 18C illustrate a case where the assembling work of the retaining ring A200 is carried out by placing the workpiece A100 on the jig B100 so that the distal end of the shaft portion A150 faces upward (in the direction Z). In FIGS. 18A, 18B, and 18C, the arm 11 and the hand 111 are simplified or omitted. In FIGS. 18B and 18C, the retaining ring A200 and the tool A300 are omitted.

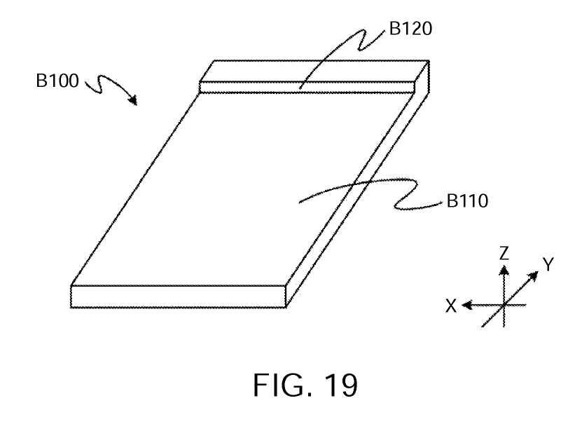

For example, the jig B100 is configured as illustrated in FIG. 19 (view illustrating a configuration example of the jig). The jig B100 has a rectangular parallelepiped shape, and includes a planar surface B110 on which the workpiece is placed and a surface B120 substantially perpendicular to the surface B110. The surface B110 and the surface B120 function as a positioning portion for positioning the workpiece A100.

Referring back to the description in FIGS. 18A to 18C, in the preparation stage, for example, the controller 20 controls one arm 11 and the hand 111 of the arm, thereby placing the workpiece A100 on the surface B110. In addition, the controller 20 controls one arm 11 and the hand 111 of the arm, thereby causing the hand 111 to grip the tool A300. In this manner, the hand 111 is moved, and the retaining ring A200 is set in the receiving portion A350 (refer to FIG. 18A).

In the work stage, the controller 20 controls one arm 11 and the hand 111 of the arm (which grips the tool A300), thereby pressing the retaining ring A200 against the shaft portion A150 in the direction F1000. The direction F1000 is the direction in which the force is applied during the assembling work, is substantially parallel to the surface B110, and is substantially orthogonal to the longitudinal direction of the shaft portion A150.

Here, if the shaft portion A150 is pressed in the direction F1000, the moment M1000 is generated in the overall workpiece A100. The moment M1000 is substantially parallel to the axis substantially orthogonal to the direction F1000, and is a counterclockwise moment when the workpiece A100 is viewed in the direction Y, with regard to the axis MJ100 substantially parallel to the surface B110. The moment M1000 acts so that the main body portion A110 floats from the surface B110 about one edge in the direction F1000 side as a fulcrum, within the bottom surface in which the main body portion A110 comes into contact with the surface B110. Therefore, the controller 20 causes one hand 111 to press the retaining ring A200, and simultaneously causes the other hand 111 to support the workpiece A100 so as to maintain a position and a posture of the workpiece A100.

Specifically, the controller 20 controls the other arm 11 and the hand 111 of the arm, thereby causing the hand 111 to grip at a predetermined position on the main body portion A110 of the workpiece A100. The gripping method and the position of the operating point P are the same as those in FIGS. 14A to 14C.

Then, the controller 20 controls the other arm 11, thereby pressing the hand 111 in the direction F100 opposite to the direction F1000 during the assembling work. In addition, the controller 20 controls the other arm 11, thereby pressing the hand 111 in the direction F200 which is substantially orthogonal to the surface B110. The direction F200 is substantially perpendicular to the direction F100. Furthermore, the controller 20 controls the other arm 11, thereby pressing the hand 111 in the direction F300 of the surface B120 which is the direction substantially parallel to the surface B110. The direction F300 is substantially perpendicular to the XZ plane including the surface B120. In addition, the controller 20 operates the hand 111 so as to generate the moment M100 opposite (in the opposite rotation direction) to the moment M1000. For example, the controller 20 sets the axis MJ10 (not illustrated) which is substantially parallel to the axis substantially orthogonal to the direction F100 and is substantially parallel to the surface B110, and presses the hand 111 by changing a posture of the arm 11 so as to generate the moment M100 around the axis (in the drawing, clockwise direction when the workpiece A100 is viewed in the direction Y). The axis MJ10 and the axis MJ100 may be located at the same position, or may be located at respectively different positions. This enables the workpiece A100 to be pressed against the jig B100 in a direction F12300 obtained by combining the direction F100, the direction F200, and the direction F300 about the operating point Pas a point of origin, and to be pressed in the rotation direction of the moment M100.

In a case of FIGS. 18A to 18C, the pressing operation in the direction F200 is not essential. The reason is that applying the moment M100 to the workpiece A100 generates an effect in which the bottom surface of the workpiece A100 is pressed against the surface B110 in the direction F200.

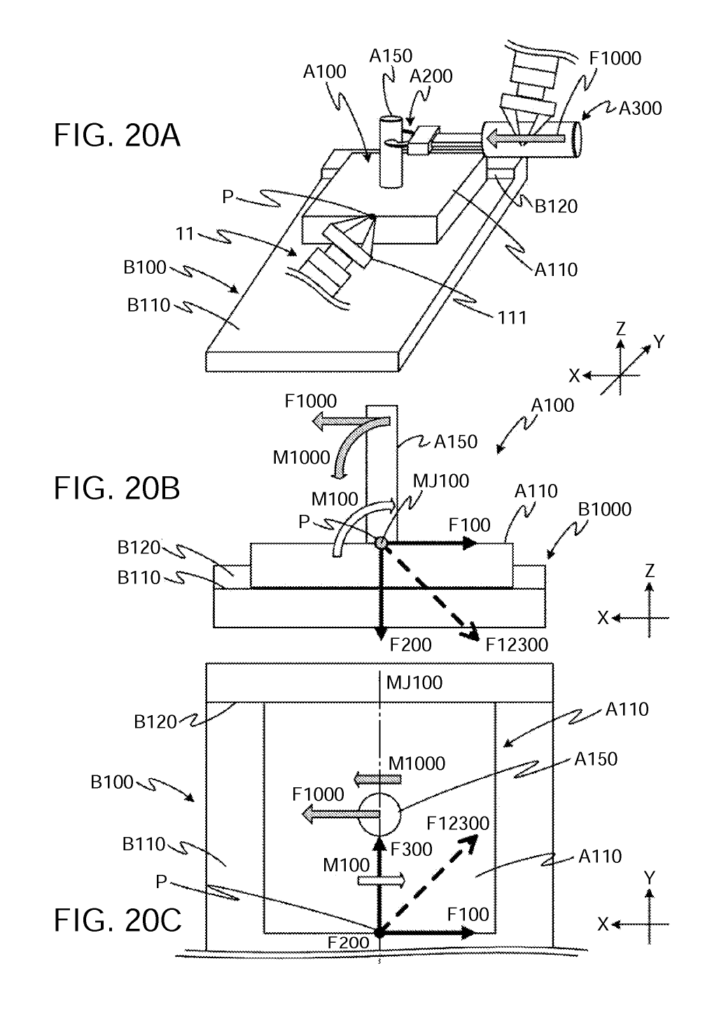

FIGS. 20A to 20C are views for describing a sixth example of the pressing operation of the robot in the first work example. Hereinafter, description will be made by focusing on points different from those in FIGS. 18A to 18C.

A placing method for the workpiece A100 is the same as that in FIGS. 18A to 18C. In addition, the direction F1000 in which the retaining ring A200 is pressed against the shaft portion A150 is the same as that in FIGS. 18A to 18C. In contrast, the position of the operating point P is different from that in FIGS. 18A to 18C. In FIGS. 20A to 20C, for example, it is preferable that the position of the operating point P be located to be substantially perpendicular to the longitudinal direction of the shaft portion A150 and on a line segment on the main body portion A110 which is substantially orthogonal to the XZ plane including the surface B120, or near the line segment.

In a case of the operating point P as illustrated in FIGS. 20A to 20C, the controller 20 also controls the other arm 11, similar to the case in FIGS. 18A to 18C. That is, the controller 20 controls the other arm 11, thereby pressing the hand 111 in the direction F100, the direction F200, and the direction F300. In addition, the controller 20 sets the axis MJ10 (not illustrated), and presses the hand 111 by changing a posture of the arm 11 so as to generate the moment M100 around the axis (in the drawing, clockwise direction when the workpiece A100 is viewed in the direction Y). The axis MJ10 and the axis MJ100 may be located at the same position, or may be located at respectively different positions. This enables the workpiece A100 to be pressed against the jig B100 in the direction F12300 obtained by combining the direction F100, the direction F200, and the direction F300 about the operating point P as a point of origin, and to be pressed in the rotation direction of the moment M100.

In a case of FIGS. 20A to 20C, the pressing operation in the direction F200 is also not essential, similar to the case of FIGS. 18A to 18C. The reason is that applying the moment 100 to the workpiece A100 generates an effect in which the bottom surface of the workpiece A100 is pressed against the surface B110 in the direction F200.

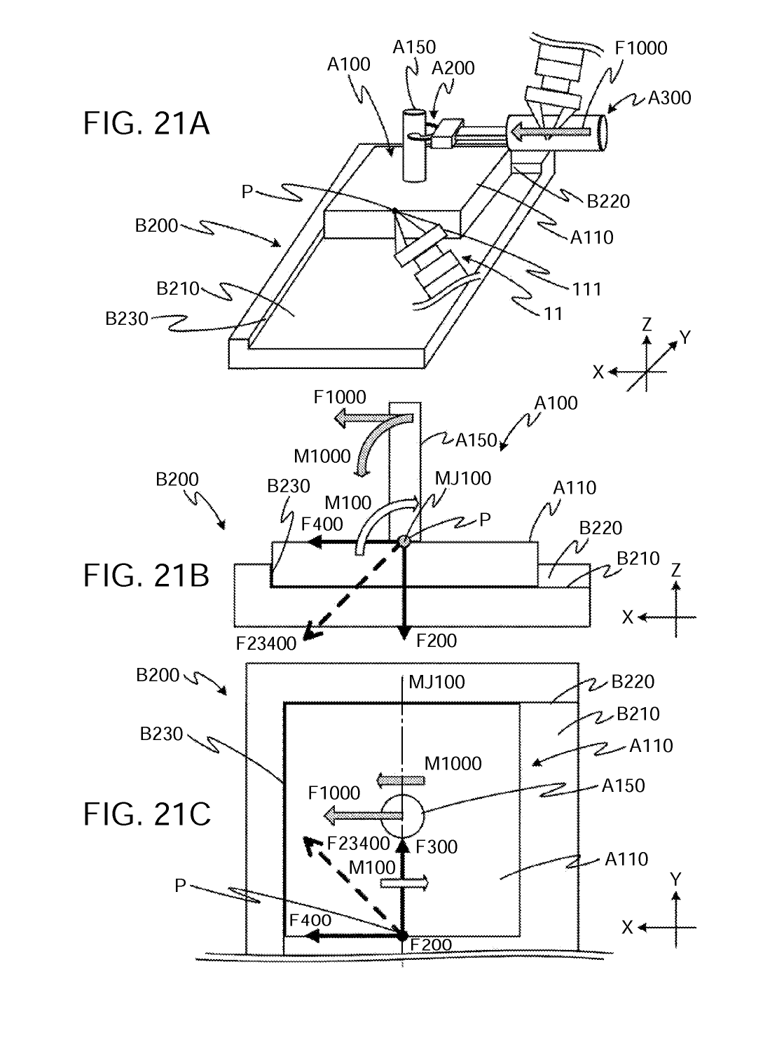

FIGS. 21A to 21C are views for describing a seventh example of the pressing operation of the robot in the first work example. Hereinafter, description will be made by focusing on points different from those in FIGS. 20A to 20C.

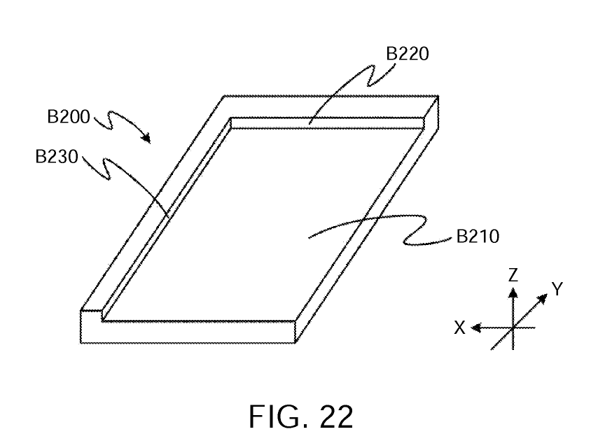

In FIGS. 21A to 21C, a jig B200 is used. For example, the jig B200 is configured as illustrated in FIG. 22 (view illustrating a configuration example of the jig). The jig B200 has a rectangular parallelepiped shape, and includes a planar surface B210 on which the workpiece is placed, a surface B220 substantially perpendicular to the surface B210, and a surface B230 substantially perpendicular to the surface B210 and the surface B220. The surface B210, the surface B220, and the surface B230 function as a positioning portion for positioning the workpiece A100.

Referring back to the description in FIGS. 21A to 21C, in a placing method for the workpiece A100, the workpiece A100 is placed on the surface B210 of the jig B200 so that the distal end of the shaft portion A150 faces upward (in the direction Z). The direction F1000 in which the retaining ring A200 is pressed against the shaft portion A150 is the same as that in FIGS. 20A to 20C. In addition, the position of the operating point P is the same as that in FIGS. 20A to 20C. In contrast, the direction in which the workpiece A100 is pressed is different from that in FIGS. 20A to 20C.

That is, the controller 20 controls the other arm 11, thereby pressing the hand 111 in the direction F200 which is substantially orthogonal to the surface B210. In addition, the controller 20 controls the other arm 11, thereby pressing the hand 111 in the direction F300 of the surface B220 which is the direction substantially parallel to both the surface B210 and the surface B230. The direction F300 is substantially perpendicular to the XZ plane including the surface B220. Furthermore, the controller 20 presses the hand 111 in a direction F400 of the surface B230 which is the direction substantially perpendicular to both the direction F200 and the direction F300. The direction F400 is substantially perpendicular to the YZ plane including the surface B230. In addition, the controller 20 sets the axis MJ10 (not illustrated), and presses the hand 111 by changing a posture of the arm 11 so as to generate the moment M100 around the axis (in the drawing, clockwise direction when the workpiece A100 is viewed in the direction Y). The axis MJ10 and the axis MJ100 may be located at the same position, or may be located at respectively different positions. This enables the workpiece A100 to be pressed against the jig B200 in a direction F23400 obtained by combining the direction F200, the direction F300, and the direction F400 about the operating point P as a point of origin, and to be pressed in the rotation direction of the moment M100.

In a case of FIGS. 21A to 21C, the pressing operation in the direction F200 is also not essential, similar to the case of FIGS. 20A to 20C. The reason is that applying the moment M100 to the workpiece A100 generates an effect in which the bottom surface of the workpiece A100 is pressed against the surface B210 in the direction F200. In addition, in a case of FIGS. 21A to 21C, the pressing operation in the direction F400 is also not essential. The reason is that applying the force in the direction F1000 to the workpiece A100 generates an effect in which the side surface of the workpiece A100 is pressed against the surface B230 in the direction F400.

The above-described direction and moment cause the hand 111 to press and support the workpiece. In this manner, it is possible to more reliably fix the workpiece so that the workpiece is unmovable or does not float during the assembling work. In addition, the above-described direction and moment cause the hand 111 to press the workpiece against the positioning portion of the jig. Accordingly, it is possible to more reliably position the workpiece.

When the assembling work of the retaining ring A200 is carried out by placing the workpiece A100 on the jig B100 so that the distal end of the shaft portion A150 faces sideways (direction opposite to the direction Y), the workpiece A100 may be pressed against the jig B100 in the directions F100, F200, F300, and by using the moment M200 as illustrated in FIGS. 15A to 15C.

Hitherto, an embodiment of the invention has been described. According to the embodiment, in the work carried out by the robot, it is possible to cause the workpiece such as the component to be more reliably unmovable.

A configuration of the component is not limited to the illustrated configuration. That is, when the force is applied to the workpiece in a certain direction during the assembling work, a moment by which the workpiece is moved or floats is generated. In contrast, the robot 1 may press the workpiece in the direction opposite to the direction in which the force is applied during the assembling work (direction in which the retaining ring is assembled), and in the direction of the working table. The robot 1 may press the workpiece by using a counter moment which can remove or reduce the moments generated during the assembling work.

In the above-described embodiment, the assembling work of the retaining ring has been described as an example, but the contents of the work are not limited thereto. For example, the contents of the work may include work for inserting a member such as a screw and a pin into a workpiece, or work for driving a member such as staple (needle) into a workpiece. Even in these cases, the direction in which the force is applied during the work is the same as the direction in which the retaining ring is assembled. In addition, the moment generated during the assembling work is the same as that in the embodiment.

In the above-described embodiment, description is made so that the workpiece and the jig, the workpiece and the workpiece, or the robot and the workpiece are in contact with each other on the surface. However, even in a case of point contact or linear contact, there is provided a physically constant area. Accordingly, the point contact or the linear contact can be considered to be the same as the surface contact.

Hitherto, the invention has been described using the embodiment. However, the technical scope of the invention is not limited to the scope described in the above-described embodiment. It is apparent to those skilled in the art that various modifications or improvements can be added to the above-described embodiment. In addition, it is apparent from the scope according to an aspect of the invention that the modified or improved embodiment is also included in the technical scope of the invention. The invention may be provided as a robot system which separately has a robot and a control device (controller), or may be provided as a robot and a control device for a robot system. In addition, the invention may be provided as a method of controlling a robot, a program for controlling a robot, or a storage medium for storing a program.

### Third Embodiment

Hereinafter, a third embodiment will be described. The same reference numerals are given to elements which are the same as those in the first embodiment and the second embodiment, and description thereof will be omitted.

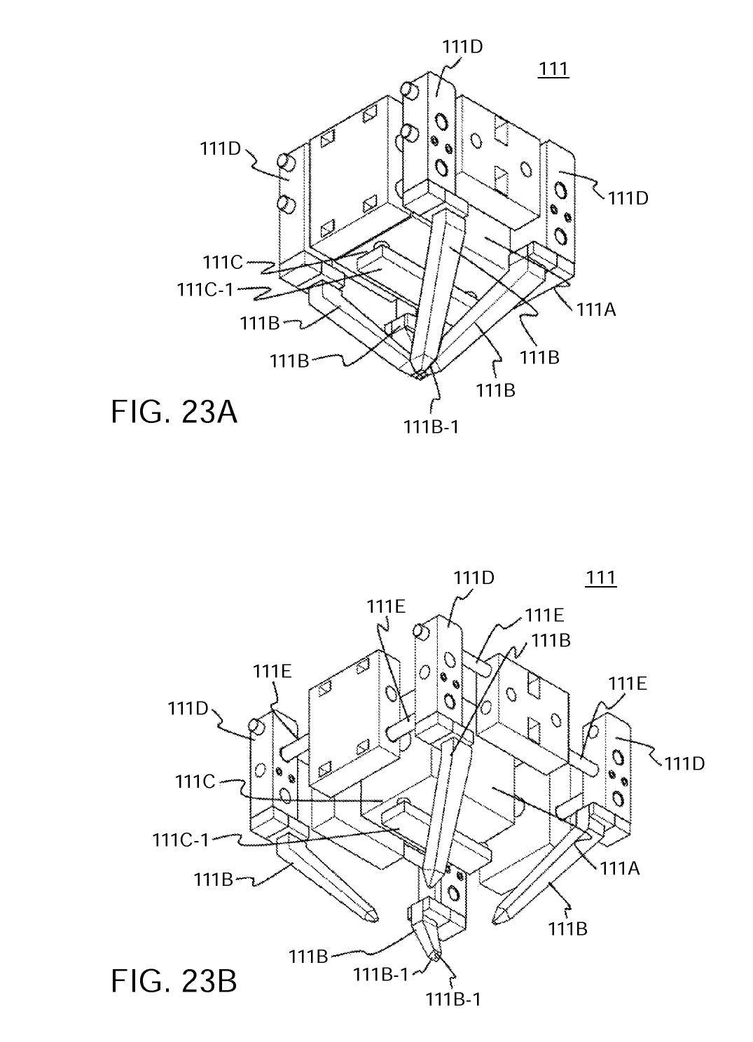

FIGS. 23A and 23B are perspective views illustrating details of the hand 111. FIG. 23A is a view when gripping surfaces 111B-1 (to be described in detail later) of the finger 111B are brought into contact with each other, and FIG. 23B is a view when the gripping surfaces 111B-1 are away from each other.

The hand 111 includes the main body portion 111A, the finger 111B, a bottom plate portion 111C, a movable portion 111D, and a shaft 111E. The main body portion 111A has a substantially rectangular parallelepiped outer shape, and the movable portion 111D is arranged in a periphery thereof. The finger 111B is disposed in the movable portion 111D. The distal end of the finger 111B is formed in a substantially quadrangular pyramid shape. At least one of the quadrangular pyramid-shaped side surfaces is formed as the gripping surface 111B-1 for gripping an object. The number of the gripping surfaces 111B-1 disposed in one finger 111B is not particularly limited. However, a case of two gripping surfaces will be described herein. The details of the gripping surface 111B-1 will be described later.

The number of the fingers 111B is not particularly limited, but for example, may be two to four. In FIGS. 23A and 23B, one finger 111B is disposed in one movable portion 111D. However, without being limited thereto, the number of the fingers 111B disposed in one movable portion 111D may be arbitrarily selected. The bottom plate portion 111C including a bottom plate surface 111C-1 is disposed in the main body portion 111A so as to be located between the fingers 111B. The gripping surface 111B-1 formed in one finger 111B and the gripping surface 111B-1 formed in the other finger 111B are disposed to be parallel to each other. Each gripping surface 111B-1 is disposed to be perpendicular to the bottom plate surface 111C-1. The finger 111B corresponds to a finger portion according to an aspect of the invention. In addition, the bottom plate portion 111C corresponds to a receiving portion according to an aspect of the invention, and the bottom plate surface 111C-1 corresponds to a surface of the receiving portion according to an aspect of the invention.

The movable portion 111D is driven by a drive mechanism (omitted in FIGS. 23A and 23B), and is movable along the shaft 111E. In this manner, it is possible to interpose an object between the gripping surfaces 111B-1 by changing a distance between the fingers 111B. During this drive, the finger 111B is configured to move parallel to the bottom plate surface 111C-1. A method of gripping the object by using the fingers 111B is not limited to a method of interposing the object between the gripping surfaces 111B-1. The hand 111 may adopt any configuration as long as the object can be gripped by at least one finger 111B.

The terms described herein such as horizontal, horizontally upward, vertically downward, vertically upward, and perpendicular represent a concept which includes an error in several degrees, without being limited to a case such as strictly horizontal, strictly horizontally upward, strictly vertically downward, strictly vertically upward, and strictly perpendicular. In addition, the terms described herein such as the rectangular parallelepiped shape and the quadrangular pyramid shape represent a concept which includes an error in several degrees and in several unit lengths (for example, mm, cm, and m), without being limited to a case such as a strictly rectangular parallelepiped shape and a strictly quadrangular pyramid shape, and which further includes a case where a corner is chamfered.

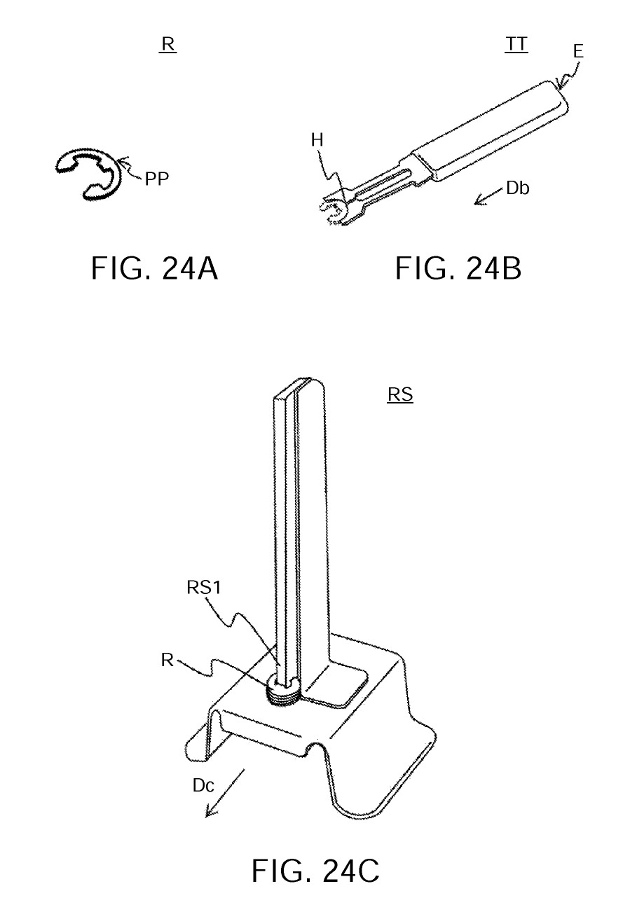

Hereinafter, description will be made with regard to a retaining ring fitted by the robot 1, a retaining ring stand which supplies the retaining ring, and a tool used in holding the retaining ring. FIG. 24A is a perspective view of the retaining ring, FIG. 24B is a perspective view of the retaining ring stand, and FIG. 24C is a perspective view of the tool. FIGS. 24A to 24C illustrate the retaining ring, the retaining ring stand, and the tool which are known. However, the retaining ring, the retaining ring stand, and the tool are not necessarily limited to those which are known.

For example, a retaining ring R is a C-type retaining ring or an E-type retaining ring. FIGS. 24A to 24C illustrate the E-type retaining ring. The retaining ring R has an annular shape which is partially open. The retaining ring R can be fitted to a fitting portion I (omitted in FIGS. 24A to 24C) by applying a load from a side opposite to the opening toward the opening.

The terms described herein such as the annular shape represent a concept which includes an error in approximately several unit lengths (for example, mm, cm, and m), without being limited to a strictly annular shape.

A tool TT includes a holding portion H. The holding portion H is generally configured to pinch and hold the retaining ring R. The holding portion H is brought into contact with a position PP of the retaining ring R, and a load is applied in a direction Db, thereby enabling the holding portion H to hold the retaining ring R. In addition, the retaining ring R held by the holding portion H can be fitted to the fitting portion I by applying the load in the direction Db.

A retaining ring stand RS facilitates the supply of the retaining ring R. The retaining ring stand RS is not particularly limited, but includes a supply portion RS1. The supply portion RS1 can pile the retaining ring R up so that the retaining ring R can be held by the tool TT, and can unload the lowermost retaining ring R by drawing out the retaining ring R in the direction Dc.

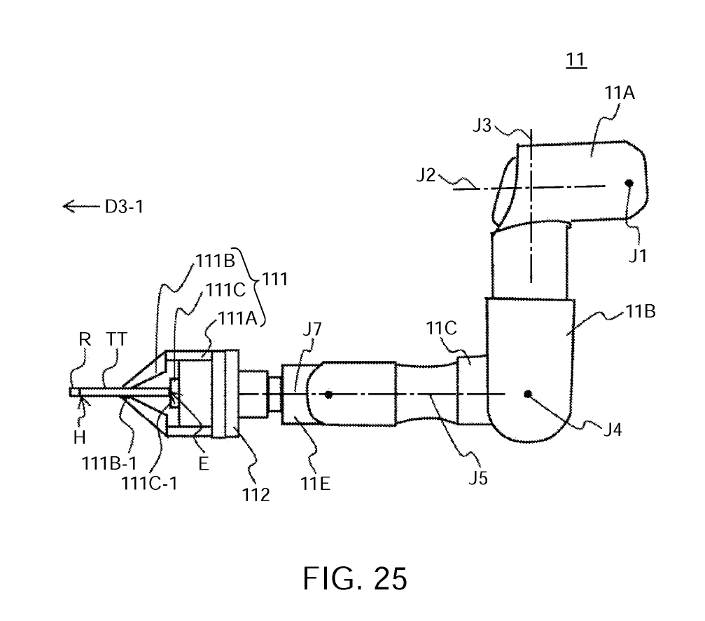

FIG. 25 is a view illustrating the details of the arm 11. FIG. 25 illustrates an example of the arm 11 when the tool TT gripped by the hand 111 holds the retaining ring R and the retaining ring R is fitted to the fitting portion I. Details of this operation will be described later.

The arm 11 is configured so that arm members (corresponding to manipulator members according to an aspect of the invention) 11A, 11B, 11C, 11D, and 11E are connected to one another by joints (not illustrated) sequentially from the body portion 10 side. An actuator (not illustrated) for operating the joint is disposed in the joint.

The arm 11 is included in a seven-axis robot having seven pivot shafts. The seven pivot shafts J1, J2, J3, J4, J5, J6, and J7 are respectively rotary shafts of the actuators disposed in the joints. The arm members 11A, 11B, 11C, 11D, 11E, and the hand 111 can be independently and pivotally moved around the pivot shafts J1, J2, J3, J4, J5, J6, and J7.

For example, the actuator includes a servo motor and an encoder. An encoder value output from the encoder is used in a feedback control performed by the controller 20 for the robot 1. In addition, an electromagnetic brake for fixing the rotary shaft is disposed in the actuator.

A force sensor 111c (not illustrated in FIG. 25) is disposed in a distal end (corresponding to a wrist portion of the arm 11) of the arm member 11E. The force sensor 111c is a sensor for detecting a force or a moment which is received as a reaction force with respect to a force output from the robot 1. For example, as the force sensor 111c, it is possible to use a six-axis force sensor 111c which can simultaneously detect six components of force components in three translational axes and moment components around three rotational axes. The force sensor 111c is not limited to the six axes, and may have three axes, for example.

The hand 111 is disposed in the distal end of the arm member 11E via an attachment/detachment member 112 for disposing the hand 111 to be attachable and detachable.

The configuration of the robot 1 is intended to describe a main configuration in describing characteristics according to the embodiment, and thus, the invention is not limited to the above-described configuration. The configuration does not exclude a configuration included in a general gripping robot. For example, FIGS. 1, 2, and 25 illustrate the arm having the seven axes, but the number of the axes (the number of joints) may be further increased or decreased. The number of arm members may be increased or decreased. In addition, a shape, a size, arrangement, and a structure of various members such as the arm member and the joint may be appropriately modified.

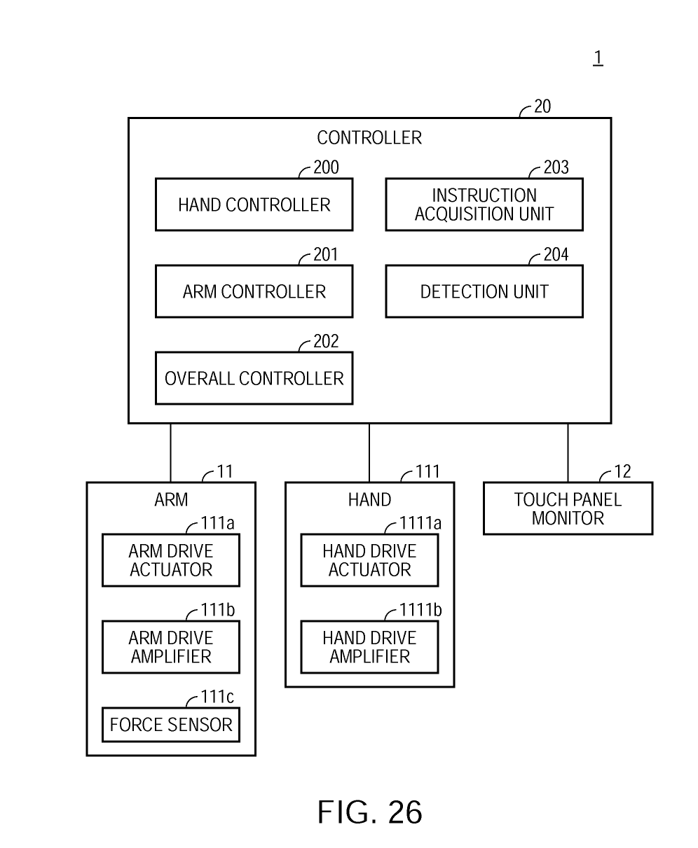

Next, a functional configuration example of the robot 1 will be described. FIG. 26 illustrates a function block diagram of the controller 20.

The controller 20 mainly includes a hand controller 200, an arm controller 201, an overall controller 202, an instruction acquisition unit 203, and a detection unit 204.

The hand controller 200 switches on or off control power and drive power for the hand 111.

If an end point is moved to a targeted position, the hand controller 200 outputs a signal for carrying out the work to the hand 111. The signal is amplified by a hand drive amplifier 1111b, and is input to a hand drive actuator 1111a. This enables the hand 111 to carry out the work. This process can employ a general technology, and thus, description thereof will be omitted.

The arm controller 201 outputs a signal for driving the arm 11, based on an encoder value of the actuator and a sensor value of the force sensor 111c. The signal is amplified by an arm drive amplifier 111b, and is input to an arm drive actuator 111a. This enables the arm 11 to be controlled.

Specifically, the arm controller 201 moves the position of the end point so that the hand 111 is caused to carry out a predetermined work, based on an image captured by an electronic camera 15. This process can employ a general technology, and thus, description thereof will be omitted.

The overall controller 202 performs a process for controlling the overall controller 20.

The instruction acquisition unit 203 executes a retaining ring fitting instruction which is input, when the retaining ring fitting instruction is input via the touch panel monitor 102.

The detection unit 204 outputs a control signal, when detecting that the tool TT comes into contact with the bottom plate portion 111C, that the retaining ring R can be drawn out from the retaining ring stand RS by the tool TT, and that the retaining ring R is fitted to the fitting portion I.

In the embodiment, the controller 20 is disposed inside the leg portion 13. However, the controller 20 can be disposed at any desired location inside the robot 1. Alternatively, the controller 20 can also be disposed outside the robot 1. When the controller 20 is disposed outside the robot 1, the controller 20 is connected to the robot 1 over wires or wirelessly. In addition, each unit of the controller 20 maybe realized by being distributed into multiple devices.

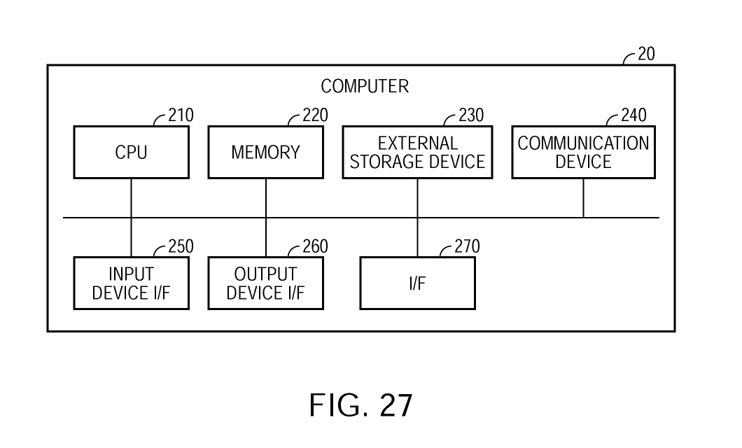

FIG. 27 is a block diagram illustrating an example of a schematic configuration of the controller 20. As illustrated, for example, the controller 20 configured to have a computer includes a central processing unit (CPU) 210 which is an arithmetic unit, a memory 220 having a random access memory (RAM) which is a volatile storage device, and a read only memory (ROM) which is a non-volatile storage device, an external storage device 230, a communication device 240 which communicates with an external device such as the robot 1, an input device interface (I/F) 250 connected to an input device such as the touch panel monitor, an output device I/F 260 connected to an output device such as the touch panel monitor, and an I/F 270 for connecting the controller 20 and other units.

For example, the CPU 210 causes the memory 220 to read and execute a predetermined program stored in the memory 220 so that the above-described functional units can be realized. For example, the predetermined program may be installed in advance in the memory 220. The predetermined program may be installed or updated after being downloaded from a network (not illustrated) via the communication device 240. Alternatively, the predetermined program may be installed or updated after a program stored in a portable storage medium (not illustrated) is read by a reading device (not illustrated).

The above-described configuration of the robot 1 is intended to describe a main configuration in describing characteristics according to the embodiment, and thus, the invention is not limited to the above-described configuration. In addition, the configuration does not exclude a configuration included in a general robot system.

### First Operation Example

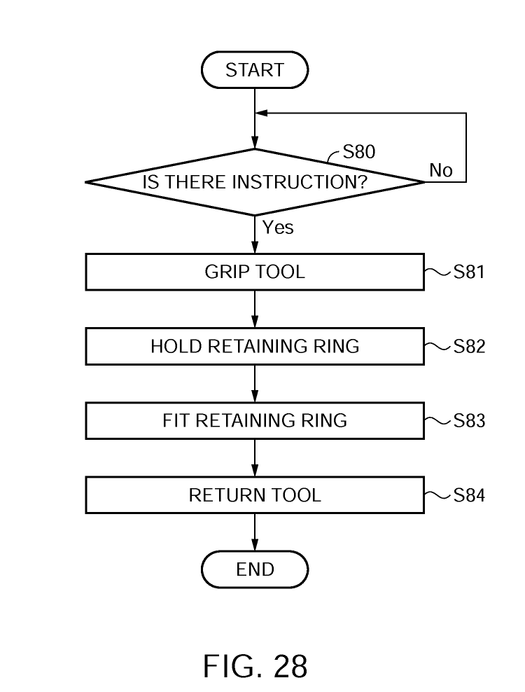

Next, with regard to a characteristic process of the robot 1 having the above-described configuration, a first operation example will be initially described. FIG. 28 is a process flowchart from when the robot 1 pinches the tool TT until the tool TT draws out the retaining ring R from the retaining ring stand RS and the retaining ring R is fitted into the fitting portion I. The process illustrated in FIG. 28 starts when a certain instruction is input to the controller 20 via the touch panel monitor 12. Details of each process in FIG. 28 will be described later.

First, the overall controller 202 determines whether or not the instruction acquisition unit 203 acquires a retaining ring fitting instruction which is input from the touch panel monitor 12 (Step S80).

When the instruction acquisition unit 203 does not acquire the retaining ring fitting instruction (Step S80: NO), the overall controller 202 performs Step S80 again after a predetermined time.

When the instruction acquisition unit 203 acquires the retaining ring fitting instruction (Step S80: YES), the robot 1 brings the tool TT into contact with the hand 111, and then, grips the tool TT (Step S81). This operation corresponds to contact (contact with the receiving portion) and gripping according to an aspect of the invention.

Next, the robot 1 causes the tool TT gripped by the hand 111 to draw out and hold the retaining ring R from the retaining ring stand RS (Step S82). This operation corresponds to holding (holding the retaining ring by using the tool) according to an aspect of the invention.

Next, the robot 1 fits the retaining ring R held by the tool TT to the fitting portion I (Step S83). This operation corresponds to fitting according to an aspect of the invention.

Next, the robot 1 returns the tool TT gripped by the hand 111 to the original location (Step S84).

The above-described steps represent a series of operations for the retaining ring fitting of the robot 1. The timing to start these operations is not limited to a case where an instruction is input from the touch panel monitor 12, and may be arbitrarily selected. In addition, a process for returning the tool TT gripped by the hand 111 to the original location (Step S84) may not be necessarily performed.

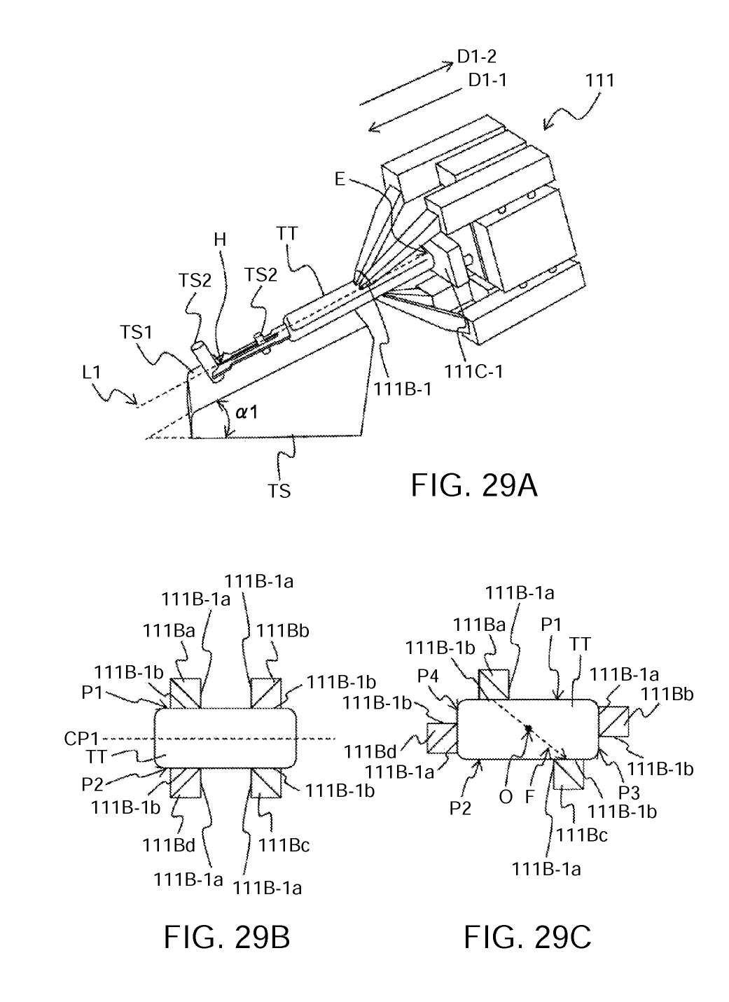

FIGS. 29A to 29C are views for describing an operation of the arm 11 and the hand 111 which perform an operation for causing the hand 111 to grip the tool TT (Step S81). FIG. 29A is a view when the finger 111B grips the tool TT.

The tool TT is arranged on a tool stand TS. The tool stand TS includes a tool holding surface TS1. The tool holding surface TS1 includes a structure for holding the tool TT (for example, a protruding portion TS2 in FIG. 29A).

The arm 11 controls the hand 111 so as to move in a direction of Arrow D1-1. At this time, for example, as illustrated in FIG. 23B, the gripping surfaces 111B-1 are located away from each other so that the gripping surfaces 111B-1 can grip the tool TT. If an end portion (for example, the portion E in FIG. 24B) of the tool TT comes into contact with the bottom plate surface 111C-1, the hand 111 grips the tool TT by narrowing a distance between the gripping surfaces 111B-1.

At this time, the tool TT is gripped so that the bottom plate surface 111C-1 is perpendicular to a direction of the operation for fitting the retaining ring R to the fitting portion I. This operation is not limited thereto, but for example, the gripping is realized in the following manner. When the fitting is performed by using the tool TT illustrated in FIGS. 24A to 24C, the direction of the operation for the fitting is a direction from a contact portion (for example, the portion E in FIG. 24B) where the tool TT comes into contact with the bottom plate surface 111C-1 to a holding portion (for example, the holding portion H in FIG. 24B) where the retaining ring R is held by the tool TT. In this case, the above-described perpendicular gripping can be realized, if a direction of the operation for coming into contact with the tool TT is substantially parallel to a virtual line (for example, L1 in FIG. 29A) from the portion E to the holding portion H of the tool TT arranged on the tool stand TS, and is perpendicular to the bottom plate surface 111C-1 of the hand 111.

Furthermore, when the tool TT illustrated in FIGS. 24A to 24C includes surfaces which are parallel to each other and the tool TT can pinch and grip the surfaces, the above-described perpendicular gripping can be realized by the following manner. This manner will be described with reference to FIGS. 29B and 29C.

FIG. 29B is a view illustrating a positional relationship of the gripping surfaces 111B-1 when a surface P1 and a surface P2 of the tool TT are substantially parallel to each other. As illustrated, a gripping surface 111B-1b of a finger 111Ba and a gripping surface 111B-1b of a finger 111Bb are brought into contact with the surface P1. A gripping surface 111B-1b of a finger 111Bc and a gripping surface 111B-1b of a finger 111Bd are brought into contact with the surface P2. In this manner, the gripping surfaces 111B-1 are brought into contact with the tool TT, and the tool TT is pinched by the gripping surfaces 111B-1b. Accordingly, the above-described perpendicular gripping can be realized.

At this time, the gripping surface 111B-1 may be brought into contact with the surface so as to be symmetric with respect to a line or a surface which equally divides a distance between parallel surfaces. For example, in a case of FIG. 29B, a plane CP1 is a plane which equally divides a distance between a plane P1 and a plane P2. The gripping surface 111B-1b of the finger 111Ba and the gripping surface 111B-1b of the finger 111Bd are brought into contact with each other at a position symmetric with respect to the plane CP1. In this way, the force applied from the finger 111Ba can be perpendicularly received by the finger 111Bd, and the force applied from the finger 111Bd can be perpendicularly received by the finger 111Ba. This positional relationship is also similarly applied to the set of the finger 111Bb and the finger 111Bc. According to this gripping, the force can be received by the gripping surfaces 111B-1 opposing each other, thereby gripping the tool TT stably.

FIG. 29C is a view illustrating a positional relationship of the gripping surfaces 111B-1 when the surface P1 and the surface P2 of the tool TT are parallel to each other and a surface P3 and a surface P4 are parallel to each other. As illustrated, the gripping surface 111B-1b of the finger 111Ba is brought into contact with the surface P1, and the gripping surface 111B-1b of the finger 111Bc is brought into contact with the surface P2. The gripping surface 111B-1a of the finger 111Bb is brought into contact with the surface P3, and the gripping surface 111B-1a of a finger 111Bd is brought into contact with the surface P4. In this manner, the gripping surfaces 111B-1 are brought into contact with the tool TT, and the tool TT is pinched by the gripping surfaces 111B-1b. Accordingly, the above-described perpendicular gripping can be realized.

As illustrated in FIG. 29C, even when the tool TT includes parallel surfaces of two sets, the gripping surface may be brought into contact with the surface so as to be symmetric with respect to a line or a surface which equally divides a distance between parallel surfaces, as illustrated in FIG. 29B. However, without being limited thereto, the force applied from the gripping surface 111B-1 which is in contact with a certain surface to the gripping surface 111B-1 which is in contact with the opposing surface may be configured to pass through the center of gravity of the tool TT (for example, the axial center of the tool TT). For example, in a case of FIG. 29C, the gripping surface 111B-1 may be brought into contact with the tool TT so that the force F applied from the gripping surface 111B-1b of the finger 111Ba to the gripping surface 111B-1b of the finger 111Bc passes through the center of gravity O of the tool TT. The set of the finger 111Bb and the finger 111Bd are also brought into contact with the tool TT by using the same positional relationship. According to this gripping, the force can be received by the gripping surfaces 111B-1 opposing each other, thereby gripping the tool TT stably.

However, the above-described perpendicular gripping is not limited to a case realized by the above-described manners. For example, conditions for the gripping can be added thereto and deleted therefrom depending on a shape and a structure of the tool TT, a shape of the gripping surface 111B-1, a shape of the bottom plate surface 111C-1, or a positional relationship therebetween.

The terms described herein such as perpendicular and parallel represent a concept which includes an error in several degrees, without being limited to a case such as strictly perpendicular and strictly parallel. In addition, the terms described herein such as symmetric, equal dividing, the center of gravity, the center, and the same represent a concept which includes an error in several degrees and in several unit lengths (for example, mm, cm, and m), without being limited to a case such as strictly symmetric, strictly equal dividing, strictly the center of gravity, strictly the center, and strictly the same.

After causing the finger 111B to grip the tool TT, the arm 11 moves the tool TT in a direction where the tool TT can be drawn out from the tool stand TS (for example, an upward direction in FIG. 29A), and then, the arm 11 moves in a direction of Arrow D1-2. However, depending on a structure for holding the tool TT, the arm 11 may move in other directions, or may combinedly move in multiple directions.

The tool holding surface TS1 forms an angle α1 with the working table in which the tool stand TS is arranged. The angle α1 has a value of α1>0 (for example, α1=20°). The value of the angle α1 is not limited. For example, the value can be determined by at least one out of a structure of the tool TT, dimensions of the tool TT, dimensions of the tool holding surface TS1, and dimensions of the hand 111. That is, the angle α1 can be determined so that the hand 111 or the other structural portion of the robot 1 does not interfere with the working table, when the hand 111 is caused to grip the tool TT held by the tool stand TS.

The tool holding surface TS1 of the tool stand TS is arranged not to be parallel to the working table. Accordingly, as compared to a case where the tool holding surface TS1 is arranged to be parallel to the working table, it is possible to further increase a movable range of the arm 11. This can reduce the time required for gripping the tool TT.

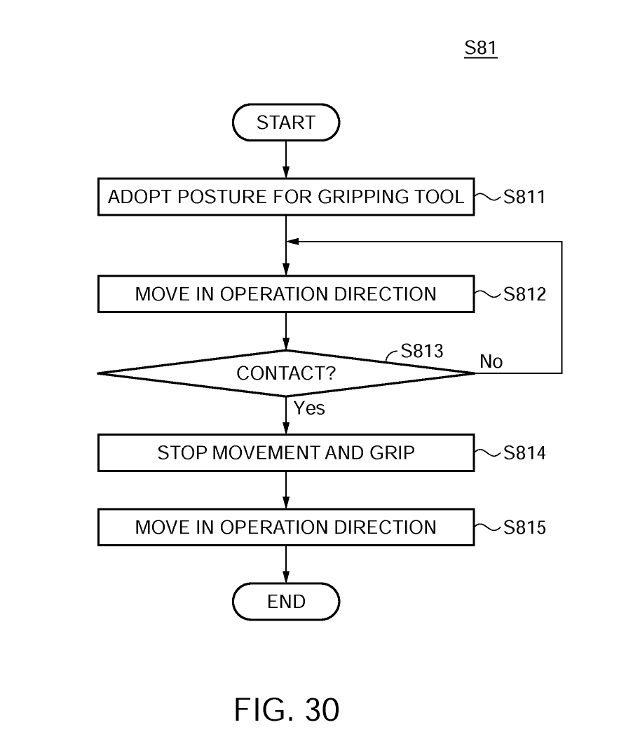

FIG. 30 is a process flowchart of the operation described with reference to FIGS. 29A to 29C. The arm 11 adopts a posture which enables the hand 111 to grip the tool TT (Step S811). To that end, the arm controller 201 adjusts the position and the orientation of the respective arm drive actuators 111a of the arm 11. The position and the orientation may be input to the robot 1 in advance, or may be designated by using an image processing technology for the image captured by the electronic camera 15 or by using a sensing technology.

During at least one process between the process in Step S811 and the preceding process, the hand controller 200 may adjust the position and the orientation of the hand drive actuator 1111a so as to capable of gripping the tool TT. As illustrated in FIG. 23B, the gripping surfaces 111B-1 of the hand 111 may be located away from each other.

Next, the arm 11 moves in an operation direction (for example, the direction of Arrow D1-1 in FIG. 29A) (S812). To that end, the arm controller 201 adjusts the position and the orientation of the arm drive actuator 111a, and moves the arm 11 in the operation direction. The operation direction at this time may be input to the robot 1 in advance, or may be designated by using the image processing technology for the image captured by the electronic camera 15 or by using the sensing technology.

The detection unit 204 determines whether or not the tool TT comes into contact with the bottom plate surface 111C-1 (S813). For example, this determination may be made by the detection unit 204 determining whether or not the force sensor 111c detects a force equal to or greater than a predetermined value in a direction opposite to the operation direction in Step S812. Alternatively, the detection unit 204 may detect the force by performing the image processing of the image captured by the electronic camera 15.

If the tool TT does not come into contact with the bottom plate surface 111C-1 (S813: NO), the process returns to Step S812, and a movement operation of the arm 11 is continued. If the tool TT comes into contact with the bottom plate surface 111C-1 (S813: YES), the movement of the arm 11 is stopped, and the hand 111 grips the tool TT (S814). To that end, the arm controller 201 adjusts the arm drive actuator 111a, and stops the movement of the arm 11. The arm controller 201 adjusts the hand drive actuator 1111a, and causes the distance between the fingers 111B of the hand 111 to be close to each other, thereby causing the gripping surfaces 111B-1 to grip the tool TT.

Next, the arm 11 moves in the operation direction (for example, the direction of Arrow D1-2 in FIG. 29A) (S815). This operation is different from the operation in Step S812 described above in that only the moving directions are different from each other. Accordingly, detailed description thereof will be omitted. Steps S812 and S813 correspond to contact (contact with the receiving portion) according to an aspect of the invention, and Step S814 corresponds to gripping according to an aspect of the invention. However, the contact (contact with the receiving portion) and gripping according to an aspect of the invention may represent the contact operation and the gripping operation themselves, but may represent a state of contact and a state of gripping.

The above-described operation is the operation for causing the hand 111 to grip the tool TT. Next, an operation will be described in which the tool TT draws out the retaining ring R.

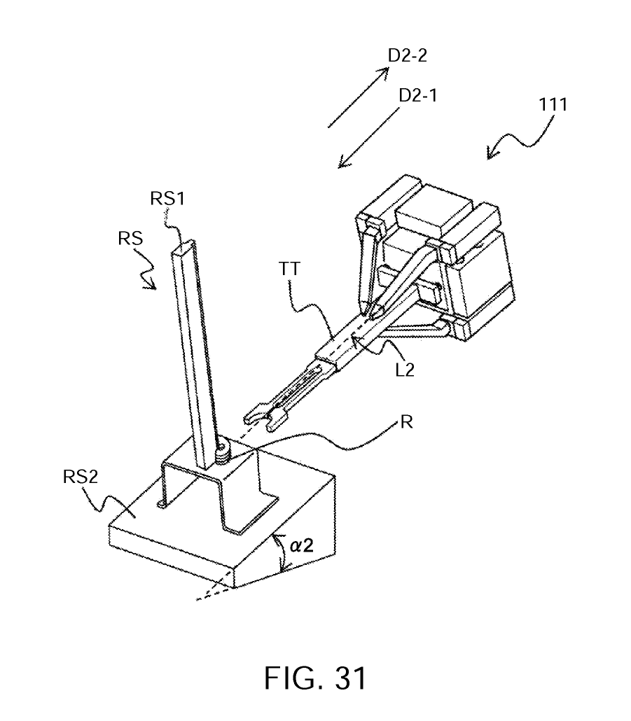

FIG. 31 is a view for describing an operation of the arm 11 and the hand 111 which perform the operation (S82) for causing the tool TT to draw out the retaining ring R from the retaining ring stand RS.

The arm 11 moves so that the hand 111 faces in a direction of Arrow D2-1. If the retaining ring R is held by the tool TT, the arm 11 moves so that the hand 111 faces in a direction of Arrow D2-2. However, depending on a structure of the supply portion RS1, the arm 11 may move in other directions, or may combinedly move in multiple directions.

The retaining ring stand RS includes a stand holding surface RS2. The stand holding surface RS2 forms an angle α2 with the working table in which the retaining ring stand RS is arranged. The angle α2 has a value of α2>0. The value of the angle α2 is not limited. For example, the value can be determined by at least one out of a structure of the tool TT, dimensions of the tool TT, dimensions of the stand holding surface RS2, a structure of the supply portion RS1, dimensions of the supply portion RS1, and dimensions of the hand 111. That is, the angle α2 can be determined so that the hand 111 or the other structural portion of the robot 1 does not interfere with the working table, when the retaining ring R is drawn out from the retaining ring stand RS. The advantageous effect is the same as that achieved by the above-described tool stand TS. The angle α2 may be the same as or may be different from the angle α1.

The directions of Arrow D2-1 and Arrow D2-2 are parallel to a direction (for example, L2 in FIG. 31) from the contact portion (portion E) in which the tool TT gripped by the hand 111 comes into contact with the bottom plate surface 111C-1, to the holding portion (holding portion H) of the retaining ring R. Therefore, the tool TT gripped by the hand 111 can hold the retaining ring R by just moving the arm 11 in the direction of Arrow D2-1.

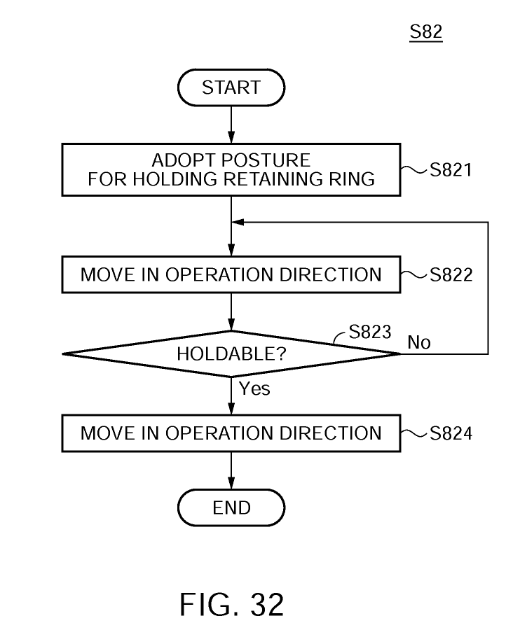

FIG. 32 is a process flowchart of the operation described with reference to FIG. 31. The arm 11 adopts a posture which enables the tool TT gripped by the hand 111 to draw out the retaining ring R from the retaining ring stand RS (Step S821). With the exception that the positions and the postures are different from each other, the details are the same as those in Step S811 described above, and thus, description thereof will be omitted.

Next, the arm 11 moves in the operation direction (for example, the direction of Arrow D2-1 in FIG. 31) (S822). With the exception that the operation directions or the movement speeds are different from each other, the details are the same as those in Step S812 described above, and thus, description thereof will be omitted.

The detection unit 204 determines whether or not the retaining ring R can be drawn out from the retaining ring stand RS (S823). For example, this determination may be made by the detection unit 204 determining whether or not the force sensor 111c detects a force equal to or greater than a predetermined value in a direction opposite to the operation direction in Step S822. Depending on a holding structure of the holding portion H, the detection unit 204 may detect the force by performing the image processing of the image captured by the electronic camera 15. When whether or not the retaining ring R can be drawn out is determined by using a sensor value obtained by the force sensor 111c, although the result depends on the holding structure of the holding portion H or a supply structure of the supply portion RS1, a threshold value thereof is generally greater than a threshold value for detecting the contact in Step S813 described above.

When the retaining ring R cannot be drawn out (S823: No), the process returns to Step S822, and the movement operation of the arm 11 is continued. When the retaining ring R can be drawn out (S823: Yes), the arm 11 moves in the operation direction (for example, the direction of Arrow D2-2 in FIG. 31) (S824). This operation is different from the operation in Step S815 in that only the movement directions or the movement speeds are different from each other. Accordingly, detailed description thereof will be omitted.

The above-described operation is the operation for causing the tool TT to draw out the retaining ring R from the retaining ring stand RS. Next, an operation for fitting the retaining ring R to the fitting portion I will be described.

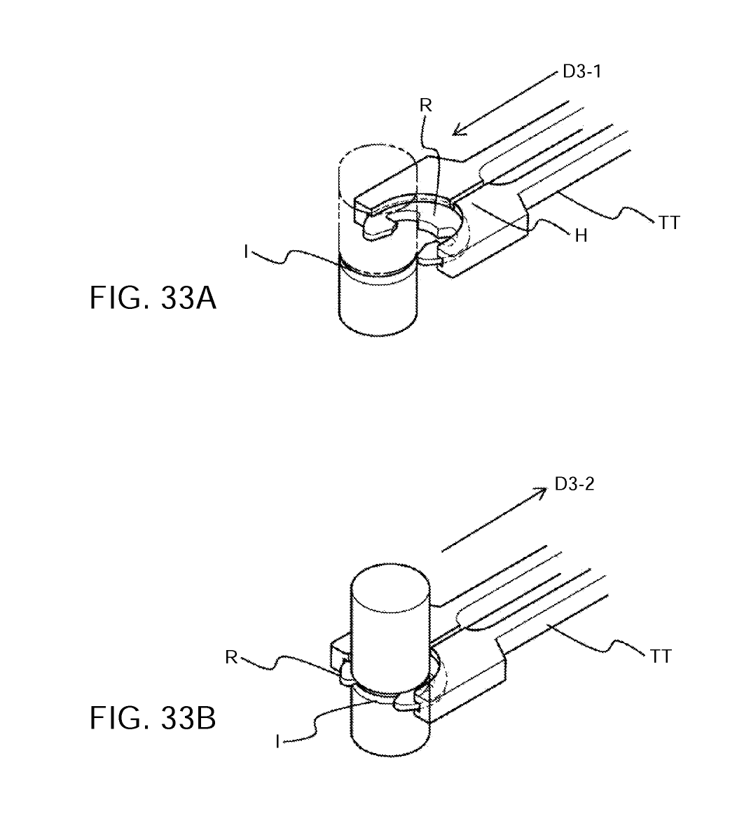

FIGS. 33A and 33B are views for describing an operation of the arm 11 and the hand 111 which perform the operation for fitting the retaining ring R to the fitting portion I (Step S83). FIG. 33A is a view in which the hand 111 is moved toward the fitting portion I, and FIG. 33B is a view in which the retaining ring R is fitted to the fitting portion I. In FIGS. 33A and 33B, configuration portions of the robot 1 are omitted for ease of illustration.

The arm 11 moves so that the hand 111 is oriented in a direction of Arrow D3-1. If it is detected that the retaining ring R comes into contact with the fitting portion I, the arm 11 further moves so that the hand 111 is oriented in the direction of Arrow D3-1. If it is detected that the retaining ring R is fitted to the fitting portion I, the arm 11 moves so that the hand 111 is oriented in a direction of Arrow D3-2. However, depending on a structure of the fitting portion I or a peripheral structure thereof, the arm 11 may move in other directions, or may combinedly move in multiple directions.

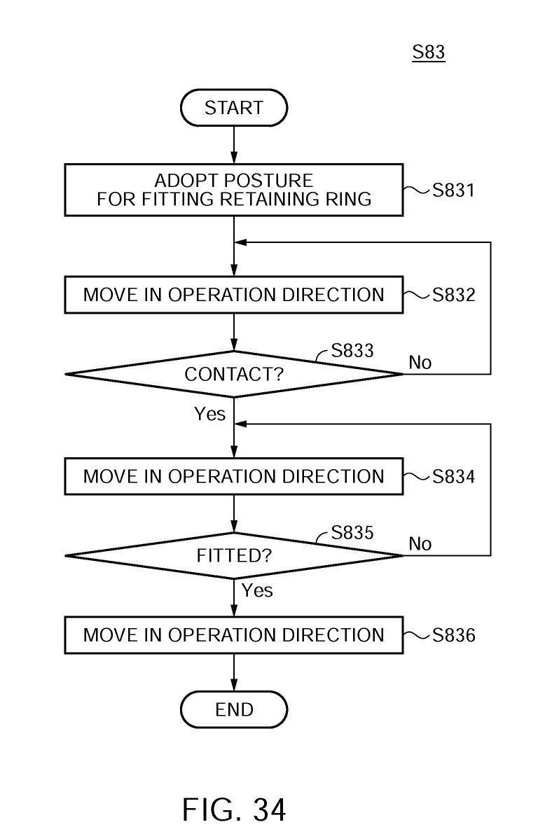

FIG. 34 is a process flowchart of the operation described with reference to FIGS. 33A and 33B. The arm 11 adopts a posture which enables the tool TT gripped by the hand 111 to fit the retaining ring R to the fitting portion I (Step S831). With the exception that the positions and the postures are different from each other, the details are the same as those in Step S811 and Step 821 which are described above, and thus, description thereof will be omitted.

Next, the arm 11 moves in the operation direction (for example, the direction of Arrow D3-1 in FIG. 33A) (S832). This operation direction is perpendicular to the bottom plate surface 111C-1. In other words, this operation direction is a direction from the contact portion (portion E) in which the tool TT gripped by the hand 111 comes into contact with the bottom plate surface 111C-1, to the holding portion (holding portion H) in which the retaining ring R is held by the tool TT. With the exception that the operation directions or the movement speeds are different from each other, the details are the same as those in Step S812 and Step S822 which are described above, and thus, description thereof will be omitted.

The detection unit 204 determines whether or not the retaining ring R comes into contact with the fitting portion I (S833). For example, this determination may be made by the detection unit 204 determining whether or not the force sensor 111c detects a force equal to or greater than a predetermined value in a direction opposite to the operation direction in Step S832. Alternatively, the detection unit 204 may detect the force by performing the image processing of the image captured by the electronic camera 15.

When the retaining ring R is not in contact with the fitting portion I (S833: No), the process returns to Step S832, and the movement operation of the arm 11 is continued. When the retaining ring R is in contact with the fitting portion I (S833: Yes), the arm 11 continues to perform the movement operation in the operation direction (for example, the direction of Arrow D3-1 in FIG. 33A) (S834). This operation is the same as the operation in Step S833 described above, and thus, detailed description thereof will be omitted.

The detection unit 204 determines whether or not the retaining ring R is fitted to the fitting portion I (S835). For example, this determination may be made by the detection unit 204 determining whether or not the force sensor 111c detects a force equal to or greater than a predetermined value in a direction opposite to the operation direction in Step S832 and Step S833. In addition, the detection unit 204 may detect whether or not the retaining ring R is fitted to the fitting portion I by further additionally performing the image processing of the image captured by the electronic camera 15. When whether or not the retaining ring R is fitted to the fitting portion I is determined by using a sensor value obtained by the force sensor 111c, a threshold value thereof is generally greater than a threshold value for detecting that the retaining ring R is drawn out from the retaining ring stand RS in Step S823 described above, or a threshold value for detecting the contact in Step S833 described above.

When the retaining ring R is not fitted to the fitting portion I (S835: No), the process returns to Step S834, and the movement operation of the arm 11 is continued. When the retaining ring R is fitted to the fitting portion I (S835: Yes), the arm 11 moves in the operation direction (for example, the direction of Arrow D3-2 in FIG. 33B) (S836). This operation is different from the operation in Step S815 and Step S824 which are described above in that only the moving directions are different from each other. Accordingly, detailed description thereof will be omitted.

Here, referring to FIG. 25, the operation for fitting the retaining ring R to the fitting portion I will be described in detail. A first end (portion E in FIG. 25) of the tool TT comes into contact with the bottom plate surface 111C-1, and the other portion of the tool TT is gripped by the opposite gripping surfaces 111B-1. The retaining ring R is held by the holding portion H which is a second end of the tool TT. In this state, the arm 11 is moved in the movement direction D3-1, thereby fitting the retaining ring R to the fitting portion I. The portion E corresponds to the first end according to an aspect of the invention, and the holding portion H corresponds to the second end according to an aspect of the invention.

The force required for fitting the retaining ring R is weaker than a sum of the force obtained by the gripping of the finger 111B (gripping surface 111B-1) and the force obtained by the tool TT coming into contact with the bottom plate surface 111C-1. That is, the gripping of the finger 111B (gripping surface 111B-1) is set so that a reaction force generated during the fitting operation does not cause the tool TT to be deviated from a position in which the tool TT is initially gripped by the finger 111B and a position in which the tool TT initially comes into contact with the bottom plate surface 111C-1. In this manner, it is possible to fit the retaining ring R to the fitting portion I so as not to be deviated from the fitting portion I.

The fitting operation direction is perpendicular to the bottom plate surface 111C-1 with which the end of the tool TT is in contact. In this manner, the reaction force generated during the fitting can be received perpendicularly to the bottom plate surface 111C-1. The force required when the retaining ring R is fitted to the fitting portion I depends on the specifications of the retaining ring R, but is approximately 150 N, if the retaining ring R has a nominal diameter of 5 mm. The robot 1 includes a configuration which can receive the reaction force generated during the fitting perpendicularly to the bottom plate surface 111C-1. Therefore, it is possible to fit the retaining ring R to the fitting portion I so as not to be deviated from the fitting portion I.

The fitting operation direction is the direction from the portion E to the holding portion H, if the tool TT is linear from the first end (portion E) to the holding portion (holding portion H) of the retaining ring R as illustrated in FIG. 24B. However, if the tool TT does not have the linear shape illustrated in FIG. 24B but has a curved or bent shape, the fitting operation direction is not limited thereto. The fitting operation direction can be determined so that a movement route of the retaining ring held by the tool is parallel to the fitting direction of the retaining ring alone. The fitting direction of the retaining ring alone represents a direction from a side of the retaining ring R which is opposite to the opening toward the opening as described with reference to FIG. 24A. Even if the tool TT is curved or bent, the above-described advantageous effect can be obtained by causing the fitting operation direction to be perpendicular to the bottom plate surface 111C-1.

Details of the operation in Step S84 in FIG. 28 can be realized by reversely performing the operation described with reference to FIGS. 29A to 30, and thus, description thereof will be omitted.

According to the first operation example, it is possible to fit the retaining ring R to the fitting portion I without using a mechanism for expanding the retaining ring R. The fitting itself can be performed by the movement in one direction. Accordingly, it is not necessary to perform a complicated operation, and thus, the fitting can be realized by performing only a simple operation.

According to the first operation example, the robot can cause the tool TT to hold the retaining ring R. Accordingly, the operation to complete the fitting can be efficiently performed. When the retaining ring R is supplied by the retaining ring stand RS, the tool TT can more efficiently hold the retaining ring R.

### Second Operation Example

Next a second operation example will be described. Only fitting methods (Step S83) of the retaining ring R are different from each other between the second operation example and the first operation example. The same reference numerals are given to the operation and the process which are the same as those in the previously described first operation example, and description thereof will be omitted. Hereinafter, the fitting of the retaining ring R will be described as Step S83a.

The second operation example is different in that the robot 1 detects the fitting portion I for the retaining ring R. To that end, the robot 1 moves the hand 111 while bringing the retaining ring R held by the tool TT into contact with a surface of a structure S. The structure S adopts any desired shape and configuration, but includes a surface with which the retaining ring R can be brought into contact (at least one of a flat surface and a curved surface). This surface includes at least one of the fitting portion I itself and a portion which can detect a position of the fitting portion I. For example, the portion which can detect the position of the fitting portion I is a concave portion, a convex portion, or both of these. The portion which can detect the position of the fitting portion I corresponds to the indication portion which indicates the fitting portion according to an aspect of the invention.

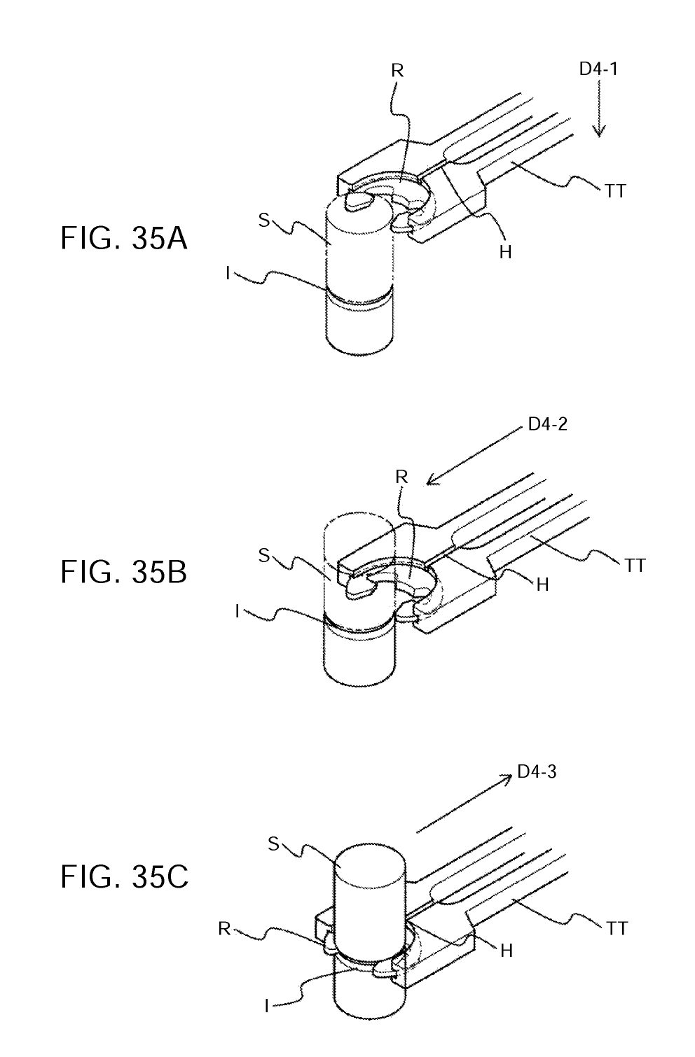

FIGS. 35A to 35C are views for describing the detection of the fitting portion for the retaining ring R. The structure S has a cylindrical shape. The fitting portion I which is a concave portion is detected by moving the hand 111 along a longitudinal direction of the cylindrical shape. FIG. 35A is a view when the retaining ring R held by the tool TT is brought into the surface of the structure S. FIG. 35B is a view when the fitting portion I is detected. FIG. 35C is a view when the retaining ring R is fitted to the fitting portion I. In FIGS. 35A to 35C, configuration portions of the robot 1 are omitted for ease of illustration.

The arm 11 moves in the movement direction, and brings the retaining ring R held by the tool TT into contact with the surface of the structure S. Then, the arm 11 moves the retaining ring R in a movement direction D4-1 while the retaining ring R is in contact with the surface of the structure S. If the fitting portion I is detected in this way, the operation which is the same as that in the above-described first operation example is performed so that the arm 11 is moved in a movement direction D4-2, thereby fitting the retaining ring R to the fitting portion I. If the retaining ring R is fitted to the fitting portion I, the arm 11 moves in a movement direction D4-3.

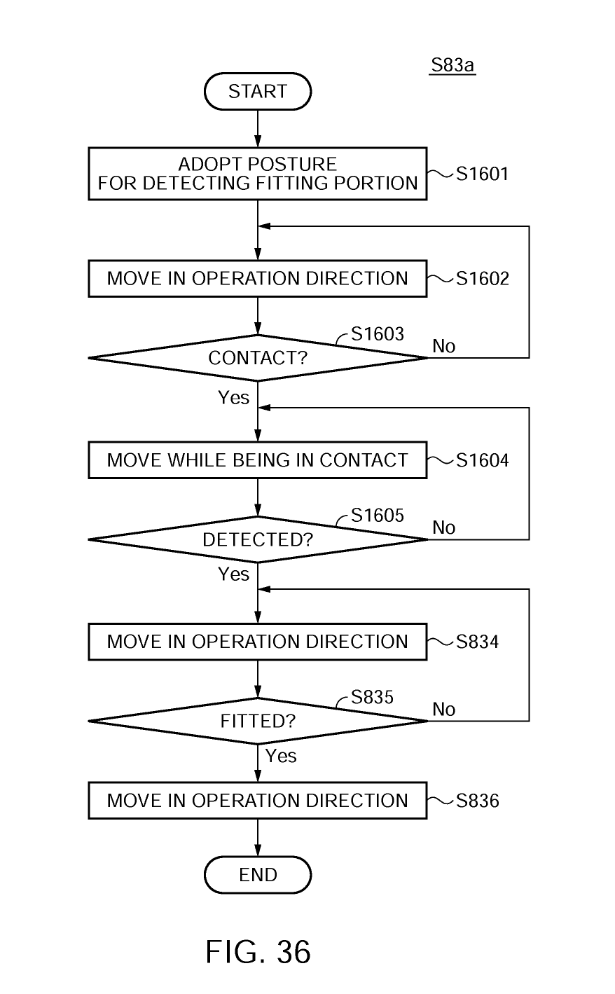

FIG. 36 is a process flowchart in Step S83a. The process in Step S83a includes the operation described with reference to FIGS. 35A to 35C. First, the arm 11 adopts a posture which enables the tool TT gripped by the hand 111 to detect the fitting portion I (Step S1601). With the exception that the operation directions or the postures are different from each other, the details are the same as those in Step S811, Step S821, and Step S831 which are described above, and thus, description thereof will be omitted.

Next, the arm 11 moves in the operation direction (S1602). With the exception that the operation directions or the movement speeds are different from each other, the details are the same as those in Step S812, Step S822, and Step S832 which are described above, and thus, description thereof will be omitted.

The detection unit 204 determines whether or not the retaining ring R comes into contact with the structure S (S1603). For example, this determination may be made by the detection unit 204 determining whether or not the force sensor 111c detects a force equal to or greater than a predetermined value in a direction opposite to the operation direction in Step S1602. Alternatively, the detection unit 204 may detect the force by performing the image processing of the image captured by the electronic camera 15.

When the retaining ring R is not in contact with the structure S (S1603: No), the process returns to Step S1602, and the movement operation of the arm 11 is continued. When the retaining ring R is in contact with the structure S (S1603: Yes), the arm 11 moves in the operation direction (for example, the direction of Arrow D4-1 in FIG. 35A) while the retaining ring R is brought into contact with the surface of the structure S (S1604). The operation direction in Step S1604 may be the same as or different from that in Step S1601. The operation direction in Step S1604 can be determined according to a shape of the structure S or any other desired condition.

The movement in Step S1604 is performed by combining a force control and a position control. That is, whereas the arm 11 is moved by the position control, a surface position of the structure S is detected by the force control. The detection is performed by inputting the reaction force generated from the surface of the structure S with which the retaining ring R held by the tool TT is in contact. Specifically, how to control can be understood if a known technology is employed. Accordingly, description thereof will be omitted.

The detection unit 204 determines whether or not the fitting portion I is detected (S1605). For example, this determination may be made by the detection unit 204 determining whether or not the force sensor 111c detects a force equal to or smaller than a predetermined value in a direction opposite to the operation direction in Step S1602, or in any other directions. Alternatively, the detection unit 204 may detect the force by performing the image processing of the image captured by the electronic camera 15. Alternatively, the determination may be made by combining both of these.

When the detection is performed by using a sensor value of the force sensor 111c, if the force in the direction opposite to the operation direction in Step S1602 is equal to or smaller than the predetermined value, in the structure S in FIGS. 35A to 35C, a position where the retaining ring R having the value is in contact with the structure S can be determined as the fitting portion I. That is, when the reaction force generated from the contact surface is weaker than the reaction force so far, the location thereof can be determined as a concave portion which is the fitting portion I. This is similarly applied to not only a case where the fitting portion I itself is the concave portion, but also a case where the position which can detect the position of the fitting portion I is the concave portion.

When the fitting portion I or the position which can detect the position of the fitting portion I is indicated by the concave portion, contrary to the above-described case, if the reaction force generated from the contact surface is stronger than the reaction force so far, the location can be determined as a convex portion.

When the fitting portion I is not detected (S1605: No), the process returns to Step S1604, the movement operation of the arm 11 is continued. At this time, the arm. 11 may change the posture and the position, and may change the operation direction so that the retaining ring R comes into contact with the other portion on the surface of the structure S. The operation direction for detecting the fitting portion I, and the posture and the position of the arm 11 can be arbitrarily determined according to a structure or a shape of the structure S, a structure or dimensions of the tool TT, and a movable range of the arm 11.

The subsequent operation when the fitting portion I is detected (S1605: Yes) is the same as that in the above-described first operation example, and thus, description thereof will be omitted. In this case, the position and the posture of the arm 11 may be adjusted again in order to fit the retaining ring R to the fitting portion I. The operation in Steps S1601 to S1605 corresponds to detection according to an aspect of the invention.

Hitherto, a case has been described where the structure S has the cylindrical shape and the fitting portion I of the concave portion is disposed in the cylindrical periphery thereof. However, the structure S and the fitting portion I are not limited thereto. For example, a through-hole may be disposed on the surface of the structure S, and the fitting portion I may be disposed inside the through-hole. In this case, the robot 1 may determine a position corresponding to the detected through-hole as the position of the fitting portion I. Then, the retaining ring R may be fitted to the fitting portion I by causing the tool TT to penetrate the through-hole.

According to the second operation example, it is possible to detect the fitting portion I to which the retaining ring R can be fitted. This enables the fitting to be efficiently performed. In addition, this operation example is particularly advantageous, when the position itself of the fitting portion I is greatly different or the position variations are great depending on a lot or an individual body.

Hitherto, the invention has been described with reference to the embodiment. However, the technical scope of the invention is not limited to the scope described in the above-described embodiment. It is apparent to those skilled in the art that various modifications or improvements can be added to the above-described embodiment. In addition, it is apparent from the scope according to an aspect of the invention that the modified or improved embodiment is also included in the technical scope of the invention. In particular, the invention may be provided as a robot system which separately has a robot and a controller, or may be provided as a robot including a controller. The invention may be provided as only a controller or a robot control device including a controller. In addition, the invention may be provided as a program for controlling a robot or a storage medium for storing a program.

### Fourth Embodiment

Hereinafter, a fourth embodiment will be described. The same reference numerals are given to elements which are the same as those in the first embodiment to the third embodiment, and description thereof will be omitted.

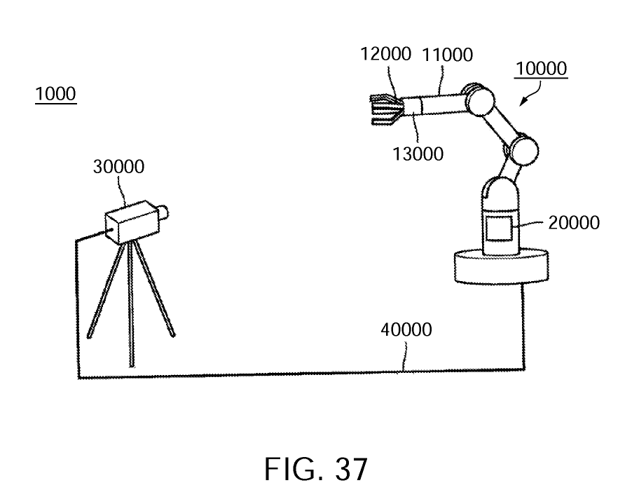

FIG. 37 is a view illustrating a schematic configuration example of a robot system 1000 according to an embodiment of the invention.

The robot system 1000 according to an aspect of the invention includes a robot 10000, a control device 20000, and an imaging unit 30000. The robot 10000 includes a control device 20000 therein. The imaging unit 30000 and the control device 20000 of the robot 10000 are connected to each other so that communication therebetween is available via a circuit 40000. In the embodiment, the circuit 40000 is provided in a wired manner, but may be provided in a wireless manner.

The robot system 1000 is a system in which a robot carries out a work with a tool gripped by the robot. In the embodiment, for example, the tool made for humans is used. Specifically, for example, the tool is an E-ring setter used in fitting an E-ring, or a screwdriver used in screw fastening. Hereinafter, as an example, a robot system including the robot 10000 gripping the E-ring setter will be described. In addition, when work is carried out by using a tool, the robot system 1000 accurately identifies a work position, thereby performing point contact at a reference position.

Here, for example, the work position represents a contact point for carrying out work between the tool gripped by the robot 10000 or a member held by the tool and a workpiece. The reference position represents a specific position on a surface of the workpiece, is a position in the vicinity of the work position, and is a position where a relative positional relationship from the work position is accurately defined. The position in the vicinity of the work position represents a position between the reference position and the work position, and which is close to such an extent that even the movement of the robot 10000 by the control device 20000 does not cause an error affecting work accuracy. In the embodiment, the workpiece is a member provided for a work, for example. The workpiece is arranged at a position where the robot 10000 gripping the tool can bring the tool into contact with the workpiece. In the embodiment, the point contact represents that the control device 20000 controls the robot 10000 to bring a predetermined portion of the tool into contact with the reference position, for example. The point contact includes that the operation of the robot 10000 is stopped, based on a detection result of the external force or the moment applied to the robot 10000 by the contact. For example, the predetermined portion of the tool represents a portion where the tool is easily brought into contact with the reference position, and is an end point such as a tip of the tool, for example.

For example, the robot 10000 is a single arm and multi-joint robot which includes a manipulator 11000 configuring one arm. The manipulator 11000 includes a hand (gripping unit) 12000 and a force sensor 13000 in a distal end section thereof. In addition, the manipulator 11000 includes a drive unit (actuator) for driving the hand 12000 or joints, and is operated, based on a control signal acquired from the control device 20000. The robot 10000 determines a position or a posture, based on multiple points on the hand 12000 or the arm, and can change a position or a posture of the tool. However, a control method for these is a known technology, and thus, description thereof will be omitted.

The hand 12000 includes a configuration member for gripping the tool, and includes two or more finger-shaped configuration members, for example. A position and a posture of the tool gripped by the hand 12000 are determined in advance for each tool. The hand 12000 grips a predetermined position of the tool so that the tool adopts a predetermined posture. In the embodiment, the hand 12000 grips a predetermined position in a handling portion of an E-ring setter so that the E-ring setter adopts a predetermined posture. In this manner, the robot system 1000 acquires coordinates of an end point of the tool in the world coordinate system. However, in some cases, an error may occur in the posture or the position of the tool during the gripping. Accordingly, the position of the end point of the tool in the world coordinate system is not an accurate one which is necessarily coincident with a position in the real space. A known technology can be used in the process for gripping the predetermined position, and thus, description thereof will be omitted.

The force sensor 13000 detects the force and the moment which are applied to the hand 12000. The force sensor 13000 outputs force information indicating the detected force and moment to the control device 20000. For example, the force sensor 13000 simultaneously detects six components of force components in three translational axes and moment components around three rotational axes. Here, for example, the three translational axes represent three coordinate axes (X-axis, Y-axis, and Z-axis) which form a three-dimensional orthogonal coordinate system and are orthogonal to one another.

The imaging unit 30000 includes a camera module, and is installed in an arrangement which can capture images including the tool gripped by the robot 10000 and the workpiece.

The imaging unit 30000 images the tool and the workpiece at predetermined time intervals such as 30 msec, for example. In addition, the imaging unit 30000 includes a communication interface connected to the circuit 40000. The imaging unit 30000 transmits object image information which is information of the captured image to the control device 20000 via the circuit 40000.

The control device 20000 controls the robot 10000 by using three types of control methods such as visual servo, an impedance control, and a position-posture control.

The visual servo is the control method for tracking a target by measuring a change in a relative position with the target as visual information and by using the measured visual information as feedback information. In the visual servo, the control device 20000 compares an object image frequently captured by the imaging unit 30000 with a target image, and performs a visual feedback control so that the object image is coincident with the target image. Here, the target image is an image captured by the imaging unit 30000 in a state where the object is arranged at the targeted position and posture. In the embodiment, for example, the object is the tool gripped by the hand 12000.

The impedance control is a control based on an output of the force sensor 13000 included in the robot 10000. In the impedance control, the control device 20000 detects the external force applied to the robot 10000, and controls a drive torque of the actuator so that responses of displacement caused by the external force (stiffness), velocity (viscosity), and inertia (acceleration) become a desired value.

The position-posture control is a control method for controlling a position and a posture of the robot 10000 and an object gripped by the robot 10000 by designating specific target coordinates as coordinates of a control target point in the world coordinate system recognized by the robot system 1000. In the position-posture control according to the embodiment, for example, the control device 20000 controls the robot 10000 so that current coordinates of the end point of the tool is coincident with target coordinates. In addition, in the position-posture control according to the embodiment, for example, the control device 20000 controls the robot 10000 so that the endpoint of the tool passes through a line segment connecting the current coordinates of the endpoint of the tool and the target coordinates.

### Overview of Control Device

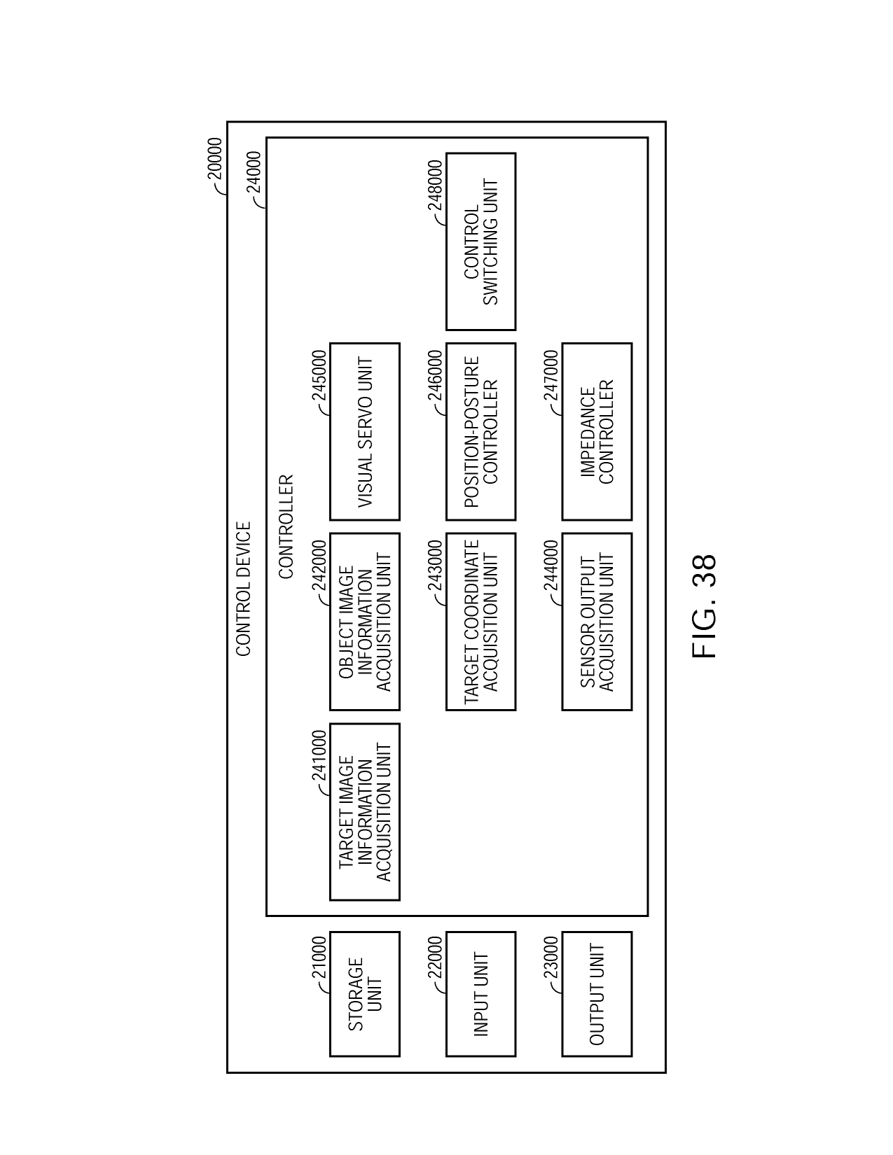

FIG. 38 is a block diagram illustrating an example of a schematic functional configuration of the control device 20000.

The control device 20000 is a control device for controlling an operation of the robot 10000, and includes a central processing unit (CPU) and a storage device inside the control device. In addition, the control device 20000 includes a storage unit 21000, an input unit 22000, an output unit 23000, and a controller 24000.

For example, the storage unit 21000 includes a hard disk drive (HDD), a flash memory, an electrically erasable programmable read only memory (EEPROM), a read only memory (ROM), or random access memory (RAM). The storage unit 21000 stores various programs which cause a CPU included in the control device 20000 to execute a process, or results of the process executed by the CPU.

The storage unit 21000 stores information for performing various controls to carry out a work. For example, the storage unit 21000 stores a switching condition and a switching order for the control in the work. In addition, for example, the storage unit 21000 stores target image information which is information of a target image used in the visual servo. In addition, for example, the storage unit 21000 stores target coordinates of the end point of the tool which are used in the position-posture control. In addition, for example, the storage unit 21000 stores target values of impedance in inertia, damping coefficient, and rigidity which are used in the impedance control. For example, the controller 24000 partially or entirely functions by the program stored in the storage unit 21000 causing the CPU included in the control device 20000 to execute the process. In addition, the controller 24000 may be partially or entirely configured to include hardware such as large scale integration (LSI) or an application specific integrated circuit (ASIC).

The input unit 22000 receives an input from the outside. For example, the input unit 22000 may include a keyboard or a mouse for receiving an operation input from a user of the robot system 1000. In addition, for example, the input unit 22000 may include a communication interface, and may have a function of receiving an input from an external device.

The output unit 23000 outputs various information items to the outside. For example, the output unit 23000 may include a display which outputs image information to a user. In addition, for example, the output unit 23000 may include a speaker which outputs voice information to the user. In addition, for example, the output unit 23000 may include a communication interface, and may have a function of outputting information to an external device.

The controller 24000 includes a target image information acquisition unit 241000, an object image information acquisition unit 242000, a target coordinate acquisition unit 243000, a sensor output acquisition unit 244000, a visual servo unit 245000, a position-posture controller 246000, an impedance controller 247000, and a control switching unit 248000.

The target image information acquisition unit 241000 reads target image information from the storage unit 21000, and outputs the read target image information to the visual servo unit 245000.

The object image information acquisition unit 242000 acquires object image information indicating an object image from the imaging unit 30000 via the circuit 40000. The object image information acquisition unit 242000 outputs the acquired object image information to the visual servo unit 245000.

The target coordinate acquisition unit 243000 reads target coordinate information for the position-posture control from the storage unit 21000, and outputs the read target coordinate information to the position-posture controller 246000.

The sensor output acquisition unit 244000 acquires force information output from the force sensor 13000 via the circuit 40000, and outputs the acquired force information to the impedance controller 247000.

The visual servo unit 245000 generates a control signal for controlling the robot 10000 using the visual servo, based on the target image information acquired from the target image information acquisition unit 241000 and the object image information acquired from the object image information acquisition unit 242000. The visual servo unit 245000 transmits the generated control signal to the robot 10000.

The position-posture controller 246000 acquires information indicating the target coordinates from the target coordinate acquisition unit 243000, and generates a control signal for controlling the robot 10000 using the position-posture control, based on the target coordinates indicated by the acquired information and the current coordinates of the end point of the tool. The position-posture controller 246000 transmits the generated control signal to the robot 10000.

The impedance controller 247000 acquires force information from the sensor output acquisition unit 244000, and generates a control signal for controlling the robot 10000 using the impedance control, based on the acquired force information. The impedance controller 247000 transmits the generated control signal to the robot 10000. In the embodiment, for example, the impedance controller 247000 generates a control signal, based on any one of two target values such as a great target value for gripping the tool with a strong force and a small target value for gripping the tool with a weak force, with regard to a reaction force received from the tool gripped by the hand 12000.

The control switching unit 248000 switches control methods and target values thereof which are applied out of the visual servo, the position-posture control, and the impedance control. For example, the control switching unit 248000 switches the control methods and the target values, based on a control switching condition and a control order which are stored in the storage unit 21000, and adjusts control signals generated by the visual servo unit 245000, the position-posture controller 246000, and the impedance controller 247000. For example, the control switching unit 248000 determines point contact (to be described later), and switches the target values of the position-posture controller 246000.

### Overview of Operation of Robot System

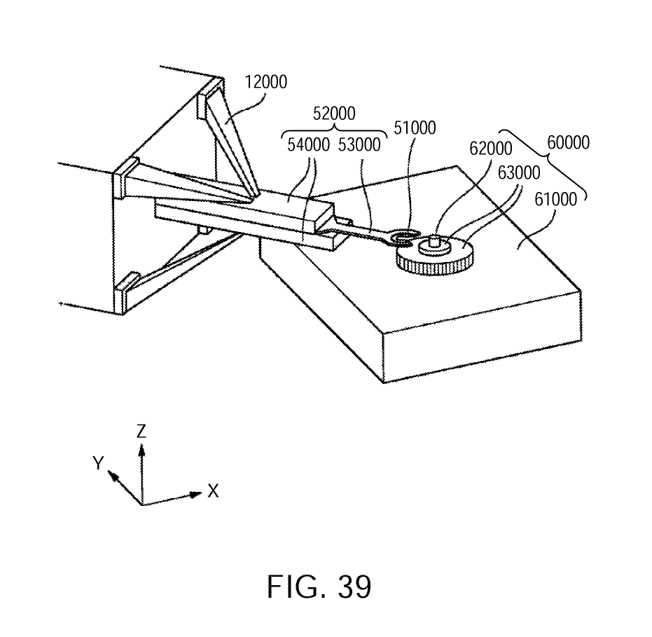

FIG. 39 is a view for describing a first example of work carried out by the robot system 1.

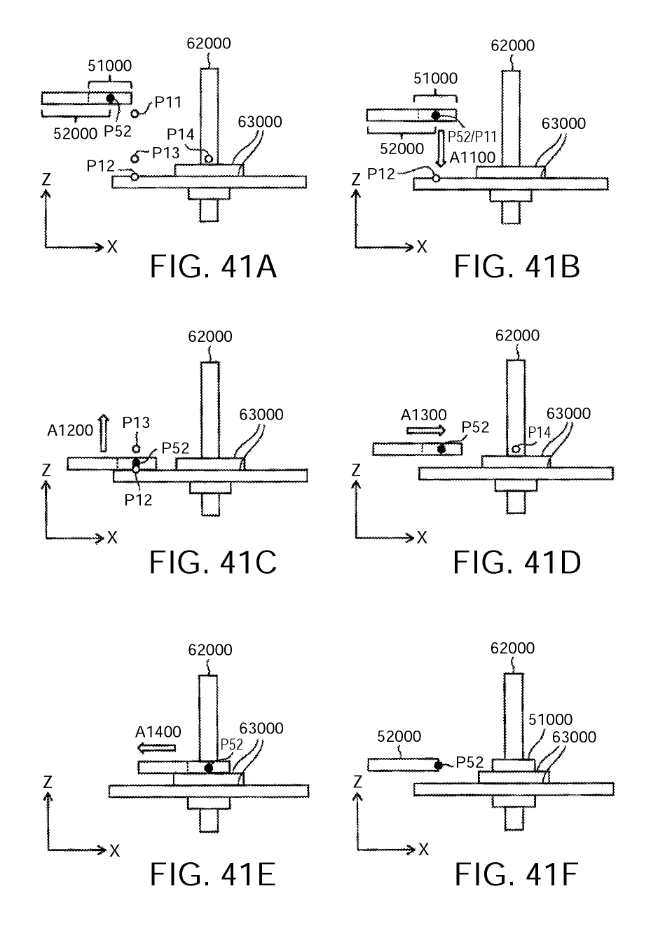

An X-axis, a Y-axis, and a Z-axis which are illustrated in FIGS. 41A to 41F, 42, and 44A to 44F (to be described later) respectively represent each axis in the three-dimensional orthogonal coordinate system in the world coordinate system. In the first example of the work, the robot 10000 carries out work for fitting an E-ring 51000 to a shaft portion 62000 of a workpiece 60000 by using an E-ring setter 52000 including a blade portion 53000 and a handling portion 54000. As illustrated in the drawing, a hand 12000 of the robot 10000 grips the E-ring setter 52000 in which the E-ring 51000 is held by the blade portion 53000.

The workpiece 60000 includes a fixing base 61000, a shaft portion 62000, and a gear portion 63000. For example, the fixing base 61000 is fixed to a working table in an arrangement which does not interfere with the operation of the robot 10000. In addition, the fixing base 61000 fixes the shaft portion 62000 so that a longitudinal axis direction of the shaft portion 62000 is perpendicular to a horizontal plane. The gear portion 63000 has a shape in which two large and small discs are superimposed on each other, and a hole perpendicular to a disc surface is formed on the center of the disc surface. The shaft portion 62000 passes through the hole without any clearance. The disc surface of the gear portion 63000 is held to be parallel to the horizontal plane. In addition, a fixing member is present in a lower portion of the gear portion 63000. The fixing member fixes the gear portion 63000 so that the gear portion 63000 does not move in a direction of gravity.

In the first example of the work, the robot system 1000 carries out the work for fitting the E-ring 51000 to the shaft portion 62000 in the upper portion of the gear portion 63000 by using the E-ring setter 52000 in a state illustrated in FIG. 39. For example, a position for fitting the E-ring 51000 is 8.0 mm above from an upper surface of the large disc of the gear portion 63000. For example, the robot system 10000 carries out this work requiring work accuracy in which an error in the Z-axis direction is set to 0.5 mm or less.

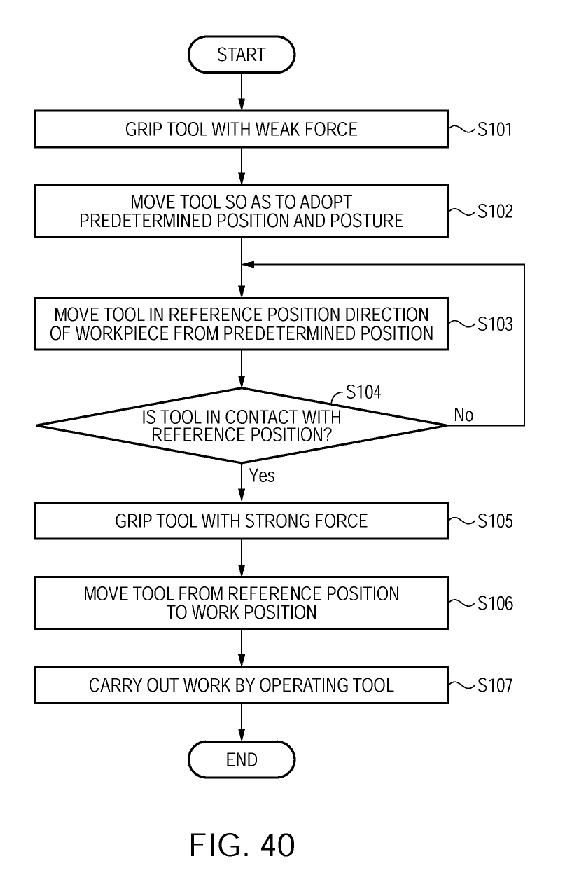

FIG. 40 is a flowchart illustrating an example of process flow performed by the control device 20000 in the first example of the work.

This drawing illustrates an example of the process when performing the first example of the work described with reference to FIG. 39. First, the control device 20000 controls the robot 10000 to grip the tool with a weak force (Step S101). Here, the weak force is a strength set to such an extent that even when the tool is tilted, the tool does not fall or a relative posture of the tool is not changed with respect to the hand 12000. In addition, the work force is a strength set to such an extent that when the tool comes into contact with an object, the external force causes the relative posture of the tool to be flexibly changed with respect to the robot 10000. Next, for example, the control device 20000 performs the visual servo, and controls the robot 10000 so that the tool adopts predetermined position and posture (Step S102).

Next, for example, the control device 20000 performs the position-posture control to move the robot 10000 from a predetermined position in a direction toward the reference position of the workpiece (Step S103). This process aims to bring the endpoint of the tool into contact with the reference position of the workpiece. However, an error may occur when the robot system 1000 recognizes the end point of the tool. Consequently, even if the reference position is targeted, a possibility that the tool does not come into contact with the reference position may be considered. Therefore, the control device 20000 may move the robot 10000 in the same direction until the contact between the tool and the reference position is detected. In this manner, it is possible to more reliably bring the tool into contact with the reference position of the workpiece.

Next, the control device 20000 determines whether or not the tool comes into contact with the reference position (Step S104). For example, the control device 20000 determines whether or not a change amount per unit time of the force or the moment indicated by the force information acquired from the force sensor 13000 is greater than a predetermined value, thereby determining whether or not the tool comes into contact with the reference position. When the tool is not in contact with the reference position (Step S104: NO), the control device 20000 returns to the process in Step S103. When the tool is in contact with the reference position (Step S104: YES), the control device 20000 performs the impedance control, and causes the robot 10000 to strengthen the force for gripping the tool (Step S105). Here, the strong force is strength set to such an extent that even when the tool comes into contact with the object, the relative position of the tool with respect to the hand 12000 is not changed up to a degree affecting work accuracy. Next, the control device 20000 performs the position-posture control based on a predetermined positional relationship between the reference position and the work position, thereby moving the robot 10000 to the work position (Step S106). Then, the control device 20000 controls the robot 10000 to carry put the work (Step S107).

FIGS. 41A to 41F are views for describing an example of the operation of the robot system 1000 in the first example of the work.

This drawing illustrates an example of the operation when performing the first example of the work described with reference to FIG. 39.

FIG. 41A illustrates a first example of a positional relationship between the tool and the workpiece 60000 in the first example of the work, and illustrates a state before the work starts.

As illustrated in this drawing, before the work starts, the E-ring setter 52000 gripped by the robot 10000 holds the E-ring 51000. A point P52 represents the end point on the blade portion 53000 side in the E-ring setter 52000. Points P11, P12, P13, and P14 respectively represent points serving as a reference for control. In addition, the points P11, P12, and P13 are located on the same straight line which is parallel to the Z-axis. In addition, the points P13 and P14 are located on the same straight line which is parallel to the X-axis. The point P12 represents the reference position of the point contact. The point P14 represents the work position. For example, a member such as the gear portion 63000 is normally molded so as to have high accuracy in which an error is ±0.05 mm or less. In this example, the reference position is a specific position on a surface of the gear portion 63000, and the work position is a position of 8.0 mm above the upper surface of the large disc of the gear portion 63000. That is, in this example, the relative positional relationship between the reference position and the work position is accurately defined. In this state, for example, the robot system 1000 performs the process illustrated in Step S102 in FIG. 40.

FIG. 41B illustrates a second example of the positional relationship between the tool and the workpiece 60000 in the first example of the work.

In a state illustrated in FIG. 41A, if the robot system 1000 performs the process illustrated in Step S102 in FIG. 40, an end point P52 is superimposed on the point P11 representing a predetermined position. In this example, the predetermined position is set upward in a perpendicular direction of the reference position for the point contact. In this state, for example, the robot system 1000 performs the process illustrated in Step S103 in FIG. 40. As illustrated by Arrow A1100, the robot system 1000 moves the E-ring setter 52000 downward in the perpendicular direction which is the direction of the reference position.

FIG. 41C illustrates a third example of the positional relationship between the tool and the workpiece 60000 in the first example of the work.

In a state illustrated in FIG. 41B, if the robot system 1000 performs the process illustrated in Step S103 in FIG. 40, the E-ring setter 52000 comes into contact with the point P12 of the reference position. If the robot system 1000 detects the contact between the E-ring setter 52000 and the gear portion 63000, the robot system 1000 performs the process illustrated in Step S105 in FIG. 40, and causes the robot 10000 to strengthen the gripping force for the E-ring setter 52000. In this state, the robot system 1000 performs the process illustrated in Step S106 in FIG. 40. As illustrated by Arrow A1200, the robot system 1000 moves the E-ring setter 52000 upward in the perpendicular direction. At this time, the control device 20000 does not regard the point P13 as the target coordinate. For example, based on the relative position of the point P13 with respect to the point P12, the control device 20000 controls the robot 10000. Specifically, in this example, the point P12 and the point P13 are present on the same straight line which is parallel to the Z-axis. Accordingly, the control device 20000 controls the robot 10000 to move the E-ring setter 52000 in the Z-axis direction by a distance amount between the point P12 and the point P13. That is, the control device 20000 controls the robot 10000 based on a change amount in a predetermined distance. Hereinafter, the position-posture control based on the change amount in this movement or angle is referred to as a relative control.

FIG. 41D illustrates a fourth example of the positional relationship between the tool and the workpiece 60000 in the first example of the work.

If the robot system 1000 performs the process described with reference to FIG. 41C, the E-ring setter 52000 moves to a height of the work position. In this example, the point P12 of the reference position and the point P14 of the work position is separated by only 8 mm in a height direction. Accordingly, an error caused by the operation of the robot 10000 hardly occurs in this movement. In addition, in this example, the robot system 1000 performs the relative control to move the E-ring setter 52000 by 8 mm from the upper surface of the large disc of the gear portion 63000. Accordingly, even if there is an error in the Z-axis coordinate system recognized by the robot system 1000, a positional error in the height direction hardly occurs in the vicinity of the reference position in the real space. Therefore, the robot system 1000 can realize high accuracy in the height direction which requires the high accuracy in the first example of the work. In this state, the control device 20000 performs the relative control based on the relative position of the point P14 with respect to the point P13. As illustrated by Arrow A1300, the control device 20000 moves the E-ring setter 52000 in the horizontal direction.

FIG. 41E illustrates a fifth example of the positional relationship between the tool and the workpiece 60000 in the first example of the work.

If the robot system 1000 performs the process described with reference to FIG. 41D, the end point P52 of the tool moves to the work position, and the E-ring 51000 is fitted to the shaft portion 62000. In this state, for example, as illustrated by Arrow A1400, the control device 20000 moves the E-ring setter 52000 in a direction opposite to the direction during the fitting.

FIG. 41F illustrates a sixth example of the positional relationship between the tool and the workpiece 60000 in the first example of the work, and illustrates a state when the work is completed.

If the robot system 1000 performs the process described with reference to FIG. 41E, the robot system 1000 detaches the E-ring 51000 from the E-ring setter 52000, and completes the work.

For example, when a position of the distal end portion of the hand 12000 is specified in the world coordinate system, based on the image captured by the imaging unit 30000, an error of approximately 1 mm which is caused by resolution of the image and an error of approximately 1 mm which is caused by a calibration error respectively occur. In addition, in some cases, errors in the resolution, an installation position, an installation direction, and imaging intervals of the imaging unit 30000 may become the positional error of the distal end portion of the hand 12000. Furthermore, if errors caused by the gripping position or the gripping posture when the hand 12000 grips the tool are included, an error of several mm or more may occur in the distal end portion of the hand 12000, in some cases. Therefore, when the robot 10000 is controlled by directly specifying the work position, there is a possibility of failure in the work requiring high accuracy as in the first example of the work.

In contrast, the control device 20000 according to the embodiment performs the relative control for the robot 10000 after determining the position or the posture of the tool using the point contact. In this manner, as an example, the robot 10000 can perform positioning requiring high accuracy in which an error is zero point several mm or less, or zero point several degrees or less, when the movement due to the relative control is approximately several mm to several cm, or when an angular change is approximately several degrees. In addition, according to the robot system 1000, the error is suppressed by the point contact for each work. Therefore, there is no possibility that the above-described errors caused by the resolution of the image or the calibration error, and the error caused by gripping the tool are accumulated.

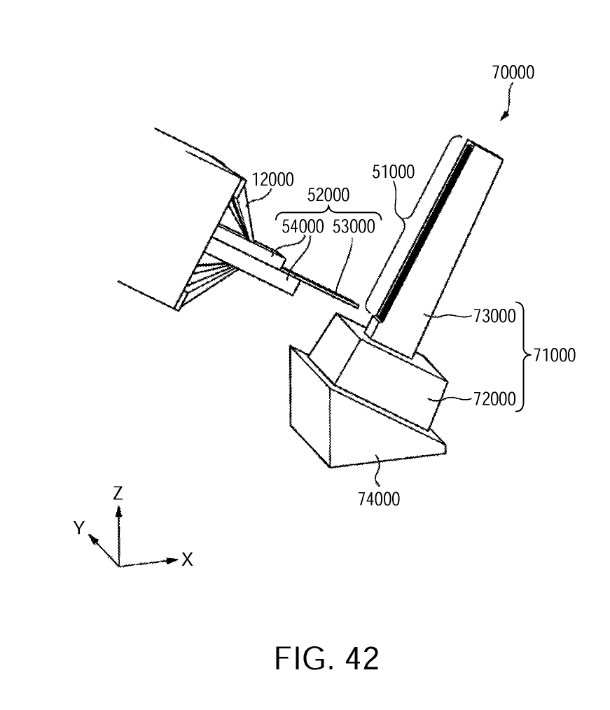

FIG. 42 is a view for describing a second example of the work carried out by the robot system 1000.

In the second example of the work, the robot 10000 carries out work for drawing out the E-ring from an E-ring stand and holding the E-ring by using an E-ring setter. As illustrated in the drawing, a workpiece 70000 includes an E-ring stand 71000 and a tilting table 74000. The E-ring stand 71000 includes a pedestal 72000 and an accommodation portion 73000. A lower portion of the pedestal 72000 is fixed to the tilting table 74000, and an upper portion of the pedestal 72000 fixes the accommodation portion 73000. An upper surface of the pedestal 72000 is a plane. The accommodation portion 73000 accommodates the E-ring 51000 having a planar shape by stacking the E-ring 51000 thereon so that the E-ring 51000 can be drawn out. In addition, the accommodation portion 73000 accommodates the E-ring 51000 so that a plate surface of the E-ring 51000 is held parallel to the upper surface of the pedestal 72000. For example, the tilting table 74000 is fixed to the working table in an arrangement which does not interfere with the operation of the robot 10000. In addition, the tilting table 74000 fixes the E-ring stand 71000 by tilting the E-ring stand 71000 at a predetermined angle. In this example, the tilting table 74000 fixes the E-ring stand 71000 by tilting the E-ring stand 71000 around the Y-axis at 30 degrees with respect to the horizon. In this manner, the upper surface of the pedestal 72000 and the upper surface of the E-ring 51000 are tilted around the Y-axis at 30 degrees with respect to the horizon.

In the second example of the work, in a state illustrated in FIG. 42, the robot system 1000 carries out the work for drawing out the E-ring 51000 accommodated in the accommodation portion 73000 of the E-ring stand 71000 by using the E-ring setter 52000. In this work, the robot system 1000 presses the blade portion 53000 of the E-ring setter 52000 against the E-ring 51000 arranged in the lowermost layer, out of the E-rings 51000 which are stacked on one another in the accommodation portion 73000, thereby drawing out the E-ring 51000. In addition, in this work, the E-ring 51000 is pressed by tilting the plate surface of the blade portion 53000 of the E-ring setter 52000 downward with respect to the plate surface of the E-ring 51000 by approximately one degree. In this case, it is empirically known that the success rate in the work is increased.

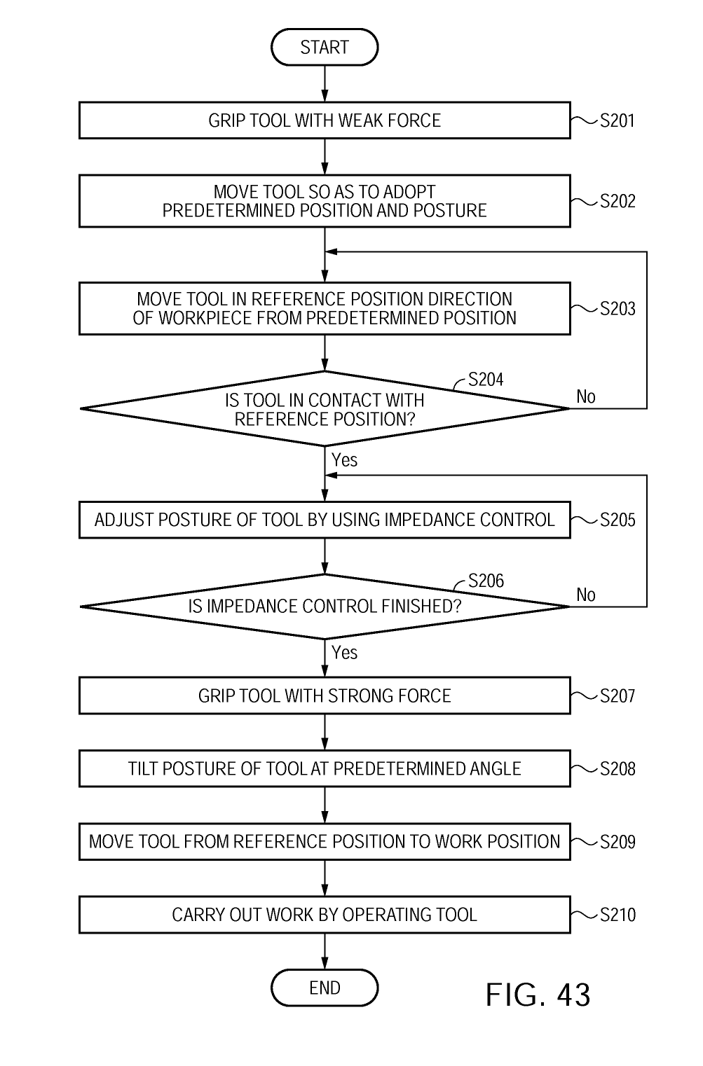

FIG. 43 is a flowchart illustrating a flow example of a process performed by the control device 20000 in the second example of the work.

This drawing illustrates an example of the process when performing the second example of the work described with reference to FIG. 42. The processes illustrated in Steps S201 to S204, S209, and S210 in FIG. 43 are the same as the processes illustrated in Steps S101 to S104, S106, and S107 in FIG. 40, and thus, description thereof will be omitted.

In Step S204, when the tool comes into contact with the reference position (Step S204: YES), the control device 20000 performs the impedance control, and causes the robot 10000 to adjust a posture of the tool (Step S205). Specifically, adjusting the posture of the tool means that the tool is brought into point contact with the reference position and the posture of the tool is adjusted, based on the inclination of a plane present at the reference position. Hereinafter, the plane present at the reference position is referred to as a reference plane. In the embodiment, the control device 20000 adjusts the posture of the E-ring setter 52000 by causing the reference plane to be parallel to the plate surface of the blade portion 53000 of the E-ring setter 52000. In adjusting the posture, for example, the control device 20000 performs the impedance control based on a torsional moment detected by the force sensor 13000.

Next, the control device 20000 determines whether or not the impedance control is finished and the posture is adjusted by the point contact (Step S206). When the impedance control is not finished (Step S206: NO), the control device 20000 returns to the process in Step S205. When the impedance control is finished (Step S206: YES), the control device 20000 performs the impedance control, and causes the robot 10000 to strengthen the force for gripping the tool (Step S207). Then, the control device 20000 controls the robot 10000 to tilt the posture of the tool by a predetermined angle (Step S208). Then, the control device 20000 performs a process which is the same as the process described in Steps S106 and S107 in FIG. 40, and completes the process.

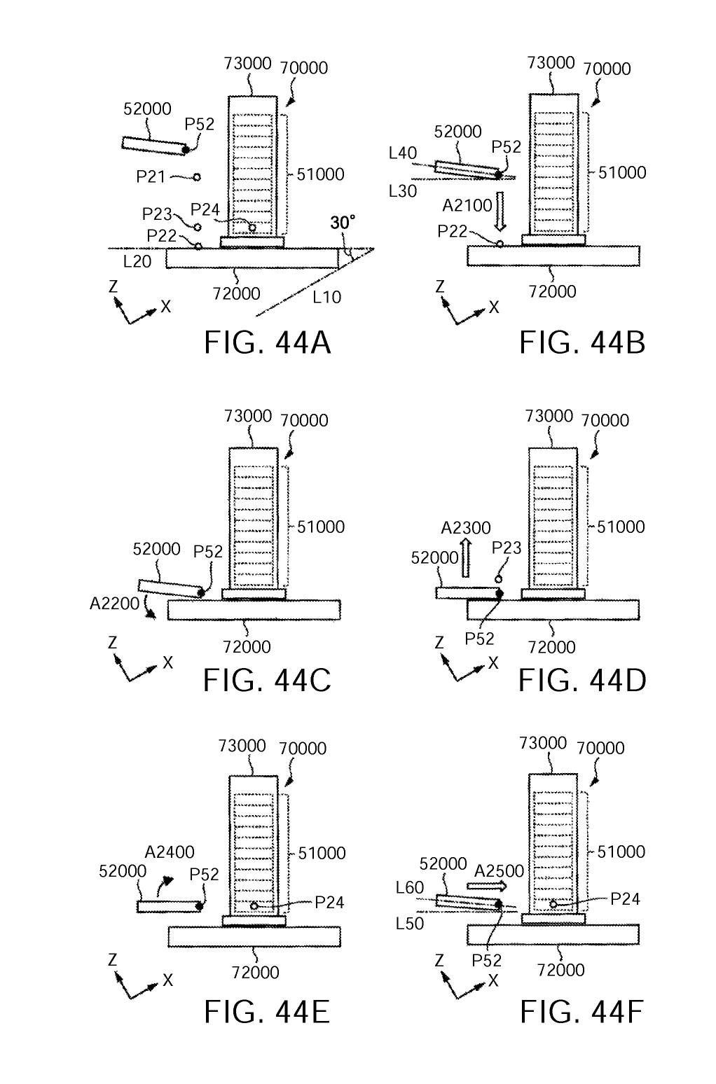

FIGS. 44A to 44F are views for describing an example of the operation of the robot system 1000 in the second example of the work.

This drawing illustrates an example of the operation when performing the second example of the work described with reference to FIG. 42.

FIG. 44A illustrates a first example of a positional relationship between the tool and the workpiece 70000 in the second example of the work, and illustrates a state before the work starts.

As described with reference to FIG. 42, the E-ring stand 71000 illustrated in this drawing is tilted around the Y-axis at 30 degrees with respect to the horizon. That is, on the XZ plane, an intersection angle between a line L10 parallel to the X-axis and a line L20 parallel to the upper surface of the pedestal 72000 is 30 degrees. The accommodation portion 73000 accommodates 10 E-rings 51000. A point P52 represents an end point on the blade portion 53000 side in the E-ring setter 52000. Points P21, P22, P23, and P24 respectively represent points serving as a reference for control. In addition, the points P21, P22, and P23 are located on the same straight line. In addition, the points P23 and P24 are located on the same straight line which is parallel to the upper surface of the pedestal 72000. The point P22 represents the reference position of the point contact. The point P24 represents the work position. In this example, the reference position is a specific position on the upper surface of the pedestal 72000. The work position is a center portion of the E-ring 51000 in the lowermost layer which is accommodated so that the plate surface is held in parallel to the upper surface of the pedestal 72000. In addition, in this example, each member of the E-ring stand 71000 is molded and assembled with high accuracy. Accordingly, in a distance and a posture between the upper surface of the pedestal 72000 and the plate surface of the E-ring 51000, there is no error which may hinder work accuracy. Therefore, the relative positional relationship between the reference position and the work position is accurately defined. In this state, for example, the robot system 1000 performs the process illustrated in Step S202 in FIG. 43.

FIG. 44B illustrates a second example of the positional relationship between the tool and the workpiece 70000 in the second example of the work.

In a state illustrated in FIG. 44A, if the robot system 1000 performs the process illustrated in Step S202 in FIG. 43, the end point P52 is superimposed on the point P21 representing a predetermined position. In this example, the predetermined position is set on a normal line passing through the reference position of the point contact, which is the normal line with respect to the upper surface of the pedestal 72000. In addition, in this example, a predetermined posture may be a posture in which the E-ring setter 52000 is rotated about the end point P52 around the Y-axis in a direction ZX by approximately several degrees. In this manner, even if an error occurs when the robot system 1000 recognizes the posture of the tool, the robot system 1000 can more reliably bring the end point P52 of the tool into contact with the reference position of the workpiece, and can adjust the posture of the tool using the point contact. In this state, for example, the robot system 1000 performs the process illustrated in Step S203 in FIG. 43. As illustrated by Arrow A2100, the robot system 1000 moves the E-ring setter 52000 in a direction of the reference position.

FIG. 44C illustrates a third example of the positional relationship between the tool and the workpiece 70000 in the second example of the work.

In a state illustrated in FIG. 44B, if the robot system 1000 performs the process illustrated in Step S203 in FIG. 43, the E-ring setter 52000 comes into contact with the point P22 of the reference position. If the robot system 1000 detects the contact between the E-ring setter 52000 and the pedestal 72000, the robot system 1000 performs the process illustrated in Step S205 in FIG. 43. For example, as illustrated by Arrow A2200, the robot system 1000 changes the posture of the E-ring setter 52000, and adjusts the posture of the E-ring setter 52000 so that the upper surface of the pedestal 72000 which is the reference plane is parallel to the plate surface of the blade portion 53000 of the E-ring setter 52000. In this case, the robot system 1000 may adjust the posture of the E-ring setter 52000 by bringing the reference plane and the plate surface of the blade portion 53000 of the E-ring setter 52000 into contact (for example, approximately several mm²) with each other.

FIG. 44D illustrates a fourth example of the positional relationship between the tool and the workpiece 70000 in the second example of the work.

If the robot system 1000 performs the process illustrated in Step S205 in FIG. 43, the upper surface of the pedestal 72000 is parallel to the plate surface of the blade portion 53000 of the E-ring setter 52000. In this state, the robot system 1000 performs the process illustrated in Step S207 in FIG. 43, and causes the robot 10000 to strengthen the gripping force for the E-ring setter 52000. For example, as illustrated by Arrow A2300, the robot system 1000 moves the E-ring setter 52000 upward in the normal direction on the upper surface of the pedestal 72000. At this time, the control device 20000 does not regard the point P23 as the target coordinate. For example, the control device 20000 controls the robot 10000, based on the relative position of the point P23 with respect to the point P22. Specifically, in this example, the point P22 and the point P23 are present on the same straight line which is parallel to the normal line on the upper surface of the pedestal 72000. Accordingly, the control device 20000 controls the robot 10000 to move the E-ring setter 52000 upward in the normal direction on the upper surface of the pedestal 72000 by a distance amount between the point P22 and the point P23.

FIG. 44E illustrates a fifth example of the positional relationship between the tool and the workpiece 70000 in the second example of the work.

If the robot system 1000 performs the process described with reference to FIG. 44D, the height of the end point P52 with respect to the upper surface of the pedestal 72000 becomes the height of the work position with respect to the upper surface of the pedestal 72000. In this state, as illustrated by Arrow A2400, the robot system 1000 rotates the E-ring setter 52000 about the end point P52 around the Y-axis in the direction ZX by one degree. At this time, the control device 20000 does not regard the rotated posture at the point P23 as the target posture. For example, the control device 20000 performs the relative control, based on a change amount of the angle to be rotated from the posture adjusted by the reference plane.

FIG. 44F illustrates a sixth example of the positional relationship between the tool and the workpiece 70000 in the second example of the work.

If the robot system 1000 performs the process described with reference to FIG. 44E, the E-ring setter 52000 is tilted with respect to the plate surface of the E-ring 51000 accommodated in the accommodation portion 73000 of the E-ring stand 71000 by one degree in the direction ZX. That is, on the XZ plane, an intersection angle between a line L50 parallel to the plate surface of the E-ring 51000 and a line L60 parallel to the long shaft of the E-ring setter 52000 is one degree. In this state, the control device 20000 performs the relative control for the robot 10000, based on the relative position of the point P24 with respect to the point P23. As illustrated by Arrow A2500, the control device 20000 moves the E-ring setter 52000 in the horizontal direction. In this manner, the robot system 1000 can cause the E-ring setter 52000 to hold the E-ring 51000. In this example, the point P22 of the reference position is located in the vicinity of the point P24 of the work position. A posture error caused by the operation of the robot 10000 hardly occurs in the movement from the reference position to the work position. In addition, in this example, the robot system 1000 performs the relative control to tilt the E-ring setter 52000. Accordingly, even if there is an error in the XYZ coordinate system recognized by the robot system 1000, the posture error hardly occurs in the vicinity of the reference plane in the real space. Therefore, the robot system 1000 can very accurately achieve the posture of the tool for increasing the success rate in the second example of the work.

### Another Configuration Example of Robot System

In the embodiment, the robot system 1000 including the single arm robot 10000 as illustrated in FIG. 37 has been described. However, a configuration which is the same as that in the embodiment can be applied to a robot system including a robot different from the robot 10000.

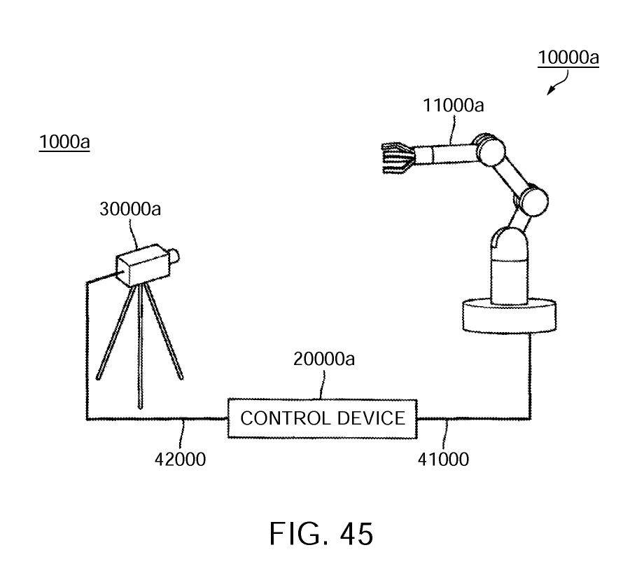

FIG. 45 is a view illustrating an example of a schematic configuration of a robot system 1000a according to another configuration example.

The robot system 1000a includes a robot 10000a, a control device 20000a, and an imaging unit 30000a. The robot 10000a and the control device 20000a are connected to each other so that communication therebetween is available via a circuit 41000. The control device 20000a and the imaging unit 30000a are connected to each other so that communication therebetween is available via a circuit 42000. In the embodiment, the circuit 41000 and the circuit 42000 are provided in a wired manner, but may be provided in a wireless manner, for example.

The robot 10000a is a single arm robot including one manipulator 11000a. The manipulator 11000a includes a configuration which is the same as that of the manipulator 11000 of the above-described robot 10000.

The control device 20000a includes a configuration which is the same as that of the control device 20000 of the above-described robot 10000. In addition, the control device 20000a is an external device of the robot 10000a. As described above, the robot 10000a and the control device 20000a may be devices which are separate from each other.

### Brief of Above-Described Embodiments

As a configuration example, the robot 10000 includes the force sensor 13000, the hand 12000 for gripping the tool used in a work, and the controller 24000 for operating the hand 12000. The robot 10000 is a robot which causes the hand 12000 to carry out the work after the controller 24000 brings the tool gripped by the hand 12000 into contact with the workpieces 60000 and 70000 so as to determine the position or the posture of the hand 12000.

As a configuration example, after the controller 24000 determines the position or the posture of the hand 12000, the controller 24000 causes the hand 12000 to carry out the work by changing the position or the posture of the hand 12000, based on the predetermined change amount.

As a configuration example, the controller 24000 causes the hand 12000 to grip the tool with the weak force before the contact, and causes the hand 12000 to strengthen the gripping force when the position or the posture of the hand 12000 is determined, thereby causing the hand 12000 to carry out the work.

As a configuration example, the controller 24000 brings the predetermined portion of the tool gripped by the hand 12000 into the contact with the workpieces 60000 and 70000.

As a configuration example, the robot system 1000 includes the robot 10000 including the force sensor 13000 and the hand 12000 for gripping the tool used in a work, and the controller 24000 for operating the robot 10000. The robot system 1000 is a robot system which causes the robot 10000 to carry out the work after the controller 24000 brings the tool gripped by the hand 12000 into contact with the workpieces 60000 and 70000 so as to determine the position or the posture of the hand 12000.

As a configuration example, the control device 20000 is a control device which operates the robot 10000 including the force sensor 13000 and the hand 12000 for gripping the tool used in the work. The control device 20000 causes the robot 10000 to carry out the work after the control device 20000 brings the tool gripped by the hand 12000 into contact with the workpieces 60000 and 70000 so as to determine the position or the posture of the hand 12000.

As a configuration example, the control method is a control method for operating the robot 10000 including the force sensor 13000 and the hand 12000 for gripping the tool used in the work. The control method includes bringing the tool gripped by the hand 12000 into contact with the workpieces 60000 and 70000, determining the position or the posture of the hand 12000, and causing the robot 10000 to carry out the work.

Hitherto, the embodiments of the invention have been described with reference to the drawings. However, a specific configuration is not limited to these embodiments, and also includes other designs within the scope not departing from the gist of the invention.

In the above-described examples, the manipulator may have any desired freedom. For example, the manipulator has the freedom of six axes, seven axes, or more. In addition, the manipulator may have the freedom of five axes or less. The manipulator may have any desired freedom.

In the above-described examples, for example, the imaging unit may be provided by being fixed to an upper surface, a floor surface, the ceiling, and a wall surface of the base in which the robot is installed. In addition, for example, the imaging unit may have a configuration in which an imaging direction or an imaging angle can be changed by human touch. In addition, the imaging unit may have a configuration in which the imaging direction or the imaging angle is automatically changed. In addition, the imaging unit may be provided integrally with the robot, or may not be provided integrally with the robot.

When the robot system 1000 determines the position or the posture by using the point contact, the robot system 1000 may use not only a point or a surface on the workpiece, but also a line. The robot system 1000 may determine the position or the posture of the tool by bringing the tool into contact with a ridgeline of the workpiece.

In the above-described devices (for example, the robots 10000 and 10000a, and the control devices 20000 and 20000a), a program for realizing a function of any desired configuration unit may be recorded in a computer-readable recording medium, and the program may be read by a computer system to execute a process. Here, the term. “computer system” includes an operating system (OS) and hardware such as peripheral devices. In addition, the term “computer-readable recording medium” means a portable medium such as a flexible disk, a magneto-optical disk, a read only memory (ROM), and a compact disk (CD)-ROM, and a storage device such as a hard disk incorporated in the computer system. Furthermore, the term “computer-readable recording medium” includes those which hold the program for a certain period of time, such as a volatile memory (RAM: random access memory) inside a server or a computer system serving as a client, when the program is transmitted via a network such as the Internet, or a communication line such as a telephone line.

The above-described program may be transmitted from the computer system which stores the program in the storage device to other computer systems, via a transmission medium or by using a transmission wave in the transmission medium. Here, the “transmission medium” which transmits the program means a medium which has a function of transmitting information, such as the network (communication network) of the Internet, or the communication circuit (communication line) of the telephone line.

The above-described program may partially realize the above-described functions. Furthermore, the above-described program may be those which can realize the above-described functions in combination with a program previously recorded in the computer system, that is, a so-called differential file (differential program).

The entire disclosures of Japanese Patent Application No. 2013-227969, filed Nov. 1, 2013, No. 2013-227970, filed Nov. 1, 2013, No. 2013-237316, filed Nov. 15, 2013 and No. 2014-063235, filed Mar. 26, 2014 are expressly incorporated by reference herein.

What is claimed is:

1. A robot comprising:
a force detection unit; and
an arm including an end effector,
wherein the arm applies a force acting in a predetermined direction to a first workpiece so that the first workpiece is pressed against at least a first surface and a second surface of a second workpiece.

2. The robot according to claim 1, wherein
the second surface is perpendicular to the first surface, and
the arm presses the first workpiece against the first surface in a first direction, and presses the first workpiece against the second surface in a second direction perpendicular to the first direction.

3. The robot according to claim 1,
wherein the arm further presses the first workpiece against a third surface of the second workpiece.

4. The robot according to claim 3, wherein
the second surface is perpendicular to the first surface,
the third surface is perpendicular to both the first surface and the second surface, and
the arm presses the first workpiece against the first surface in the first direction, presses the first workpiece against the second surface in the second direction, and presses the first workpiece against the third surface in a third direction.

5. The robot according to claim 1, wherein
two arms are provided, and
one of the arms presses the first workpiece against the second workpiece, and the other of the arms carries out predetermined work for the first workpiece.

6. The robot according to claim 5, wherein
the predetermined work is work for inserting a member into the first workpiece, and
the first direction is a direction where the member is inserted into the first workpiece.

7. The robot according to claim 1,
wherein the second workpiece is a jig for positioning the first workpiece.

8. The robot according to claim 1,
wherein the second workpiece is a workpiece to which the first workpiece is fastened at a predetermined position.

9. The robot according to claim 1,
wherein the force detection unit; and
the arm including the end effector,
wherein the arm applies a force acting in a predetermined direction and a moment acting in a predetermined direction to a first workpiece so that the first workpiece is pressed against at least a first surface and a second surface of a second workpiece.

10. A control device that controls the robot according to claim 1,
wherein the arm applies a force acting in a predetermined direction to a first workpiece so that the robot performs an operation in which the first workpiece is pressed against at least a first surface and a second surface of a second workpiece.

11. A robot system comprising:
a robot that has a force detection unit and an arm including an end effector; and
a controller that controls the robot,
wherein the controller causes the robot to perform an operation in which the arm applies a force acting in a predetermined direction to a first workpiece so that the first workpiece is pressed against at least a first surface and a second surface of a second workpiece.

12. A control method for controlling a robot that has a force detection unit and an arm including an end effector, comprising:
causing the arm to apply a force acting in a predetermined direction to a first workpiece so that the first workpiece is pressed against at least a first surface and a second surface of a second workpiece.
